(19) United States
(12) Patent Application Publication
(10) Pub. No.: US 2023/0135489 A1
(43) Pub. Date: May 4, 2023

(54) FLUORINE-CONTAINING COPOLYMER, COMPOSITION, OPTICAL FILM, LIQUID CRYSTAL FILM, HARDCOAT FILM, AND POLARIZING PLATE

(71) Applicant: FUJIFILM Corporation, Tokyo (JP)

(72) Inventors: Akio TAMURA, Kanagawa (JP); Hiroyuki HAGIO, Kanagawa (JP); Reiko INUSHIMA, Kanagawa (JP); Mayumi NOJIRI, Kanagawa (JP); Nobuyuki AKUTAGAWA, Kanagawa (JP); Yuta FUKUSHIMA, Kanagawa (JP)

(73) Assignee: FUJIFILM Corporation, Tokyo (JP)

(21) Appl. No.: 18/065,866

(22) Filed: Dec. 14, 2022

Related U.S. Application Data
(63) Continuation of application No. PCT/JP2021/023479, filed on Jun. 21, 2021.

(30) Foreign Application Priority Data
Jul. 10, 2020 (JP) 2020-119176
Feb. 5, 2021 (JP) 2021-017705

(51) Int. Cl. C08F 20/24; C09D 127/12

(52) U.S. Cl. CPC C08F 20/24; C09D 127/12

(57) ABSTRACT

A fluorine-containing polymer includes at least one repeating unit represented by any of General Formulae (I) to (III):

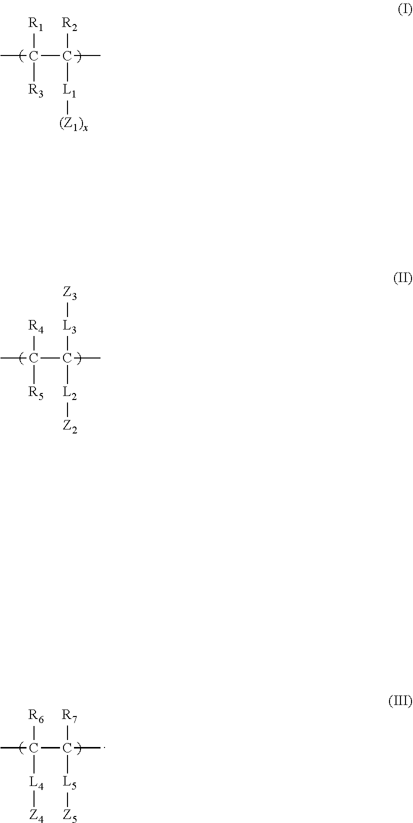

### CROSS-REFERENCE TO RELATED APPLICATIONS

This application is a Continuation of PCT International Application No. PCT/JP2021/023479 filed on Jun. 21, 2021, which claims priority under 35 U.S.C §119(a) to Japanese Patent Application No. 2020-119176 filed on Jul. 10, 2020, and Japanese Patent Application No. 2021-017705 filed on Feb. 5, 2021. Each of the above application(s) is hereby expressly incorporated by reference, in its entirety, into the present application.

### BACKGROUND OF THE INVENTION

### 1. Field of the Invention

The present invention relates to a fluorine-containing copolymer, a composition, an optical film, a liquid crystal film, a hardcoat film, and a polarizing plate.

### 2. Description of the Related Art

Polymer materials have been increasingly used in many fields in recent years. Along with this, the characteristics of a polymer as a matrix as well as the properties and states of a surface and an interface of the polymer have been increasingly important according to each field.

Optical films such as an optical compensation sheet and a phase difference film have been used in various image display devices for the purpose of solving image coloration, widening a viewing angle, and the like. A stretched birefringent film has been used as the optical film, but it has recently been proposed to use a film (liquid crystal film) having an optically anisotropic layer consisting of a liquid crystal compound instead of the stretched birefringent film.

For example, it has been proposed to use an optical film having an optically anisotropic layer containing a predetermined fluoroaliphatic group-containing copolymer in order to display an image having high display quality while not generating unevenness (JP2004-198511A).

On the other hand, in recent years, functions required for optical films have been increasingly more sophisticated. It has also been proposed to combine layers having optical functions to constitute various optical laminates, and in a case of combining these layers, there is an increasing demand for not causing uneven coating thickness, defects, cissing-like failures, and the like.

### SUMMARY OF THE INVENTION

In an optically anisotropic layer formed with a liquid crystal compound, the liquid crystal compound is required to be uniformly aligned so as not to generate alignment defects (satisfying such a requirement will hereinafter be also referred to as having excellent “aligning properties”). In addition, there is also a demand for homogeneity with no unevenness or defects.

Therefore, an object of the present invention is to provide a fluorine-containing polymer capable of forming a film having excellent aligning properties and homogeneity, a composition containing the fluorine-containing polymer, and an optical film, a liquid crystal film, a hardcoat film, and a polarizing plate, each including a layer formed from the composition.

The present inventors have conducted extensive studies to accomplish the object, and as a result, they have found that the object of the present invention is accomplished by manufacturing an optical film using a composition including a predetermined fluorine-containing polymer.

That is, the present inventors have found that it is possible to accomplish the object by the following configurations.

[1] A fluorine-containing polymer comprising at least one repeating unit represented by any of General Formulae (I) to (III).

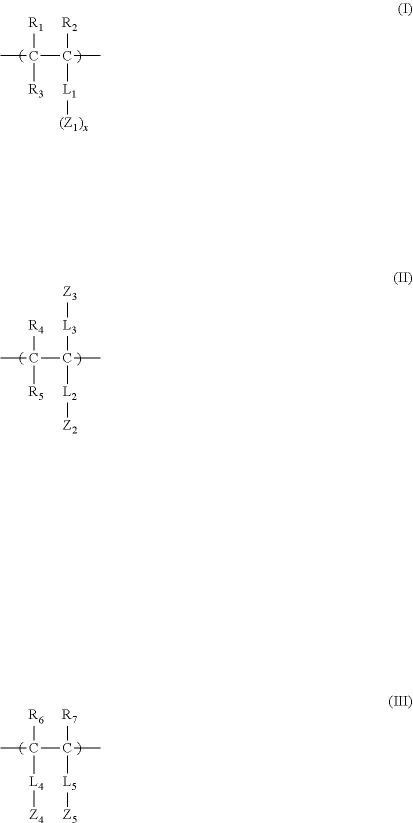

In General Formulae (I) to (III),

L₁ represents an (x+1)-valent linking group.

x represents an integer of 2 or more.

L₂ to L₅ each independently represent a single bond or a divalent linking group.

R₁ to R₇ each independently represent a hydrogen atom, a fluorine atom, a chlorine atom, or an alkyl group having 1 to 20 carbon atoms.

Z₁ to Z₅ each independently represent a fluorine atom-containing aliphatic hydrocarbon group which may have an oxygen atom, and a plurality of Z₁'s may be the same as or different from each other.

Provided that a unit represented by Formula (Ie) is not included in General Formula (I).

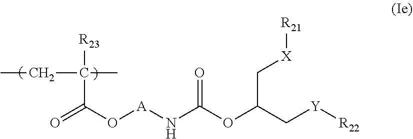

In General Formula (Ie),

R₂₁ represents a perfluoroalkyl group having 1 to 20 carbon atoms, a partially fluorinated alkyl group having 1 to 20 carbon atoms, a perfluoroalkyl group having a total number of carbon atoms of 1 to 20, in which perfluoroalkyl groups are linked through an oxygen atom, or a partially fluorinated alkyl group having a total number of carbon atoms of 1 to 20, in which partially fluorinated alkyl groups are linked through an oxygen atom.

R₂₂ represents the same group as R₂₁, an alkyl group having 1 to 10 carbon atoms, an aralkyl group having 1 to 10 carbon atoms, or a phenyl group.

R₂₃ represents a hydrogen atom or a methyl group.

A represents a divalent linking group represented by —CH₂—CH₂—, —CH₂—CH₂—CH₂—, —CH₂CH(CH₃)—, or —CH(CH₃)CH₂—.

X and Y each independently represent a divalent linking group represented by Structural Formula (a), (b), or (c). Provided that R₄₁ in Structural Formula (c) represents an alkyl group having 1 to 6 carbon atoms.

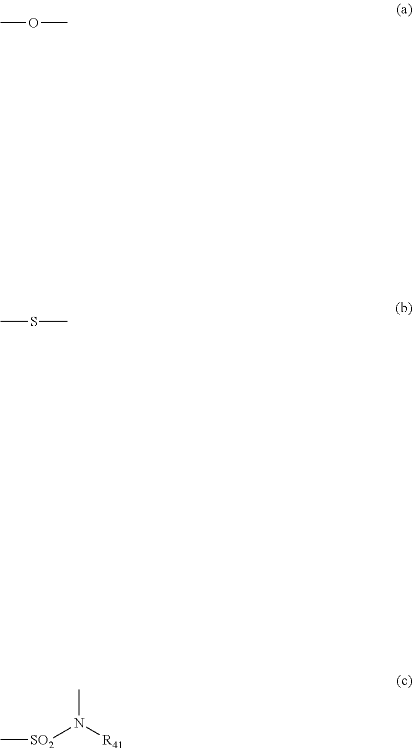

[2] The fluorine-containing polymer as described in [1], further comprising a repeating unit represented by General Formula (IV).

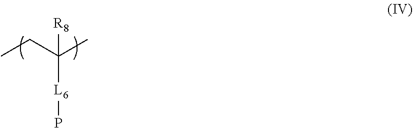

In General Formula (IV),

R₈ represents a hydrogen atom, a fluorine atom, a chlorine atom, or an alkyl group having 1 to 20 carbon atoms.

P represents an aromatic ring which may have a substituent.

L₆ represents a single bond or a divalent linking group.

[3] The fluorine-containing polymer as described in [1] or [2], further comprising a repeating unit represented by General Formula (V).

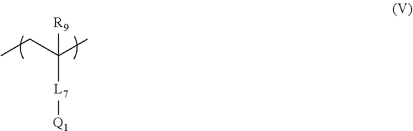

In General Formula (V),

R₉ represents a hydrogen atom, a fluorine atom, a chlorine atom, or an alkyl group having 1 to 20 carbon atoms.

L₇ represents a single bond or a divalent linking group, and

Q₁ represents a group including a polymerizable group selected from the group consisting of a cationically polymerizable group and a radically polymerizable group.

[4] The fluorine-containing polymer as described in any one of [1] to [3], further comprising a repeating unit represented by General Formula (VI).

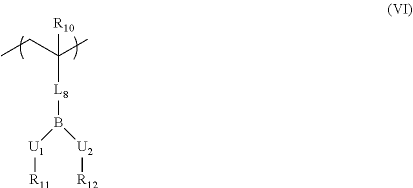

In General Formula (VI),

R₁₀ represents a hydrogen atom, a fluorine atom, a chlorine atom, or an alkyl group having 1 to 20 carbon atoms.

U₁ and U₂ each independently represent —O—, —S—, —COO—, —OCO—, —CONH—, —NHCOO—, or —NH—.

R₁₁ and R₁₂ each independently represent a hydrogen atom, a substituted or unsubstituted aliphatic hydrocarbon group, a substituted or unsubstituted aryl group, or a substituted or unsubstituted heteroaryl group, and R₁₁ and R₁₂ may be linked to each other through a linking group.

L₈ represents a single bond or a divalent linking group.

[5] The fluorine-containing polymer as described in any one of [1] to [4], further comprising a partial structure formed by a radical polymerization of a compound having a mesogenic group derived from at least one liquid crystal compound selected from the group consisting of a rod-like liquid crystal compound and a disk-like liquid crystal compound and two or more polymerizable groups,

in which the fluorine-containing polymer is branched.

[6] The fluorine-containing polymer as described in [5],

in which the compound having a mesogenic group derived from a rod-like liquid crystal compound and two or more polymerizable groups is a compound represented by General Formula (X).

Q^{X1}—L^{X1}—Cy^{X1}—L^{X2}—(Cy^{X2}—L^{X3})ₙₓ—Cy^{X3}—L^{X4}—Q^{X2} General Formula (X)

In General Formula (X), Q^{X1} and Q^{X2} each independently represent a polymerizable group, L^{X1} and L^{X4} each independently represent a divalent linking group, L^{X2} and L^{X3} each independently represent a single bond or a divalent linking group, Cy^{X1}, Cy^{X2}, and Cy^{X3} each independently represent a divalent cyclic group, and nx represents an integer of 0 to 3.

[7] The fluorine-containing polymer as described in [5],

in which the compound having a mesogenic group derived from a disk-like liquid crystal compound and two or more polymerizable groups is a compound represented by General Formula (I-X).

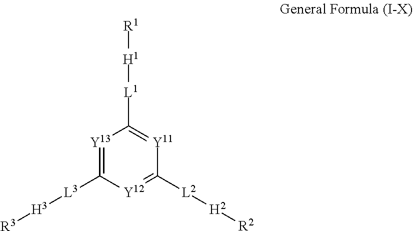

In General Formula (I-X), Y¹¹, Y¹² and Y¹³ each independently represent a methine which may be substituted or a nitrogen atom, L¹, L², and L³ each independently represent a single bond or a divalent linking group, H¹, H², and H³ each independently represent a group represented by General Formula (I-A) or a group represented by General Formula (I-B), and R¹, R², and R³ each independently represent a group represented by General Formula (I-R).

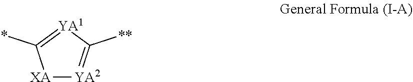

In General Formula (I-A), YA¹ and YA² each independently represent a methine which may have a substituent, or a nitrogen atom, XA represents an oxygen atom, a sulfur atom, a methylene, or an imino, * represents a position for bonding to an L¹ to L³ side in General Formula (I-X), and ** represents a position for bonding to an R¹ to R³ side in General Formula (I-X).

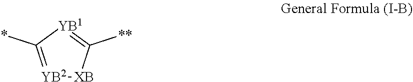

In General Formula (I-B), YB¹ and YB² each independently represent a methine which may have a substituent, or a nitrogen atom, XB represents an oxygen atom, a sulfur atom, a methylene, or an imino, * represents a position for bonding to an L¹ to L³ side in General Formula (I-X), and ** represents a position for bonding to an R¹ to R³ side in General Formula (I-X).

*—(L^{r1}—Q²)ₙ₁—L^{r2}—L^{r3}—Q¹ General Formula (I-R)

In General Formula (I-R), * represents a position for bonding to an H¹ to H³ side in General Formula (I-X), Lr¹ represents a single bond or a divalent linking group, Q² represents a divalent group having at least one cyclic structure, n1 represents an integer of 0 to 4, L^{r2} and L^{r3} each independently represent a divalent linking group, and Q¹ represents a polymerizable group or a hydrogen atom. Provided that in General Formula (I-X), at least two of a plurality of Q¹'s represent polymerizable groups.

[8] A composition comprising the fluorine-containing polymer as described in any one of [1] to [7].

[9] The composition as described in [8], further comprising a polymerizable liquid crystal compound,

in which a content of the polymerizable liquid crystal compound is 40% by mass or more with respect to a total mass of the composition.

[10] An optical film comprising a layer formed from the composition as described in [8] or [9].

[11] A liquid crystal film comprising a layer formed from the composition as described in [8] or [9].

[12] A hardcoat film comprising a layer formed from the composition as described in [8] or [9].

[13] A polarizing plate comprising a layer formed from the composition as described in [8] or [9].

According to the present invention, it is possible to provide a fluorine-containing polymer capable of forming a film having excellent aligning properties and homogeneity, a composition including the fluorine-containing polymer, and an optical film, a hardcoat film, and a polarizing plate, each including a layer formed from the composition.

### DESCRIPTION OF THE PREFERRED EMBODIMENTS

Hereinafter, the present invention will be described in detail.

The following description of the constitutional requirements is made based on representative embodiments of the present invention in some cases, but it should not be construed that the present invention is limited to such embodiments.

Furthermore, in the present specification, a numerical range expressed using “to” means a range that includes the preceding and succeeding numerical values of “to” as the lower limit value and the upper limit value, respectively.

In addition, in the present specification, the bonding direction of a divalent group (for example, —CO—O—) described is not particularly limited, and for example, in a case where D1 in General Formula (W) which will be described later is —CO—O—, D1 may be either *1—CO—O—*2 or *1—O—CO—*2, in which *1 represents a position bonding to the Ar side and *2 represents a position bonding to the G1 side.

In the present specification, (meth)acrylate represents acrylate or methacrylate. In addition, (meth)acrylic acid represents acrylic acid or methacrylic acid. A (meth)acryloyl group represents a methacryloyl group or an acryloyl group.

In citations for a group (atomic group) in the present specification, in a case where the group is denoted without specifying whether it is substituted or unsubstituted, the group includes both a group not having a substituent and a group having a substituent. For example, an “alkyl group” includes not only an alkyl group not having a substituent (unsubstituted alkyl group), but also an alkyl group having a substituent (substituted alkyl group). In addition, an “organic group” in the present specification refers to a group having at least one carbon atom.

Moreover, in the present specification, the type of the substituent, the position of the substituent, and the number of the substituents in a case of referring to “which may have a substituent” are not particularly limited. The number of the substituents may be, for example, one, two, three, or the like. Examples of the substituent include a monovalent non-metal atomic group excluding a hydrogen atom, and can be selected from, for example, the following substituent group T.

(Substituent T)

Examples of the substituent T include a halogen atom such as a fluorine atom, a chlorine atom, a bromine atom, and an iodine atom; an alkoxy group such as a methoxy group, an ethoxy group, and a tert-butoxy group; an aryloxy group such as a phenoxy group and a p-tolyloxy group; an alkoxycarbonyl group such as a methoxycarbonyl group, a butoxycarbonyl group, and a phenoxycarbonyl group; an acyloxy group such as an acetoxy group, a propionyloxy group, and a benzoyloxy group; an acyl group such as an acetyl group, a benzoyl group, an isobutyryl group, an acryloyl group, a methacryloyl group, and a methoxalyl group; an alkylsulfanyl group such as a methylsulfanyl group and a tert-butylsulfanyl group; an arylsulfanyl group such as a phenylsulfanyl group and a p-tolylsulfanyl group; an alkyl group; a cycloalkyl group; an aryl group; a heteroaryl group; a hydroxyl group; a carboxy group; a formyl group; a sulfo group; a cyano group; an alkylaminocarbonyl group; an arylaminocarbonyl group; a sulfonamide group; a silyl group; an amino group; a monoalkylamino group; a dialkylamino group; an arylamino group; and a combination thereof.

A reason why the film including the fluorine-containing polymer of an embodiment of the present invention has homogeneity and has excellent aligning properties in a case of being made into a liquid crystal film has not been clarified in detail, but is presumed to be as follows by the present inventors.

Since the fluorine-containing polymer of the embodiment of the present invention has a branched structure having a plurality of branched aliphatic hydrocarbon groups having a fluorine atom in branches, as represented by General Formulae (I) to (III), the fluorine moieties can be efficiently localized on an air interface side and the copolymerization components can be efficiently localized on a matrix resin forming component (curable component) side in the composition, whereby a compatibility between the fluorine-containing polymer of the embodiment of the present invention and the matrix resin forming component is improved. It is presumed that such a configuration causes aggregation of the fluorine-containing polymer of the embodiment of the present invention in the composition including the fluorine-containing polymer of the embodiment of the present invention to be less likely to occur, whereby the aligning properties of the liquid crystal compound are improved.

In addition, due to the branched structure, the transferability of the fluorine-containing polymer onto a surface of the coating film is improved. It is presumed that since the surface tension of the composition (coating film) is lowered by adding such a fluorine-containing polymer to the composition, the wettability (homogeneous coating properties) of the composition with respect to a substrate during coating is improved, whereby a film having excellent homogeneity with less unevenness and defects can be obtained.

### Fluorine-Containing Polymer

The fluorine-containing polymer of the embodiment of the present invention is a fluorine-containing polymer having a repeating unit represented by any of General Formulae (I) to (III).

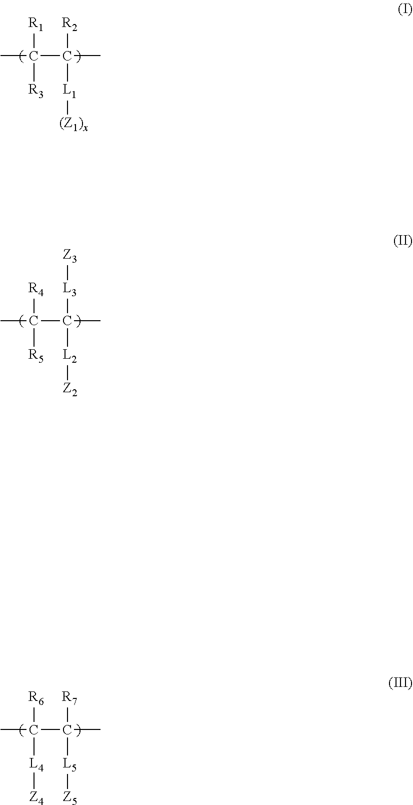

In General Formulae (I) to (III), L₁ represents an (x+1)-valent linking group. x represents an integer of 2 or more. L₂ to L₅ each independently represent a single bond or a divalent linking group. R₁ to R₇ each independently represent a hydrogen atom, a fluorine atom, a chlorine atom, or an alkyl group having 1 to 20 carbon atoms. Z₁ to Z₅ each independently represent a fluorine atom-containing aliphatic hydrocarbon group which may have an oxygen atom, and a plurality of Z₁'s may be the same as or different from each other.

It should be noted that a unit represented by Formula (Ie) is not included in General Formula (I).

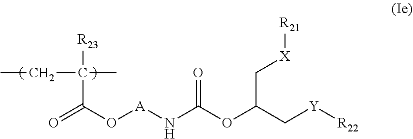

Here, in General Formula (Ie),

R₂₁ represents a perfluoroalkyl group having 1 to 20 carbon atoms, a partially fluorinated alkyl group having 1 to 20 carbon atoms, a perfluoroalkyl group having a total number of carbon atoms of 1 to 20, in which perfluoroalkyl groups are linked through an oxygen atom, or a partially fluorinated alkyl group having a total number of carbon atoms of 1 to 20, in which partially fluorinated alkyl groups are linked through an oxygen atom. Furthermore, the perfluoroalkyl group means a kind of fluoroalkyl group, in which all hydrogen atoms of the alkyl group are substituted with fluorine atoms, and the partially fluorinated alkyl group means a kind of fluoroalkyl group, in which parts of hydrogen atoms of the alkyl group are substituted with fluorine atoms.

R₂₂ represents the same group as R₂₁, an alkyl group having 1 to 10 carbon atoms, an aralkyl group having 1 to 10 carbon atoms, or a phenyl group.

R₂₃ represents a hydrogen atom or a methyl group.

A represents a divalent linking group represented by —CH₂—CH₂—, —CH₂—CH₂—CH₂—, —CH₂CH(CH₃)—, or —CH(CH₃)CH₂—.

X and Y each independently represent a divalent linking group represented by Structural Formula (a), (b), or (c). R₄₁ in Structural Formula (c) represents an alkyl group having 1 to 6 carbon atoms.

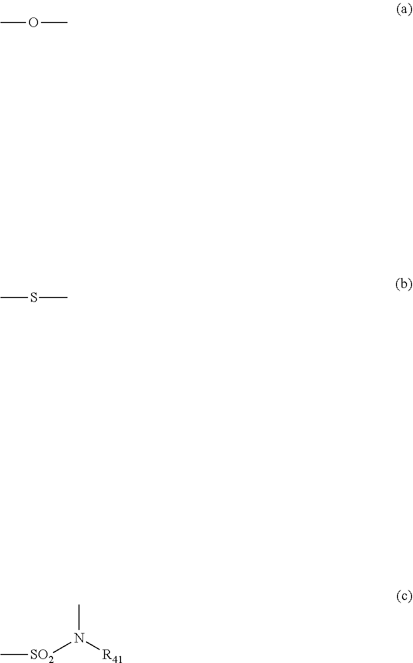

In General Formulae (I) to (III), R₁ to R₇ are each independently preferably the hydrogen atom, the fluorine atom, or an alkyl group having 1 to 4 carbon atoms, and more preferably the hydrogen atom or a methyl group.

In General Formula (I), L₁ represents an (x+1)-valent linking group as described above, but it is preferably the (x+1)-valent linking group in which x represents 2 or 3, that is, a trivalent or tetravalent linking group.

L₂ to L₅ each independently represent a single bond or a divalent linking group, and are preferably a divalent linking group having —O—, —CO—O—, —CO—NH—, or —O—CO—.

### (a) Fluorine-Containing Polymer Containing Group Represented by Formula (I)

It is also preferable that General Formula (I) is represented by Formula (VII).

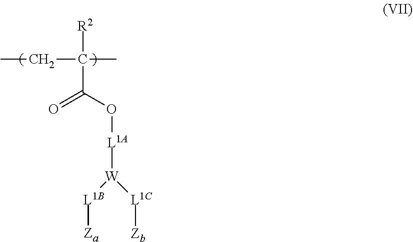

In General Formula (VII), R² represents a hydrogen atom, a fluorine atom, a chlorine atom, or an alkyl group having 1 to 20 carbon atoms. Among those, R² is preferably the hydrogen atom, the fluorine atom, or an alkyl group having 1 to 4 carbon atoms, and more preferably the hydrogen atom or a methyl group.

In General Formula (VII), L^{1A} to L^{1C} each independently represent a single bond or a divalent group having 2 to 50 carbon atoms.

The divalent group having 2 to 50 carbon atoms, represented by one aspect of L^{1A} to L^{1C}, may include a heteroatom, and may be an aromatic group, a heteroaromatic group, a heterocyclic group, an aliphatic group, or an alicyclic group.

Specific examples of L^{1A} to L^{1C} include the following groups, and a plurality of these groups may be included.

—(CH₂)ₙ₁— (n1=1 to 50)

—X—Y—(CH₂)ₙ₂— (n2=0 to 50)

—X—(CH₂)ₙ₃— (n3=0 to 50)

—Y—(CH₂)ₙ₄— (n4=0 to 50)

—CH₂CH₂(OCH₂CH₂)ₙ₅— (n5=1 to 50)

—XCO(OCH₂CH₂)ₙ₆— (n6=1 to 50)

—O—(CH₂)ₙ₇— (n7=1 to 50)

—S—(CH₂)ₙ₈— (n8=1 to 50)

In the formulae of the specific examples, X represents phenylene, biphenylene, or naphthylene, which may have 1 to 3 substituents selected from the group consisting of an alkyl group having 1 to 3 carbon atoms (for example, a methyl group, an ethyl group, and a propyl group), an alkoxy group having 1 to 4 carbon atoms (for example, a methoxy group, an ethoxy group, a propoxy group, and a butoxy group), and a halogen atom (for example, F, Cl, Br, and I). Among those, 1,2-phenylene, 1,3-phenylene, or 1,4-phenylene, which may have the substituent, is preferable, and 1,4-phenylene which may have the substituent is particularly preferable.

In addition, in the formulae of the specific examples, Y represents —O—CO—, —CO—O—, —CONH—, or —NHCO—.

In General Formula (VII), W represents a trivalent group.

Examples of the trivalent group represented by W include a group derived by removing three hydrogen atoms contained in a carbon atom or a nitrogen atom.

In General Formula (VII), Zₐ and Z_{b} each independently represent a fluorine atom-containing aliphatic hydrocarbon group which may have an oxygen atom.

Specific examples thereof include the following groups.

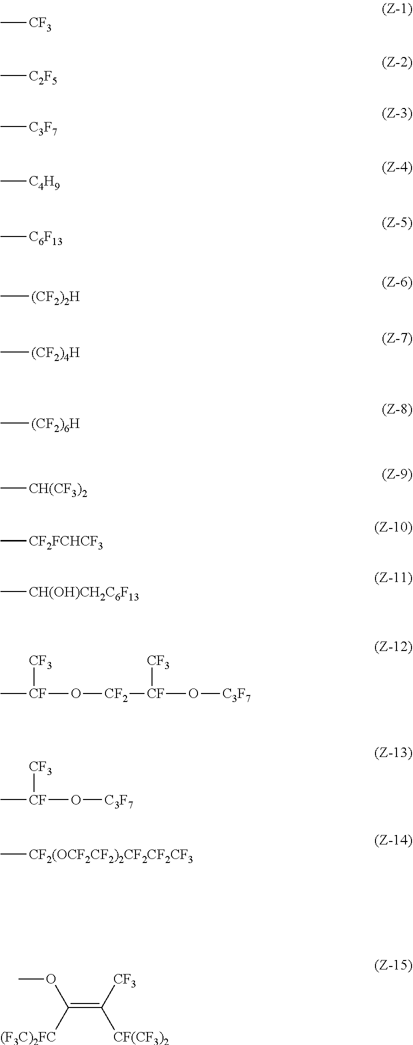

### (b) Fluorine-Containing Polymer Containing Group Represented by Formula (II)

It is also preferable that General Formula (II) is represented by Formula (VIII).

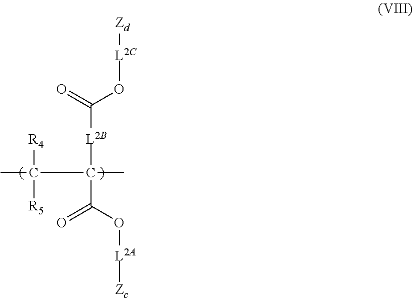

In General Formula (VIII), R₄ and R₅ each independently represent a hydrogen atom, a fluorine atom, a chlorine atom, or an alkyl group having 1 to 20 carbon atoms. Among those, R₄ and R₅ are each independently preferably the hydrogen atom, the fluorine atom, or an alkyl group having 1 to 4 carbon atoms, and more preferably the hydrogen atom or a methyl group.

In General Formula (VIII), L^{2A} to L^{2C} each independently represent a single bond or a divalent group having 2 to 50 carbon atoms, may include a heteroatom, and may be an aromatic group, a heteroaromatic group, a heterocyclic group, an aliphatic group, or an alicyclic group. Specific examples of the divalent group having 2 to 50 carbon atoms, represented by one aspect of L^{2A} to L^{2C} in General Formula (VII) mentioned above include the same groups as those of the divalent group having 2 to 50 carbon atoms, represented by one aspect of L^{1A} to L^{1C}.

In General Formula (VIII), Z_{c} and Z_{d} each independently represent a fluorine atom-containing aliphatic hydrocarbon group which may have an oxygen atom, and specific examples thereof include the same groups as those of Zₐ and Z_{b} of General Formula (VII).

### (c) Fluorine-Containing Polymer Containing Group Represented by Formula (III)

It is also preferable that General Formula (III) is represented by General Formula (IX).

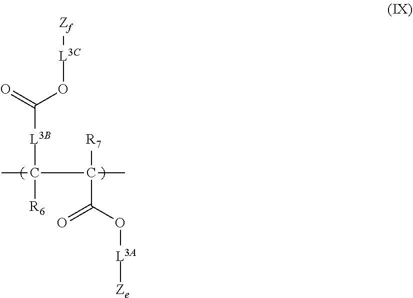

In General Formula (IX), R₆ and R₇ each independently represent a hydrogen atom, a fluorine atom, a chlorine atom, or an alkyl group having 1 to 20 carbon atoms. Among those, R₆ and R₇ are each independently preferably the hydrogen atom, the fluorine atom, or an alkyl group having 1 to 4 carbon atoms, and more preferably the hydrogen atom or a methyl group.

In General Formula (IX), L^{3A} to L^{3C} each independently represent a single bond or a divalent group having 2 to 50 carbon atoms, may include a heteroatom, and may be an aromatic group, a heteroaromatic group, a heterocyclic group, an aliphatic group, or an alicyclic group. Specific examples of the divalent group having 2 to 50 carbon atoms, represented by one aspect of L^{3A} to L^{3C} in General Formula (VII) mentioned above include the same groups as those of the divalent group having 2 to 50 carbon atoms, represented by one aspect of L^{1A} to L^{1C}.

In General Formula (IX), Zₑ and Z_{f} each independently represent a fluorine atom-containing aliphatic hydrocarbon group which may have an oxygen atom, and specific examples thereof include the same groups as those of Zₐ and Z_{b} of General Formula (VII).

It is particularly preferable that the repeating unit represented by General Formula (II) or (III) is a dicarboxylic acid ester skeleton induced from an ethylenically unsaturated dicarboxylic acid or an anhydride thereof. The ethylenically unsaturated dicarboxylic acid or an anhydride thereof is not particularly limited, but the ethylenically unsaturated dicarboxylic acid having 4 to 10 carbon atoms or an anhydride thereof, in particular, itaconic acid, fumaric acid, maleic acid, citraconic acid, mesaconic acid, glutaconic acid, and teraconic acid are suitable.

### Repeating Unit Represented by General Formula (IV)

It is also preferable that the fluorine-containing polymer of the embodiment of the present invention further has a repeating unit represented by General Formula (IV).

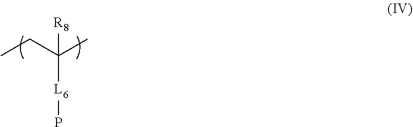

In General Formula (IV), R₈ represents a hydrogen atom, a fluorine atom, a chlorine atom, or an alkyl group having 1 to 20 carbon atoms. Among those, R₈ is preferably the hydrogen atom, the fluorine atom, or an alkyl group having 1 to 4 carbon atoms, and more preferably the hydrogen atom or a methyl group.

P represents an aromatic ring which may have a substituent. Examples of the aromatic ring group include an aromatic hydrocarbon ring group such as a benzene ring group, a naphthalene ring group, an anthracene ring group, and a phenanthroline ring group; and an aromatic heterocyclic group such as a furan ring group, a pyrrole ring group, a thiophene ring group, a pyridine ring group, a thiazole ring group, and a benzothiazole ring group. Among these, the benzene ring group (for example, a 1,4-phenyl group) is preferable. By incorporating these groups in the polymer, for example, the compatibility with the liquid crystal composition which will be described later can be improved. In addition, examples of the substituent which may be contained in the aromatic ring include those exemplified in the above-mentioned substituent T and a substituent group Y which will be described later.

L₆ represents a single bond or a divalent linking group. L₆ is preferably —C(O)—O—L₆₁— from the viewpoint that the effect of the present invention is more excellent. Examples of L₆₁ include an alkylene group having 1 to 10 carbon atoms, or a group represented by (L₆₂O)ₘ₁₀ (in the formula, L₆₂ represents an alkylene group having 1 to 4 carbon atoms, and m10 represents an integer of 1 to 10).

### Repeating Unit Represented by General Formula (V)

It is also preferable that the fluorine-containing polymer of the embodiment of the present invention further has a repeating unit represented by General Formula (V).

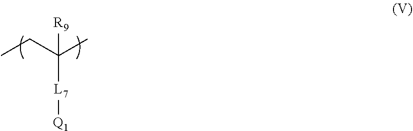

In General Formula (V), R₉ represents a hydrogen atom, a fluorine atom, a chlorine atom, or an alkyl group having 1 to 20 carbon atoms. Among those, R₉ is preferably the hydrogen atom, the fluorine atom, or an alkyl group having 1 to 4 carbon atoms, and more preferably the hydrogen atom or a methyl group.

L₇ represents a single bond or a divalent linking group. L₇ is preferably —C(O)—O—L₇₁— from the viewpoint that the effect of the present invention is more excellent. L₇₁ represents an alkylene group having 1 to 5 carbon atoms, which may have a substituent.

Q₁ represents a group including a polymerizable group selected from the group consisting of a cationically polymerizable group and a radically polymerizable group.

In a case where Q₁ represents the group including a cationically polymerizable group, the cationically polymerizable group is not particularly limited, and examples thereof include an alicyclic ether group, a cyclic acetal group, a cyclic lactone group, a cyclic thioether group, a spiroorthoester group, and a vinyloxy group.

As the cationically polymerizable group, the alicyclic ether group or the vinyloxy group is preferable, an epoxy group, an oxetanyl group or the vinyloxy group is more preferable, the epoxy group or the oxetanyl group is still more preferable, and the epoxy group is particularly preferable. The epoxy group is particularly preferably the alicyclic epoxy group. Furthermore, each group mentioned above may have a substituent.

In a case where Q₁ represents the group including a radically polymerizable group, the radically polymerizable group is not particularly limited, and examples thereof include a group including a polymerizable carbon-carbon double bond, a (meth)acryloyl group, a (meth)acryloyloxy group, a (meth)acrylamide group, a vinyl group, a styryl group, and an allyl group, and the (meth)acryloyloxy group is preferable. Furthermore, each group mentioned above may have a substituent. By incorporating these groups, for example, it is possible to improve the adhesiveness between layers in a case where a plurality of liquid crystal composition layers are laminated in a liquid crystal film which will be described later.

### Repeating Unit Represented by General Formula (VI)

It is also preferable that the fluorine-containing polymer of the embodiment of the present invention further has a repeating unit represented by General Formula (VI).

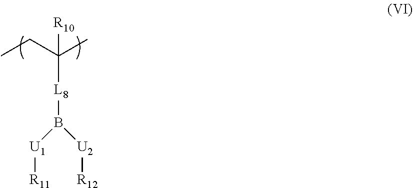

In General Formula (VI), R₁₀ represents a hydrogen atom or an alkyl group having 1 to 20 carbon atoms, and among these, the hydrogen atom or an alkyl group having 1 to 10 carbon atoms is preferable, the hydrogen atom or an alkyl group having 1 to 4 carbon atoms is more preferable, and the hydrogen atom or a methyl group is still more preferable.

U₁ and U₂ each independently represent —O—, —S—, —COO—, —OCO—, —CONH—, —NHCOO—, or —NH—, and are each preferably —O— or—NH—, and more preferably —O—.

R₁₁ and R₁₂ each independently represent a hydrogen atom, or a substituted or unsubstituted aliphatic hydrocarbon group, a substituted or unsubstituted aryl group, or a substituted or unsubstituted heteroaryl group, and R₁₁ and R₁₂ may be linked to each other through a linking group.

Examples of the substituted or unsubstituted aliphatic hydrocarbon groups represented by R₁₁ and R₁₂ include an alkyl group, an alkenyl group, or an alkynyl group, which may have a substituent.

Specific examples of the alkyl group include linear, branched, or cyclic alkyl groups such as a methyl group, an ethyl group, a propyl group, a butyl group, a pentyl group, a hexyl group, a heptyl group, an octyl group, a nonyl group, a decyl group, an undecyl group, a dodecyl group a tridecyl group, a hexadecyl group, an octadecyl group, an eicosyl group, an isopropyl group, an isobutyl group, a sec-butyl group, a tert-butyl group, an isopentyl group, a neopentyl group, a 1-methylbutyl group, an isohexyl group, a 2-methylhexyl group, a cyclopentyl group, a cyclohexyl group, a 1-adamantyl group, and a 2-norbornyl group.

Specific examples of the alkenyl group include linear, branched, or cyclic alkenyl groups such as a vinyl group, a 1-propenyl group, a 1-butenyl group, a 1-methyl-1-propenyl group, a 1-cyclopentenyl group, and a 1-cyclohexenyl group.

Specific examples of the alkynyl group include an ethynyl group, a 1-propynyl group, a 1-butynyl group, and a 1-octynyl group.

Examples of the substituted or unsubstituted aryl group represented by R₁₁ and R₁₂ include those in which 1 to 4 benzene rings form a fused ring and those in which a benzene ring and an unsaturated five-membered ring form a fused ring, and specific examples thereof include a phenyl group, a naphthyl group, an anthryl group, a phenanthryl group, an indenyl group, an acenaphthenyl group, a fluorenyl group, and a pyrenyl group.

Examples of the substituted or unsubstituted heteroaryl group represented by R₁₁ and R₁₂ include a heteroaryl group obtained by removing one hydrogen atom on a heteroaromatic ring including one or more heteroatoms selected from the group consisting of a nitrogen atom, an oxygen atom, and a sulfur atom.

Specific examples of the heteroaromatic ring including one or more heteroatoms selected from the group consisting of a nitrogen atom, an oxygen atom, and a sulfur atom include pyrrole, furan, thiophene, pyrazole, imidazole, triazole, oxazole, isoxazole, oxadiazole, thiazole, thiadiazole, indole, carbazole, benzofuran, dibenzofuran, thianaphthene, dibenzothiophene, indazole benzimidazole, anthranil, benzisoxazole, benzoxazole, benzothiazole, purine, pyridine, pyridazine, pyrimidine, pyrazine, triazine, quinoline, acridine, isoquinoline, phthalazine, quinazoline, quinoxaline, naphthyridine, phenanthroline, and pteridine.

Examples of the substituents which may be contained in R₁₁ and R₁₂ include monovalent non-metal atomic groups from which hydrogen is removed, and are selected from the following substituent group Y, for example.

(Substituent Group Y)

A halogen atom (—F, —Br, —Cl, and —I), a hydroxyl group, an alkoxy group, an aryloxy group, a mercapto group, an alkylthio group, an arylthio group, an alkyldithio group, an aryldithio group, an amino group, an N-alkylamino group, an N,N-dialkylamino group, an N-arylamino group, an N,N-diarylamino group, an N-alkyl-N-arylamino group, an acyloxy group, a carbamoyloxy group, an N-alkylcarbamoyloxy group, an N-arylcarbamoyloxy group, an N,N-dialkylcarbamoyloxy group, an N,N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, a ureide group, an N′-alkylureide group, an N′,N′-dialkylureide group, an N′-arylureide group, an N′,N′-diarylureide group, an N′-alkyl-N′-arylureide group, an N-alkylureide group, an N-arylureide group, an N′-alkyl-N-alkylureide group, an N′-alkyl-N-arylureide group, an N′,N′-dialkyl-N-alkylureide group, an N′,N′-dialkyl-N-arylureide group, an N′-aryl-N-alkylureide group, an N′-aryl-N-arylureide group, an N′,N′-diaryl-N-alkylureide group, an N′,N′-diaryl-N-arylureide group, an N′-alkyl-N′-aryl-N-alkylureide group, an N′-alkyl-N′-aryl-N-arylureide group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group, an N-aryl-N-aryloxycarbonylamino group, a formyl group, an acyl group, a carboxyl group and a conjugate base group thereof, an alkoxycarbonyl group, an aryloxycarbonyl group, a carbamoyl group, an N-alkylcarbamoyl group, an N,N-dialkylcarbamoyl group, an N-arylcarbamoyl group, an N,N-diarylcarbamoyl group, an N-alkyl-N-arylcarbamoyl group, an alkylsulfinyl group, an arylsulfinyl group, an alkylsulfonyl group, an arylsulfonyl group, a sulfo group (—SO₃H) and a conjugate base group thereof, an alkoxysulfonyl group, an aryloxysulfonyl group, sulfinamoyl group, an N-alkylsulfinamoyl group, an N,N-dialkylsulfinamoyl group, an N-arylsulfinamoyl group, an N,N-diarylsulfinamoyl group, an N-alkyl-N-arylsulfinamoyl group, a sulfamoyl group, an N-alkylsulfamoyl group, an N,N-dialkylsulfamoyl group, an N-arylsulfamoyl group, an N,N-diarylsulfamoyl group, an N-alkyl-N-arylsulfamoyl group, an N-acylsulfamoyl group and a conjugate base group thereof, an N-alkylsulfonylsulfamoyl group (—SO₂NHSO₂(alkyl)) and a conjugate base group thereof, an N-arylsulfonylsulfamoyl group (—SO₂NHSO₂(aryl)) and a conjugate base group thereof, an N-alkylsulfonylcarbamoyl group (—CONHSO₂(alkyl)) and a conjugate base group thereof, an N-arylsulfonylcarbamoyl group (—CONHSO₂(aryl)) and a conjugate base group thereof, an alkoxysilyl group (—Si(Oalkyl)₃), an aryloxysilyl group (—Si(Oaryl)₃), a hydroxysilyl group (—Si(OH)₃) and a conjugate base group thereof, a phosphono group (—PO₃H₂) and a conjugate base group thereof, a dialkylphosphono group (—PO₃(alkyl)₂), a diarylphosphono group (—PO₃(aryl)₂), an alkylarylphosphono group (—PO₃(alkyl)(aryl)), a monoalkylphosphono group (—PO₃H(alkyl)) and a conjugate base group thereof, a monoarylphosphono group (—PO₃H(aryl)) and a conjugate base group thereof, a phosphonooxy group (—OPO₃H₂) and a conjugate base group thereof, a dialkylphosphonooxy group (—OPO₃(alkyl)₂), a diarylphosphonooxy group (—OPO₃(aryl)₂), an alkylarylphosphonooxy group (—OPO₃(alkyl)(aryl)), a monoalkylphosphonooxy group (—OPO₃H(alkyl)) and a conjugated base group thereof, a monoarylphosphonooxy group (—OPO₃H(aryl)) and a conjugated base group thereof, a cyano group, a nitro group, an aryl group, an alkenyl group and an alkynyl group, in which these substituents may be bonded to each other or bonded to a hydrocarbon group which is substituted to form a ring, as possible.

R₁₁ and R₁₂ in Formula (IV) are each preferably the hydrogen atom, the substituted or unsubstituted alkyl group, or the substituted or unsubstituted aryl group, more preferably the hydrogen atom or the substituted or unsubstituted alkyl group, and still more preferably the hydrogen atom or both linked to each other through an alkylene linking group.

L₈ represents a single bond or a divalent linking group selected from the group consisting of —O—, —S—, —COO—, —OCO—, —CONR¹³—, —NR¹³COO—, —CR¹³N—, a substituted or unsubstituted divalent aliphatic group, a substituted or unsubstituted divalent aromatic group, and a combination thereof, and R¹⁰ represents a hydrogen atom or an alkyl group having 1 to 20 carbon atoms.

L₈ is preferably a divalent linking group selected from the group consisting of —O—, —COO—, —OCO—, —CONR¹³—, —NR¹³COO—, the substituted or unsubstituted divalent aliphatic group, the substituted or unsubstituted divalent aromatic group, and a combination thereof.

In a case where L₈ includes the substituted or unsubstituted divalent aromatic group, the number of aromatic rings is preferably 1 to 3, more preferably 1 or 2, and still more preferably 1. Within this range, the aligning properties of an optically anisotropic layer thus formed can be improved.

Specific examples of the monomer forming the repeating unit represented by Formula (VI) include monomers represented by Formulae 3-1 to 3-26.

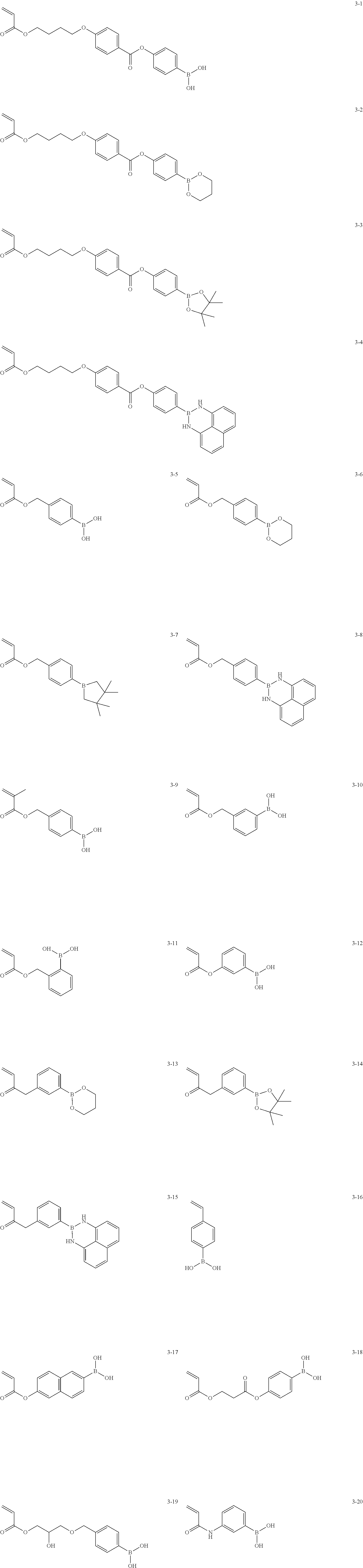

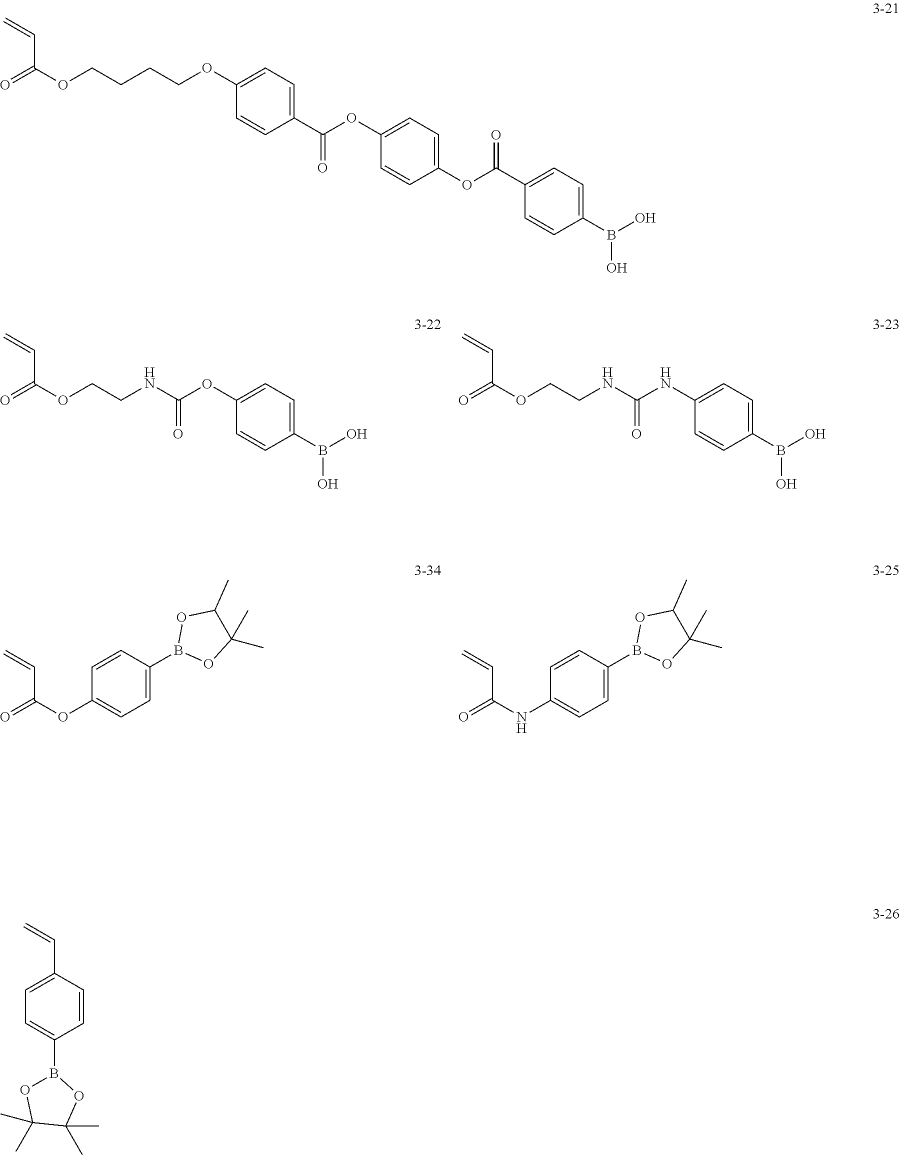

### Structure Derived from Liquid Crystal Compound

The fluorine-containing polymer of the embodiment of the present invention preferably has a structure derived from a liquid crystal compound.

Examples of the structure derived from the liquid crystal compound include a partial structure formed by a radical polymerization of a compound having a mesogenic group derived from at least one liquid crystal compound selected from a rod-like liquid crystal compound and a disk-like liquid crystal compound, and two or more polymerizable groups. In a case where the fluorine-containing polymer of the embodiment of the present invention has such a partial structure, the fluorine-containing polymer is branched. That is, the polymerizable group derived from the liquid crystal compound serves as a branch point.

The partial structure is preferably introduced into the fluorine-containing polymer of the embodiment of the present invention as the repeating unit having a structure derived from a liquid crystal compound.

The partial structure includes a mesogen structure derived from a liquid crystal compound. Therefore, in a case where the fluorine-containing polymer of the embodiment of the present invention includes the partial structure, the compatibility between the polymerizable liquid crystal compound and the fluorine-containing polymer in the liquid crystal composition is improved. As a result, the wettability of the liquid crystal composition with respect to the substrate is further improved and cissing during application of the liquid crystal composition can be suppressed, whereby a more homogeneous film can be obtained. In particular, in a case where the content of the polymerizable liquid crystal compound in the liquid crystal composition is high, this effect is more remarkably expressed.

Here, the expression that the polymer is “branched” means that the polymer has a three-dimensional crosslinking structure and at least one polymerization initiator fragment is incorporated at a terminal. A polymerization initiator fragment differs depending on the structure of a polymerization initiator structure used in polymerization of the polymer, but it can be confirmed that the polymer fragment is incorporated into the polymer by a method such as nuclear magnetic resonance (NMR) spectrum measurement, infrared (IR) spectrum measurement, mass spectrometry measurement, or element analysis measurement.

As the rod-like liquid crystal compound, the compounds described in Makromol. Chem., Vol. 190, p. 2255 (1989), Advanced Materials Vol. 5, p. 107 (1993), US4683327A, US5622648A, US5770107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081A), JP2001-329873A, and the like can be used.

In addition, it is preferable that a structure derived from a compound represented by General Formula (X) is included as the mesogenic group derived from the rod-like liquid crystal compound.

Q^{X1}—L^{X1}—Cy^{X1}—L^{X2}—(Cy^{X2}—L^{X3})ₙₓ—Cy^{X3}—L^{X4}—Q^{X2} General Formula (X)

In the formula, Q^{X1} and Q^{X2} each independently represent a polymerizable group, L^{X1} and L^{X4} each independently represent a divalent linking group, L^{X2} and L^{X3} each independently represent a single bond or a divalent linking group, Cy^{X1}, Cy^{X2}, and Cy^{X3} each independently represent a divalent cyclic group, and nx represents an integer of 0 to 3.

The rod-like liquid crystal compound represented by General Formula (X) will be further described below.

In the formula, Q^{X1} and Q^{X2} each independently represent a polymerizable group. The polymerization reaction of the polymerizable group is preferably addition polymerization. In other words, the polymerizable group is preferably a functional group capable of an addition polymerization reaction. Examples of the polymerizable group include Formulae (M-1) to (M-6).

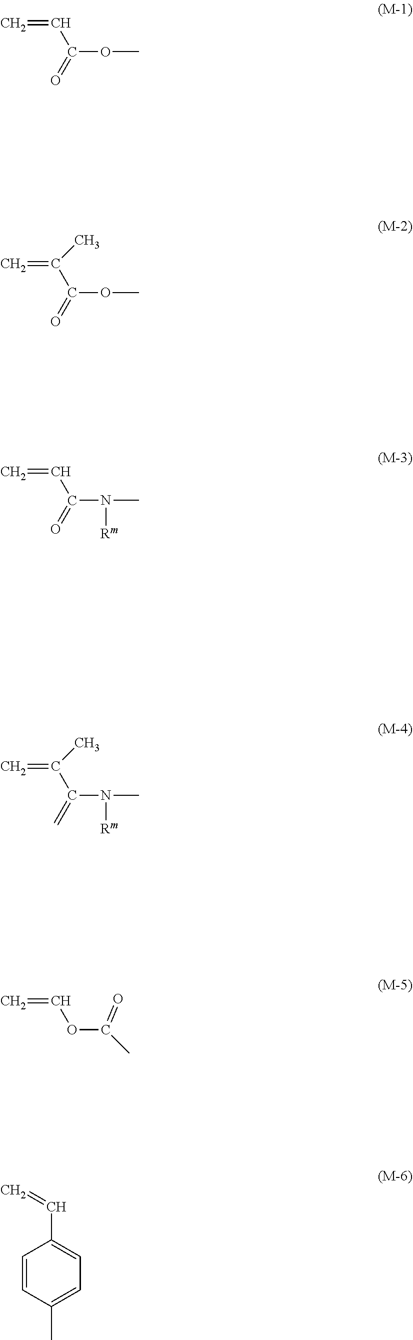

In Formulae (M-3) and (M-4), R^{m} represents a hydrogen atom or an alkyl group having 1 to 20 carbon atoms, more preferably a hydrogen atom or an alkyl group having 1 to 7 carbon atoms, and most preferably the hydrogen atom or a methyl group.

Among Formulae (M-1) to (M-6), (M-1) or (M-2) is preferable, and (M-1) is more preferable.

L^{X1} and L^{X4} are each independently a divalent linking group. L^{X1} and L^{X4} are each independently preferably a divalent linking group selected from the group consisting of —O—, —S—, —CO—, —NR^{x1}—, —C═N—, a divalent chain group, a divalent cyclic group, and a combination thereof. R^{x1} is a hydrogen atom or an alkyl group having 1 to 7 carbon atoms. Examples of the divalent linking group consisting of the combination are shown below. Here, the left side is bonded to Q(Q^{X1} or Q^{X2}) and the right side is bonded to Cy (Cy^{X1} or Cy^{X3}).

Lx-1: —C(═O)O-divalent chain group-O—

Lx-2: —C(═O)O-divalent chain group-OC(═O)—

Lx-3: —C(═O)O-divalent chain group-OC(═O)O—

Lx-4: —C(═O)O-divalent chain group-O-divalent cyclic group—

Lx-5: —C(═O)O-divalent chain group-O-divalent cyclic group-C(═O)O—

Lx-6: —C(═O)O-divalent chain group-O-divalent cyclic group-OC(═O)—

Lx-7: —C(═O)O-divalent chain group-O-divalent cyclic group-divalent chain group—

Lx-8: —C(═O)O-divalent chain group-O-divalent cyclic group-divalent chain group-C(═O)O—

Lx-9: —C(═O)O-divalent chain group-O-divalent cyclic group-divalent chain group-OC(═O)—

Lx-10: —C(═O)O-divalent chain group-OC(═O)-divalent cyclic group—

Lx-11: —C(═O)O-divalent chain group-OC(═O)-divalent cyclic group-C(═O)O—

Lx-12: —C(═O)O-divalent chain group-OC(═O)-divalent cyclic group-OC(═O)—

Lx-13: —C(═O)O-divalent chain group-OC(═O)-divalent cyclic group-divalent chain group—

Lx-14: —C(═O)O-divalent chain group-OC(═O)-divalent cyclic group-divalent chain group-C(═O)O—

Lx-15: —C(═O)O-divalent chain group-OC(═O)-divalent cyclic group-divalent chain group-OC(═O)—

Lx-16: —C(═O)O-divalent chain group-OC(═O)O-divalent cyclic group—

Lx-17: —C(═O)O-divalent chain group-OC(═O)O-divalent cyclic group-C(═O)O—

Lx-18: —C(═O)O-divalent chain group-OC(═O)O-divalent cyclic group-OC(═O)—

Lx-19: —C(═O)O-divalent chain group-OC(═O)O-divalent cyclic group-divalent chain group—

Lx-20: —C(═O)O-divalent chain group-OC(═O)O-divalent cyclic group-divalent chain group-C(═O)O—

Lx-21: —C(═O)O-divalent chain group-OC(═O)O-divalent cyclic group-divalent chain group-OC(═O)—

The divalent chain group means an alkylene group, a substituted alkylene group, an alkenylene group, a substituted alkenylene group, an alkynylene group, or a substituted alkynylene group. The alkylene group, the substituted alkylene group, the alkenylene group, or the substituted alkenylene group is preferable, and the alkylene group or the alkenylene group is more preferable.

The alkylene group may have a branch. The alkylene group preferably has 1 to 12 carbon atoms, more preferably has 2 to 10 carbon atoms, and most preferably has 2 to 8 carbon atoms.

The alkylene moiety of the substituted alkylene group is the same as that of the above-mentioned alkylene group. Examples of the substituent include a halogen atom.

The alkenylene group may have a branch. The alkenylene group preferably has 2 to 12 carbon atoms, more preferably has 2 to 10 carbon atoms, and most preferably has 2 to 8 carbon atoms.

The alkenylene moiety of the substituted alkenylene group is the same as that of the alkenylene group. Examples of the substituent include a halogen atom.

The alkynylene group may have a branch. The alkynylene group preferably has 2 to 12 carbon atoms, more preferably has 2 to 10 carbon atoms, and most preferably has 2 to 8 carbon atoms.

The alkynylene moiety of the substituted alkynylene group is the same as that of the alkynylene group. Examples of the substituent include a halogen atom.

Specific examples of the divalent chain group include ethylene, trimethylene, propylene, tetramethylene, 2-methyl-tetramethylene, pentamethylene, hexamethylene, octamethylene, 2-butenylene, and 2-butynylene.

The definitions and the examples of the divalent cyclic group are the same as the definitions and the examples of Cy^{X1}, Cy^{X2}, and Cy^{X3} which will be described later.

L^{X2} or L^{X3} are each independently a single bond or a divalent linking group. L^{X2} and L^{X3} are each independently preferably a divalent linking group selected from the group consisting of —O—, —S—, —CO—, —NR^{x2}—, —CH═N—, a divalent chain group, a divalent cyclic group, a single bond, and a combination thereof. R^{x2} is a hydrogen atom or an alkyl group having 1 to 7 carbon atoms, preferably the hydrogen atom or an alkyl group having 1 to 4 carbon atoms, more preferably the hydrogen atom, a methyl group, or an ethyl group, and most preferably the hydrogen atom. The divalent chain group and the divalent cyclic group have the same definitions as the definitions of those in L^{X1} and L^{X4}.

Preferred examples of the divalent linking group as L^{X2} or L^{X3} include —C(═O)O—, —OC(═O)—, —OC(═O)O—, —OC(═O)NR^{x2}—, —COS—, —SCO—, —CONR^{x2}—, —NR^{x2}CO—, —(CR^{xa}R^{xb})ⱼₓ—, —CH═CH—C(═O)O—, —CH═N—, and —CH═N—N═CH—.

Here, R^{xa} and R^{xb} each independently represent a hydrogen atom or an alkyl group (for example, an alkyl group having 1 to 3 carbon atoms, and preferably a methyl group), and jx represents an integer of 1 or more, and is preferably an integer in the range of 1 to 3.

In the compound represented by General Formula (X), nx represents 0, 1, 2, or 3. In a case where nx is 2 or 3, the plurality of L^{X3}'s may be the same as or different from each other, and the plurality of Cy^{X2}'s may be the same as or different from each other. nx is preferably 1 or 2, and more preferably 1.

In the compound represented by General Formula (X), Cy^{X1}, Cy^{X2}, and Cy^{X3} are each independently a divalent cyclic group. The ring included in the divalent cyclic group is preferably a 5-membered ring, a 6-membered ring, or a 7-membered ring, more preferably the 5-membered ring or the 6-membered ring, and most preferably the 6-membered ring. The ring included in the cyclic group may be a fused ring. It should be noted that the ring is more preferably a monocyclic ring rather than the fused ring.

The ring included in the cyclic group may be any one of an aromatic ring, an aliphatic ring, or a heterocyclic ring. Examples of the aromatic ring include a benzene ring and a naphthalene ring. Examples of the aliphatic ring include a cyclohexane ring. Examples of the heterocyclic ring include a pyridine ring and a pyrimidine ring.

As the cyclic group having a benzene ring, 1,4-phenylene is preferable. As the cyclic group having a naphthalene ring, naphthalene-1,5-diyl and naphthalene-2,6-diyl are preferable. The cyclic group having a cyclohexane ring is preferably 1,4-cyclohexylene. As the cyclic group having a pyridine ring, pyridine-2,5-diyl is preferable. As the cyclic group having a pyrimidine ring, pyrimidine-2,5-diyl is preferable.

The cyclic group may have a substituent. Examples of the substituent include a halogen atom, a cyano group, a nitro group, an alkyl group having 1 to 5 carbon atoms, a halogen-substituted alkyl group having 1 to 5 carbon atoms, an alkoxy group having 1 to 5 carbon atoms, an alkylthio group having 1 to 5 carbon atoms, an acyloxy group having 2 to 6 carbon atoms, an alkoxycarbonyl group having 2 to 6 carbon atoms, a carbamoyl group, an alkyl-substituted carbamoyl group having 2 to 6 carbon atoms, and an acylamino group having 2 to 6 carbon atoms.

It is most preferable that the structure derived from the compound represented by General Formula (X) contains at least one selected from the group consisting of a compound represented by General Formula (X-I) and a compound represented by General Formula (X-II).

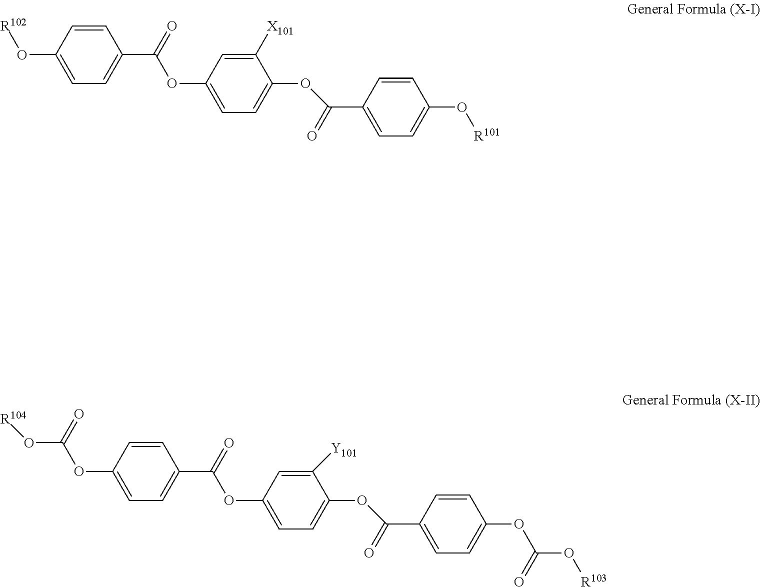

In General Formula (X-I) and General Formula (X-II), R¹⁰¹ to R¹⁰⁴ each independently represent a polymerizable group, and X₁₀₁ and Y₁₀₁ each independently represent a hydrogen atom, a methyl group, an ethyl group, a halogen group, an alkyl fluoride group, or an aldehyde group. Examples of the halogen group include a chlorine atom and a bromine atom.

The definitions of R¹⁰¹ to R¹⁰⁴ are the same as the definitions of Q^{X1} and Q^{x4}, but are each preferably a group represented by —(CH₂)ny-O(O═)C—CH═C(R^{xc}R^{xd}) Here, R^{xc} and R^{xd} each independently represent a hydrogen atom or an alkyl group (for example, an alkyl group having 1 to 3 carbon atoms, and preferably a methyl group), and ny is preferably an integer in the range of 2 to 8.

From the viewpoint of suppressing crystal precipitation, it is preferable that in General Formula (X-I) or (X-II), X₁₀₁ and Y₁₀₁ each represent a methyl group. From the viewpoint of showing the properties of a liquid crystal display, it is preferable that ny is an integer of 4 to 8.

Examples of the compound represented by General Formula (X) are shown below. The present invention is not limited thereto.

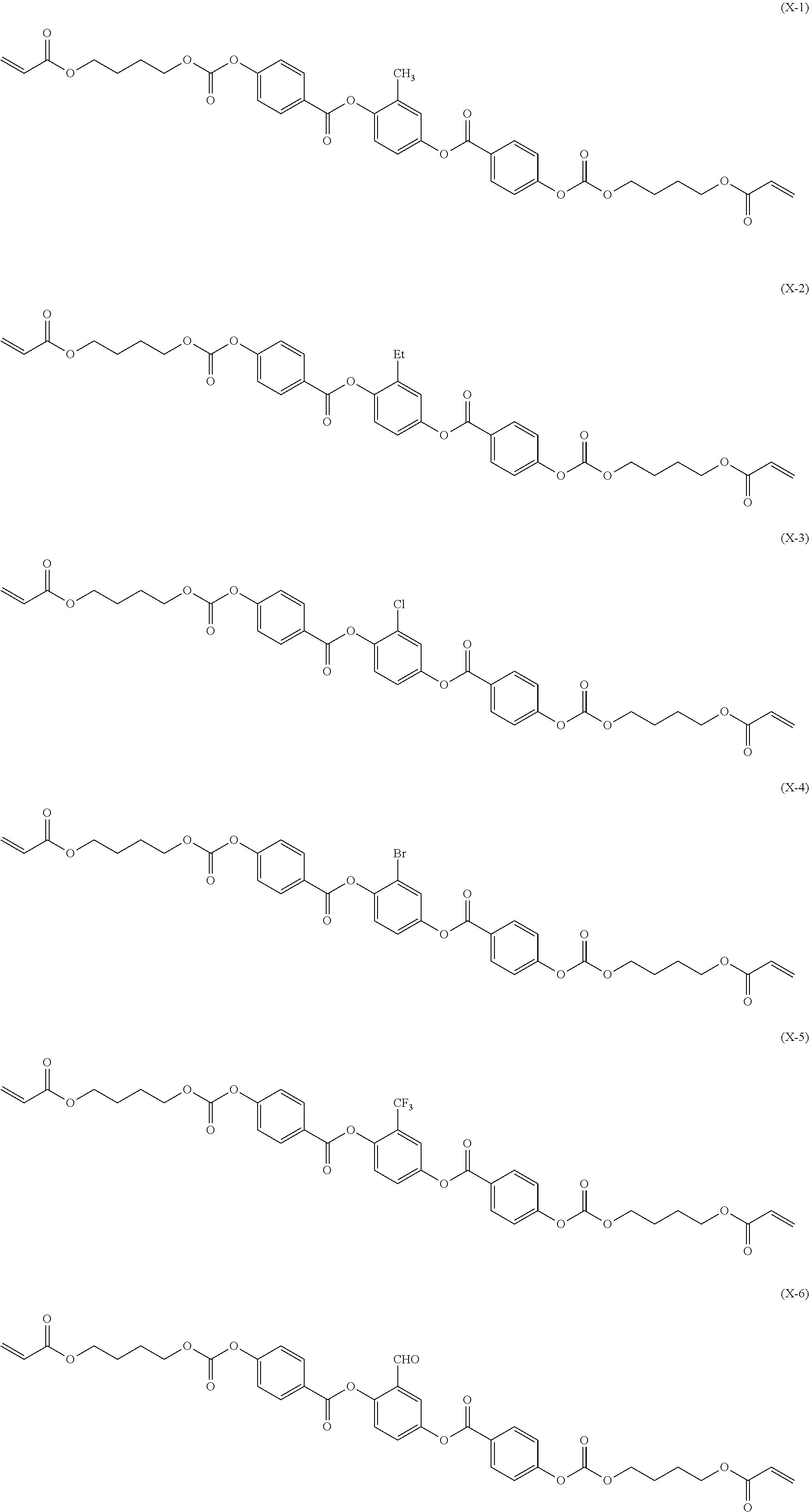

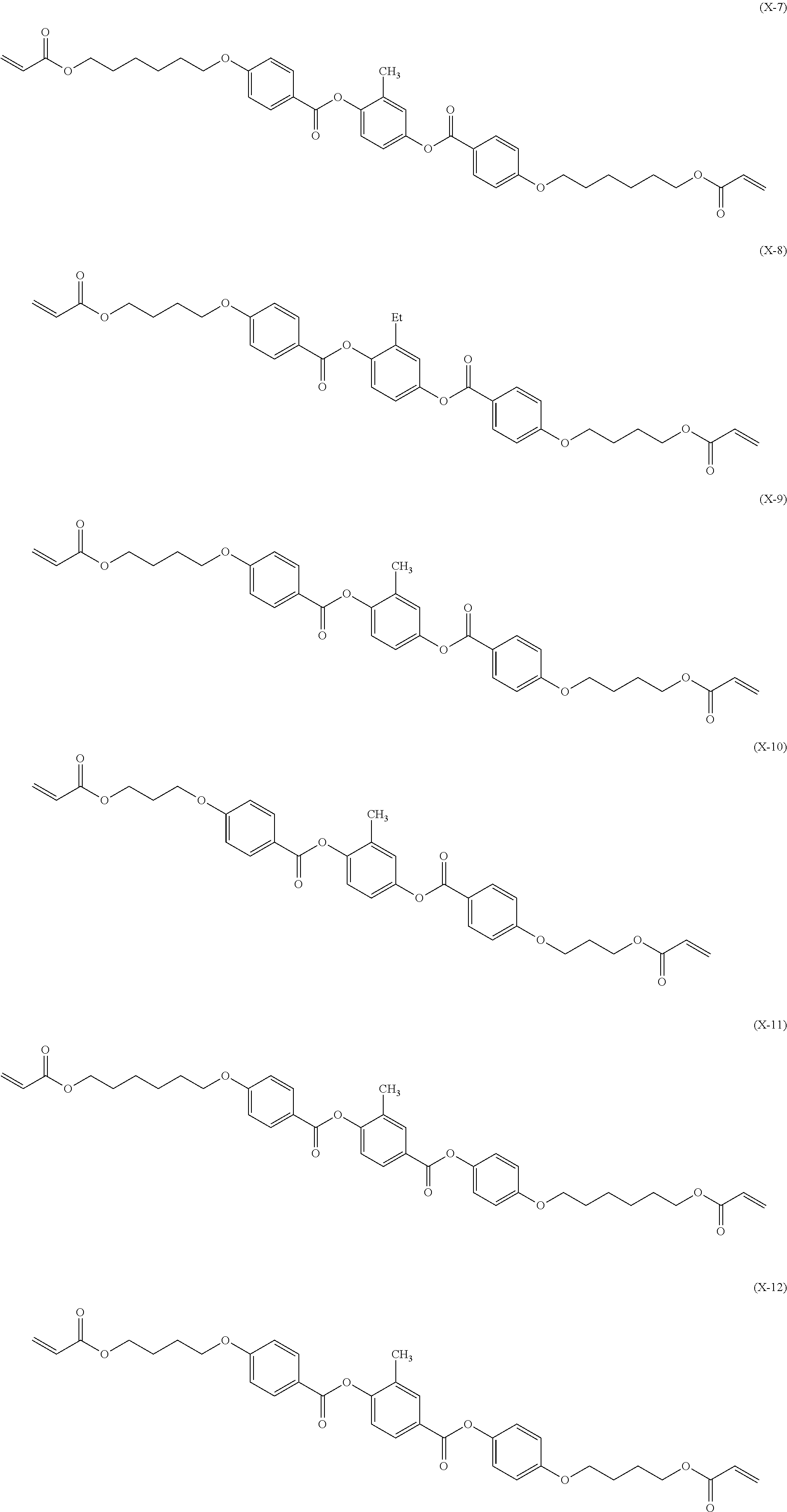

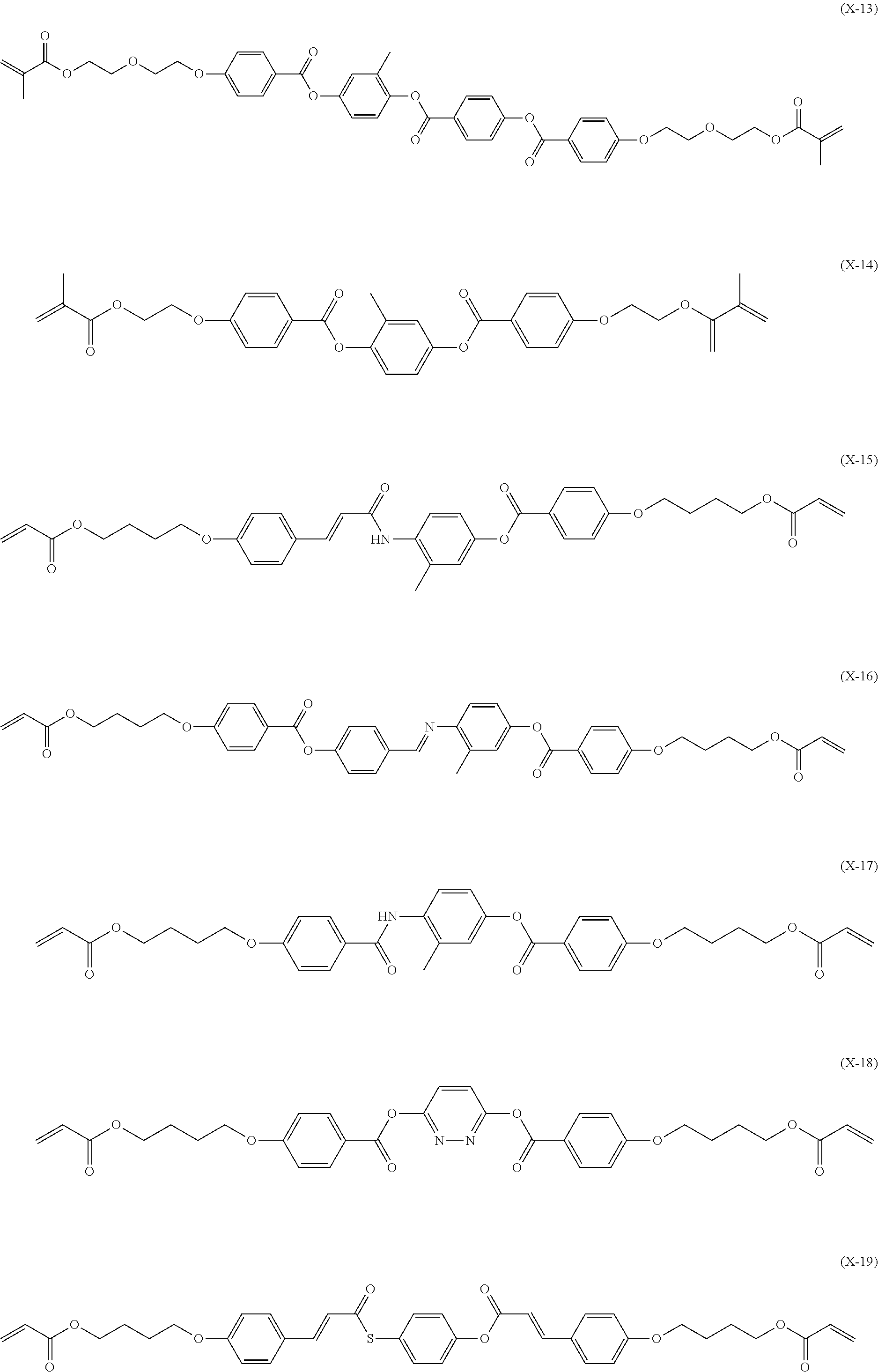

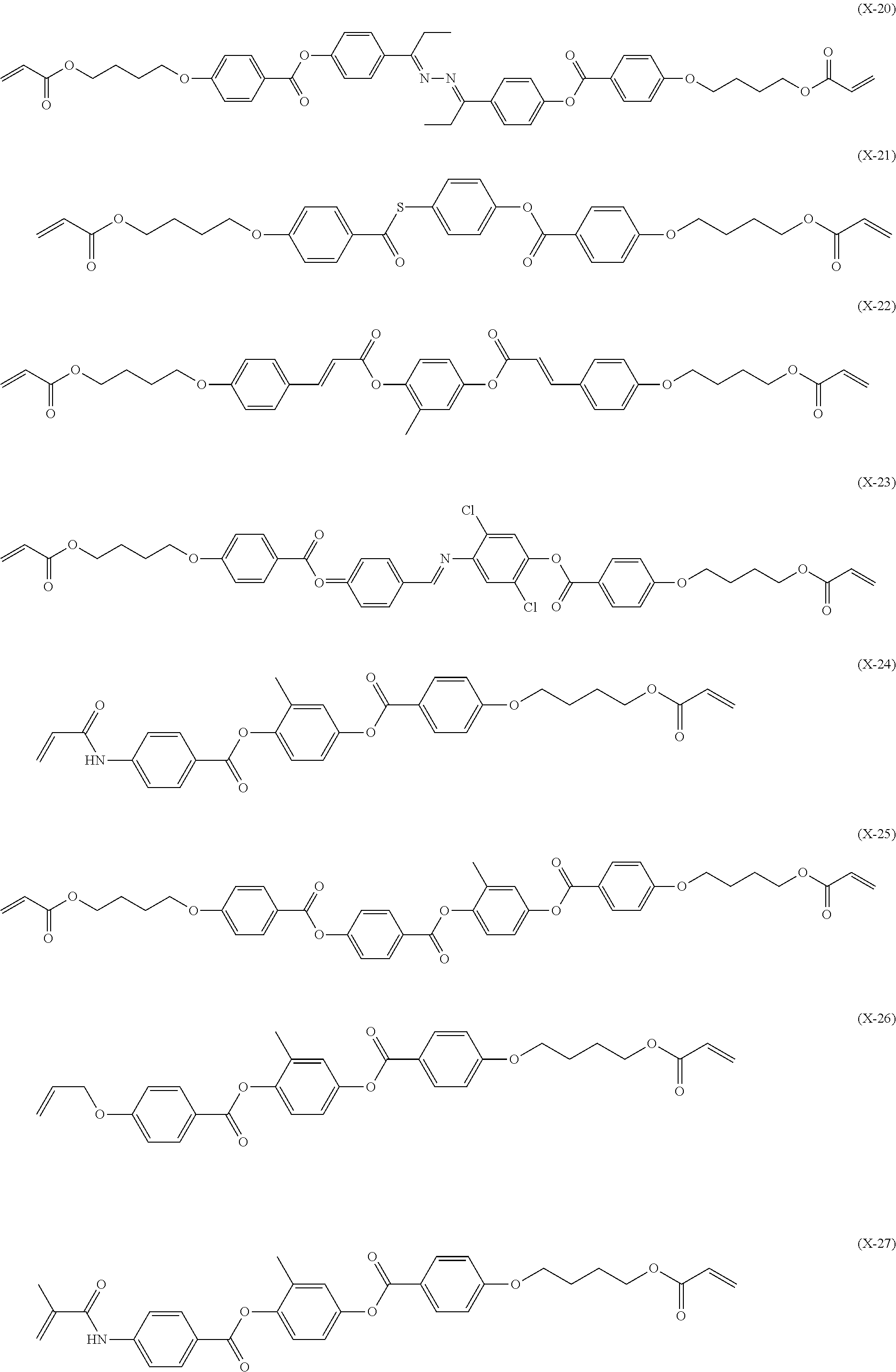

It is also preferable that a structure derived from a compound represented by General Formula (I-X) is included as a mesogenic group derived from the disk-like liquid crystal compound.

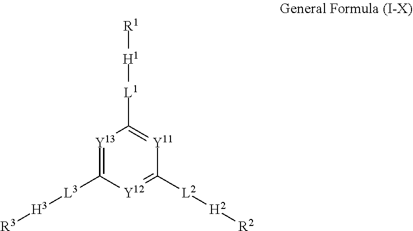

In General Formula (I-X), Y¹¹, Y¹², and Y¹³ each independently represent a methine which may have a substituent, or a nitrogen atom, L¹, L², and L³ each independently represent a single bond or a divalent linking group, and H¹, H², and H³ each independently represent a group represented by General Formula (I-A) or (I-B).

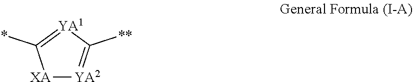

in General Formula (I-A), YA¹ and YA² each independently represent a methine which may have a substituent, or a nitrogen atom, XA represents an oxygen atom, a sulfur atom, a methylene, or an imino, * represents a position for bonding to an L¹ to L³ side in General Formula (I-X), and ** represents a position for bonding to an R¹ to R³ side in General Formula (I-X).

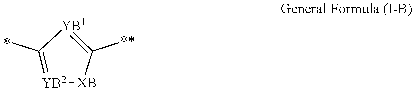

In General Formula (I-B), YB¹ and YB² each independently represent a methine which may have a substituent, or a nitrogen atom, XB represents an oxygen atom, a sulfur atom, a methylene, or an imino, * represents a position for bonding to the L¹ to L³ side in General Formula (I-X), and ** represents a position for bonding to the R¹ to R³ side in General Formula (I-X).

R¹, R², and R³ each independently represent General Formula (I-R).

*—(L^{r1}—Q²)ₙ₁—L^{r2}—L^{r3}—Q¹ General Formula (I-R)

In General Formula (I-R), * represents a position for bonding to the H¹ to H³ side in General Formula (I-X), L^{r1} represents a single bond or a divalent linking group, Q² represents a divalent group (cyclic group) having at least one cyclic structure, n1 represents an integer of 0 to 4, L^{r2} and L^{r3} each independently represent a divalent linking group, and Q¹ represents a polymerizable group or a hydrogen atom. It should be noted that in General Formula (I-X), at least two of the plurality of Q¹'s represent a polymerizable group.

In General Formula (I-X), Y¹¹, Y¹², and Y¹³ each independently represent a methine which may have a substituent, or a nitrogen atom, and are preferably a methine which may have a substituent, and the methine is more preferably unsubstituted.

Preferred examples of the substituent which may be contained in the methine include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Among these substituents, the alkyl group, the alkoxy group, the alkoxycarbonyl group, the acyloxy group, the halogen atom, and the cyano group are more preferable, and an alkyl group having 1 to 12 carbon atoms, an alkoxy group having 1 to 12 carbon atoms, an alkoxycarbonyl group having 2 to 12 carbon atoms, an acyloxy group having 2 to 12 carbon atoms, the halogen atom, and the cyano group are more preferable.

L¹, L², and L³ each independently represent a single bond or a divalent linking group.

In a case where L¹, L², and L³ are each the divalent linking group, L¹, L², and L³ are each independently preferably a divalent linking group selected from the group consisting of —O—, —S—, —C(═O)—, —NR⁷—, —CH═CH—, —C≡C—, a divalent cyclic group, and a combination thereof. R⁷ is a hydrogen atom or an alkyl group having 1 to 7 carbon atoms, preferably the hydrogen atom or an alkyl group having 1 to 4 carbon atoms, more preferably the hydrogen atom, a methyl group, or an ethyl group, and most preferably the hydrogen atom.

The divalent cyclic group in each of L¹, L², and L³ is a divalent linking group having at least one kind of cyclic structure (which may hereinafter be referred to as a cyclic group). The cyclic group is preferably a 5-membered ring, a 6-membered ring, or a 7-membered ring, more preferably the 5-membered ring or the 6-membered ring, and still more preferably the 6-membered ring. The ring included in the cyclic group may be a fused ring. It should be noted that the ring is more preferably a monocyclic ring rather than the fused ring. In addition, the ring included in the cyclic group may be any one of an aromatic ring, an aliphatic ring, or a heterocyclic ring. Preferred examples of the aromatic ring include a benzene ring and a naphthalene ring. Preferred examples of the aliphatic ring include a cyclohexane ring. As the heterocyclic ring, a ring including at least one of a sulfur atom, a nitrogen atom, or an oxygen atom is preferable, and preferred examples thereof include a pyridine ring, a pyrimidine ring, and an oxadiazole ring. The cyclic group is more preferably an aromatic ring or a heterocyclic ring. The divalent cyclic group in the present invention is more preferably a divalent linking group consisting of only a cyclic structure (provided that the group includes a substituent) (the same applies hereinafter).

Among the divalent cyclic groups represented by L¹, L², and L³, the cyclic group having a benzene ring is preferably a 1,4-phenylene group. As the cyclic group having a naphthalene ring, a naphthalene-1,5-diyl group and a naphthalene-2,6-diyl group are preferable. As the cyclic group having a cyclohexane ring, a 1,4-cyclohexylene group is preferable. As the cyclic group having a pyridine ring, a pyridine-2,5-diyl group is preferable. As the cyclic group having a pyrimidine ring, a pyrimidine-2,5-diyl group is preferable. As the cyclic group having an oxadiazole ring, a 1,2,4-oxadiazole-3,5-diyl group is preferable.

The divalent cyclic group represented by L¹, L², and L³ may have a substituent. Examples of the substituent include a halogen atom (preferably a fluorine atom and a chlorine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, an alkyl group-substituted carbamoyl group having 2 to 16 carbon atoms, and an acylamino group having 2 to 16 carbon atoms.

As L¹, L², and L³, a single bond, *—O—C(═O)—, *—C(═O)—O—, *—CH═CH—, *—C≡C—, *-divalent cyclic group-, *—O—C(═O)—divalent cyclic group-, *—C(═O)—O—divalent cyclic group—, *-CH═CH—divalent cyclic group-, *—C≡C—divalent cyclic group-, *-divalent cyclic group-O-C(═O)—, *-divalent cyclic group-C(═O)—O—, *-divalent cyclic group-CH═CH—, and *-divalent cyclic group-C≡C— are preferable. In particular, the single bond, *—CH═CH—, *—C≡C—, *—CH═CH-divalent cyclic group-, and *—C≡C—divalent cyclic group- are preferable, and the single bond is the most preferable. Here, * represents a position for bonding to the 6-membered ring side including Y¹¹, Y¹², and Y¹³ in General Formula (I-X).

In General Formula (I-X), H¹, H², and H³ each independently represent the group of General Formula (I-A) or (I-B).

R¹, R², and R³ each independently represent General Formula (I-R).

*—(L^{r1}—Q²)ₙ₁—L^{r2}—L^{r3}—Q¹ General Formula (I-R)

In General Formula (I-R), * represents a position for bonding to the H¹ to H³ side in General Formula (I-X). L^{r1} represents a single bond or a divalent linking group. Q² represents a divalent group (cyclic group) having at least one kind of cyclic structure.

L^{r1} represents a single bond or a divalent linking group. In a case where L^{r1} is the divalent linking group, it is preferably a divalent linking group selected from the group consisting of —O—, —S—, —C(═O)—, —NR⁷—, —CH═CH—, and —C≡C—, and a combination thereof. R⁷ is a hydrogen atom or an alkyl group having 1 to 7 carbon atoms, preferably the hydrogen atom or an alkyl group having 1 to 4 carbon atoms, more preferably the hydrogen atom, a methyl group, or a ethyl group, and most preferably the hydrogen atom.

L^{r1} is preferably any of the single bond, ***—O—CO—, ***—CO—O—, ***—CH═CH—, and ***—C≡C— (in which ***—C≡C— represents the * side in General Formula (I-R)), and more preferably the single bond.

Q² represents a divalent group (cyclic group) having at least one kind of cyclic structure. As such a cyclic group, a cyclic group having a 5-membered ring, a 6-membered ring, or a 7-membered ring is preferable, the cyclic group having a 5-membered ring or a 6-membered ring is more preferable, and the cyclic group having a 6-membered ring is still more preferable. The cyclic structure included in the cyclic group may be a fused ring. It should be noted that the ring is more preferably a monocyclic ring rather than the fused ring. In addition, the ring included in the cyclic group may be any one of an aromatic ring, an aliphatic ring, or a heterocyclic ring. Preferred examples of the aromatic ring include a benzene ring, a naphthalene ring, an anthracene ring, and a phenanthrene ring. Preferred examples of the aliphatic ring include a cyclohexane ring. As the heterocyclic ring, those having at least one nitrogen atom or oxygen atom are preferable, and preferred examples of the ring include a pyridine ring, a pyrimidine ring, and an oxadiazole ring.

Among the groups of Q², the 1,4-phenylene group is preferable as the cyclic group having a benzene ring. As the cyclic group having a naphthalene ring, a naphthalene-1,4-diyl group, a naphthalene-1,5-diyl group, a naphthalene-1,6-diyl group, a naphthalene-2,5-diyl group, or a naphthalene-2,6-diyl group, naphthalene-2,7-diyl group is preferable. As the cyclic group having a cyclohexane ring, a 1,4-cyclohexylene group is preferable. As the cyclic group having a pyridine ring, a pyridine-2,5-diyl group is preferable. As the cyclic group having a pyrimidine ring, a pyrimidine-2,5-diyl group is preferable. As the oxadiazole ring, a 1,2,4-oxadiazole-3,5-diyl group is preferable. Among these, the 1,4-phenylene group, the naphthalene-2,6-diyl group, the 1,4-cyclohexylene group, and the 1,2,4-oxadiazole-3,5-diyl group are particularly preferable.

Q² may have a substituent. Examples of the substituent include a halogen atom (a fluorine atom, a chlorine atom, a bromine atom, and an iodine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, an alkyl-substituted carbamoyl group having 2 to 16 carbon atoms, and an acylamino group having 2 to 16 carbon atoms. Among these, the halogen atom, the cyano group, the alkyl group having 1 to 6 carbon atoms, and the halogen-substituted alkyl group having 1 to 6 carbon atoms, are preferable, the halogen atom, an alkyl group having 1 to 4 carbon atoms, and a halogen-substituted alkyl group having 1 to 4 carbon atoms, are more preferable, and the halogen atom, an alkyl group having 1 to 3 carbon atoms, and a trifluoromethyl group are still more preferable.

n1 represents an integer of 0 to 4. n1 is preferably an integer of 1 to 3, and more preferably 1 or 2.

L^{r2} is preferably **—O—, **—O—C(═O)—, **—C(═O)—O—, **—O—C(═O)—O—, **—S—, **—NH—, **—SO₂—, **—CH₂—, **—CH═CH—, or **—C≡C—. ** represents the position to be bonded to Q².

L^{r2} is more preferably **—O—, **—O—C(═O)—, **—C(═O)—O—, **—O—C(═O)—O—, **—CH₂—, **—CH═CH—, or **—C≡C—, and still more preferably **—O—, **—O—C(═O)—, **—O—C(═O)—O—, or **—CH₂—.

In a case where L^{r2} is a group including a hydrogen atom, this hydrogen atom may be substituted with a substituent. Preferred examples of such a substituent include a halogen atom, a cyano group, a nitro group, an alkyl group having 1 to 6 carbon atoms, a halogen-substituted alkyl group having 1 to 6 carbon atoms, an alkoxy group having 1 to 6 carbon atoms, an acyl group having 2 to 6 carbon atoms, an alkylthio group having 1 to 6 carbon atoms, an acyloxy group having 2 to 6 carbon atoms, an alkoxycarbonyl group having 2 to 6 carbon atoms, a carbamoyl group, an alkyl-substituted carbamoyl group having 2 to 6 carbon atoms, and an acylamino group having 2 to 6 carbon atoms, and the substituent is more preferably the halogen atom or the alkyl group having 1 to 6 carbon atoms.

L^{r3} is preferably a divalent linking group selected from the group consisting of —O—, —S—, —C(═O)—, —SO₂—, —NH—, —CH₂—, —CH═CH—, and and a combination thereof. Here, the hydrogen atom of —NH—, —CH₂—, or —CH═CH— may be substituted with a substituent. Preferred examples of such a substituent include a halogen atom, a cyano group, a nitro group, an alkyl group having 1 to 6 carbon atoms, a halogen-substituted alkyl group having 1 to 6 carbon atoms, an alkoxy group having 1 to 6 carbon atoms, an acyl group having 2 to 6 carbon atoms, an alkylthio group having 1 to 6 carbon atoms, an acyloxy group having 2 to 6 carbon atoms, an alkoxycarbonyl group having 2 to 6 carbon atoms, a carbamoyl group, an alkyl-substituted carbamoyl group having 2 to 6 carbon atoms, and an acylamino group having 2 to 6 carbon atoms, and the substituent is more preferably the halogen atom or the alkyl group having 1 to 6 carbon atoms. By substituting with these substituents, a solubility in the solvent used in a case of preparing a liquid crystalline composition from the liquid crystal compound of the present invention can be improved.

Lr³ is preferably selected from the group consisting of —O—, —C(═O)—, —CH₂—, —CH═CH—, and —C≡C— and a combination thereof. L^{r3} preferably contains 1 to 20 carbon atoms, and more preferably contains 2 to 14 carbon atoms. Further, L^{r3} preferably contains 1 to 16 —CH₂—'s, and more preferably has 2 to 12 —CH₂—'s.

Q¹ represents a polymerizable group or a hydrogen atom, and in General Formula (I-X), at least two of a plurality of Q¹'s represent a polymerizable group. In addition, it is preferable that all of the plurality of Q¹'s are polymerizable groups. The definition of Q¹ is the same as the definitions of Q^{X1} and Q^{X4}, and the preferred range is also the same.

Among the compounds of General Formula (I-X), the compound represented by General Formula (I′) is more preferable.

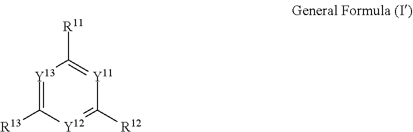

In General Formula (I′), Y¹¹, Y¹², and Y¹³ have the same definitions as Y¹¹, Y¹², and Y¹³ in General Formula (I-X), and R¹¹, R¹², and R¹³ each independently represent General Formula (I′-A), General Formula (I′-B), or General Formula (I′-C).

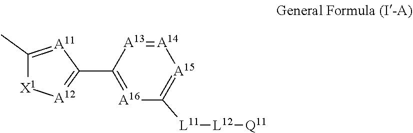

In General Formula (I′-A), A¹¹, A¹², A¹³, A¹⁴, A¹⁵ and A¹⁶ each independently represent a methine which may have a substituent, or a nitrogen atom, X¹ represents an oxygen atom, a sulfur atom, a methylene, or an imino, L¹¹, and L¹² each independently represent a divalent linking group, and Q¹¹ represents a polymerizable group or a hydrogen atom.

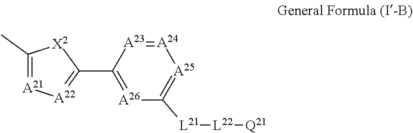

In General Formula (I′-B), A²¹, A²², A²³, A²⁴, A²⁵, and A²⁶ each independently represent a methine which may have a substituent, or a nitrogen atom, X² represents an oxygen atom, a sulfur atom, a methylene, or an imino, L²¹ and L²² each independently represent a divalent linking group, and Q²¹ represents a polymerizable group or a hydrogen atom.

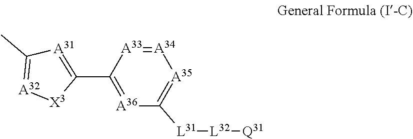

In General Formula (I′-C), A³¹, A³², A³³, A³⁴, A³⁵, and A³⁶ each independently represent a methine which may have a substituent, or a nitrogen atom, X³ represents an oxygen atom, a sulfur atom, a methylene, or an imino, L³¹ and L³² each independently represent a divalent linking group, and Q³¹ represents a polymerizable group or a hydrogen atom.

It should be noted that at least two of Q¹¹, Q²¹, or Q³¹ represent polymerizable groups.

In General Formula (I′), Y¹¹, Y¹², and Y¹³ have the same definitions as Y¹¹, Y¹², and Y¹³ in General Formula (I-X), and the preferred range is also the same.

R¹¹, R¹², and R¹³ each independently represent General Formula (I′-A), General Formula (I′-B), or General Formula (I′-C). In a case where it is intended to reduce the wavelength dispersibility of an intrinsic birefringence, General Formula (I′-A) or General Formula (I′-C) is preferable, and General Formula (I′-A) is more preferable. R¹¹, R¹², and R¹³ are preferably R¹¹═R¹²═R¹³.

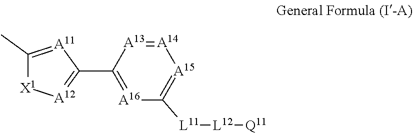

In General Formula (I′-A), A¹¹, A¹², A¹³, A¹⁴, A¹⁵ and A¹⁶ each independently represent a methine which may have a substituent, or a nitrogen atom.

It is preferable that at least one of A¹¹ or A¹² is a nitrogen atom, and it is more preferable that the both of A¹¹ and A¹² are nitrogen atoms.

It is preferable that at least three of A¹³, A¹⁴, A¹⁵ or A¹⁶ are methines which may have a substituent, and it is more preferable that all of A¹³, A¹⁴, A¹⁵ and A¹⁶ are methines which may have a substituent. Further, these methines are preferably unsubstituted.

Examples of the substituent in the case of the methine in which A¹¹, A¹², A¹³, A¹⁴, A¹⁵, or A¹⁶ may have a substituent include a halogen atom (a fluorine atom, a chlorine atom, a bromine atom, and an iodine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, an alkyl-substituted carbamoyl group having 2 to 16 carbon atoms, and an acylamino group having 2 to 16 carbon atoms. Among these, the halogen atom, the cyano group, the alkyl group having 1 to 6 carbon atoms, and the halogen-substituted alkyl group having 1 to 6 carbon atoms, are preferable, the halogen atom, an alkyl group having 1 to 4 carbon atoms, and a halogen-substituted alkyl group having 1 to 4 carbon atoms, are more preferable, and the halogen atom, an alkyl group having 1 to 3 carbon atoms, and a trifluoromethyl group are still more preferable.

X¹ represents an oxygen atom, a sulfur atom, a methylene, or an imino, and is preferably the oxygen atom.

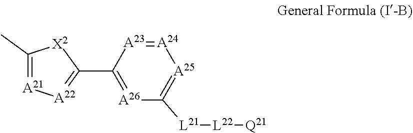

In General Formula (I′-B), A²¹, A²², A²³, A²⁴, A²⁵, and A²⁶ each independently represent a methine which may have a substituent, or a nitrogen atom.

It is preferable that at least one of A²¹ or A²² is the nitrogen atom, and it is more preferable that both of A²¹ and A²² are nitrogen atoms.

It is preferable that at least three of A²³, A²⁴, A²⁵, or A²⁶ are methines which may have a substituent, and it is more preferable that all of A²³, A²⁴, A²⁵, and A²⁶ are methines which may have a substituent. Further, these methines are preferably unsubstituted.

Examples of the substituent in the case of the methine in which A²¹, A²², A²³, A²⁴, A²⁵, or A²⁶ may have a substituent include a halogen atom (a fluorine atom, a chlorine atom, a bromine atom, and an iodine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, an alkyl-substituted carbamoyl group having 2 to 16 carbon atoms, and an acylamino group having 2 to 16 carbon atoms. Among these, the halogen atom, the cyano group, the alkyl group having 1 to 6 carbon atoms, and the halogen-substituted alkyl group having 1 to 6 carbon atoms, are preferable, the halogen atom, an alkyl group having 1 to 4 carbon atoms, and a halogen-substituted alkyl group having 1 to 4 carbon atoms, are more preferable, and the halogen atom, an alkyl group having 1 to 3 carbon atoms, and a trifluoromethyl group are still more preferable.

X² represents an oxygen atom, a sulfur atom, a methylene, or an imino, and is preferably the oxygen atom.

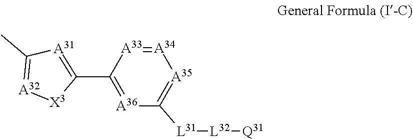

In General Formula (I′-C), A³¹, A³², A³³, A³⁴, A³⁵, and A³⁶ each independently represent a methine which may have a substituent, or a nitrogen atom.

It is preferable that at least one of A³¹ or A³² is the nitrogen atom, and it is more preferable that both of A³¹ and A³² are nitrogen atoms.

It is preferable that at least three of A³¹, A³⁴, A³⁵, or A³⁶ are methines which may have a substituent, and it is more preferable that all of A³³, A³⁴, A³⁵, and A³⁶ are methines which may have a substituent. Further, these methines are preferably unsubstituted.

In a case where A³¹, A³², A³¹, A³⁴, A³⁵ or A³⁶ are methines which may have a substituent, the methine may have a substituent. Examples of the substituent include a halogen atom (a fluorine atom, a chlorine atom, a bromine atom, and an iodine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, an alkyl-substituted carbamoyl group having 2 to 16 carbon atoms, and an acylamino group having 2 to 16 carbon atoms. Among these, the halogen atom, the cyano group, the alkyl group having 1 to 6 carbon atoms, and the halogen-substituted alkyl group having 1 to 6 carbon atoms, are preferable, the halogen atom, an alkyl group having 1 to 4 carbon atoms, and a halogen-substituted alkyl group having 1 to 4 carbon atoms, are more preferable, and the halogen atom, an alkyl group having 1 to 3 carbon atoms, and a trifluoromethyl group are still more preferable.

X³ represents an oxygen atom, a sulfur atom, a methylene, or imino, and the oxygen atom is preferable.

L¹¹ in General Formula (I′-A), L²¹ in General Formula (I′-B), and L³¹ in General Formula (I′-C) are each independently preferably —O—, —C(═O)—, —OC(═O)—, —C(═O)—O—, —OC(═O)—O—, —S—, —NH—, —SO₂—, —CH₂—, —CH═CH—, or C≡C—, more preferably —O—, —C(═O)—, —O—C(═O)—, —C(═O)—O—, —O—C(═O)—O—, —CH₂—, —CH═CH—, or —C≡C—, and still more preferably —O—, —O—C(═O)—, —C(═O)—O—, —O—C(═O)—O—, or —C≡C—. In particular, L¹¹ in General Formula (I′-A), which can be expected to have a small intrinsic birefringence wavelength dispersibility, is particularly preferably —O—, —C(═O)—O—, and —C≡C—, and among these, —C(═O)—O— is the most preferable since it can express a discotic nematic phase at a higher temperature. In a case where the above-mentioned group is a group including a hydrogen atom, this hydrogen atom may be substituted with a substituent. Preferred examples of such a substituent include a halogen atom, a cyano group, a nitro group, an alkyl group having 1 to 6 carbon atoms, a halogen-substituted alkyl group having 1 to 6 carbon atoms, an alkoxy group having 1 to 6 carbon atoms, an acyl group having 2 to 6 carbon atoms, an alkylthio group having 1 to 6 carbon atoms, an acyloxy group having 2 to 6 carbon atoms, an alkoxycarbonyl group having 2 to 6 carbon atoms, a carbamoyl group, an alkyl-substituted carbamoyl group having 2 to 6 carbon atoms, and an acylamino group having 2 to 6 carbon atoms, and the substituent is more preferably the halogen atom or the alkyl group having 1 to 6 carbon atoms.

L¹² in General Formula (I′-A), L²² in General Formula (I′-B), and L³² in General Formula (I′-C) are each independently preferably a divalent linking group selected from the group consisting of —O—, —S—, —C(═O)—, —SO₂—, —NH—, —CH₂—, —CH═CH—, and C≡C—, and a combination thereof. Here, the hydrogen atom of —NH—, —CH₂—, or —CH═CH— may be substituted with a substituent. Preferred examples of such a substituent include a halogen atom, a cyano group, a nitro group, a hydroxyl group, a carboxy group, an alkyl group having 1 to 6 carbon atoms, a halogen-substituted alkyl group having 1 to 6 carbon atoms, an alkoxy group having 1 to 6 carbon atoms, an acyl group having 2 to 6 carbon atoms, an alkylthio group having 1 to 6 carbon atoms, an acyloxy group having 2 to 6 carbon atoms, an alkoxycarbonyl group having 2 to 6 carbon atoms, a carbamoyl group, an alkyl-substituted carbamoyl group having 2 to 6 carbon atoms, and an acylamino group having 2 to 6 carbon atoms, and the substituent is more preferably the halogen atom, the hydroxyl group, or the alkyl group having 1 to 6 carbon atoms, and particularly preferably the halogen atom, a methyl group, or an ethyl group.

L¹², L²², and L³² are each independently preferably selected from the group consisting of —O—, —C(═O)—, —CH₂—, —CH═CH—, and C≡C—, and a combination thereof.

L¹², L²², and L³² each independently preferably have 1 to 20 carbon atoms, and more preferably have 2 to 14 carbon atoms. The number of carbon atoms is preferably 2 to 14, and the number of —CH₂—'s is more preferably 1 to 16, and still more preferably 2 to 12.

The number of carbon atoms constituting L¹², L²², and L³² affects the phase transition temperature of a liquid crystal and the solubility of the compound in a solvent. Generally, as the number of carbon atoms increases, the transition temperature from a discotic nematic phase (N_{D} phase) to an isotropic liquid tends to decrease. In addition, the solubility in a solvent generally tends to improve as the number of carbon atoms increases.

Q¹¹ in General Formula (I′-A), Q²¹ in General Formula (I′-B), and Q³¹ in General Formula (I′-C) each independently represent a polymerizable group or a hydrogen atom, and at least two of Q¹¹, Q²¹, or Q³¹ represent polymerizable groups. In addition, it is preferable that Q¹¹, Q²¹, and Q³¹ are all polymerizable groups. The examples of the polymerizable group are the same as those of the polymerizable group represented by Q^{X1} or Q^{X2} in General Formula (X), and preferred examples thereof are also the same.

Specific examples of the compound represented by General Formula (I-X) include the exemplary compounds described in paragraphs [0068] to [0077] of JP2010-244038A, and the exemplary compounds described in paragraphs [0040] to [0063] of JP2007-2220A. It should be noted that the present invention is not limited to these compounds.

The compound can be synthesized by various methods, and for example, it can be synthesized by the methods described in [0064] to [0070] of JP2007-2220A.

The discotic liquid crystal compound preferably exhibits a columnar phase and a discotic nematic phase (N_{D} phase) as the liquid crystal phase, and among these liquid crystal phases, the discotic nematic phase (N_{D} phase) exhibiting good monodomain properties is preferable.

It is also preferable that the disk-like liquid crystal compound includes a structure derived from the compound represented by General Formula (1).

D⁴¹—(L⁴¹—Q⁴¹)ₙ₄₁ General Formula (1)

In the formula, D⁴¹ represents a disk-like core, L⁴¹ represents a divalent linking group, Q⁴¹ represents a polymerizable group, and n₄₁ represents any one integer of 2 to 12.

Examples of the disk-like core (D⁴¹) of the formula are shown below. L represents a divalent linking group, and Q represents a polymerizable group.

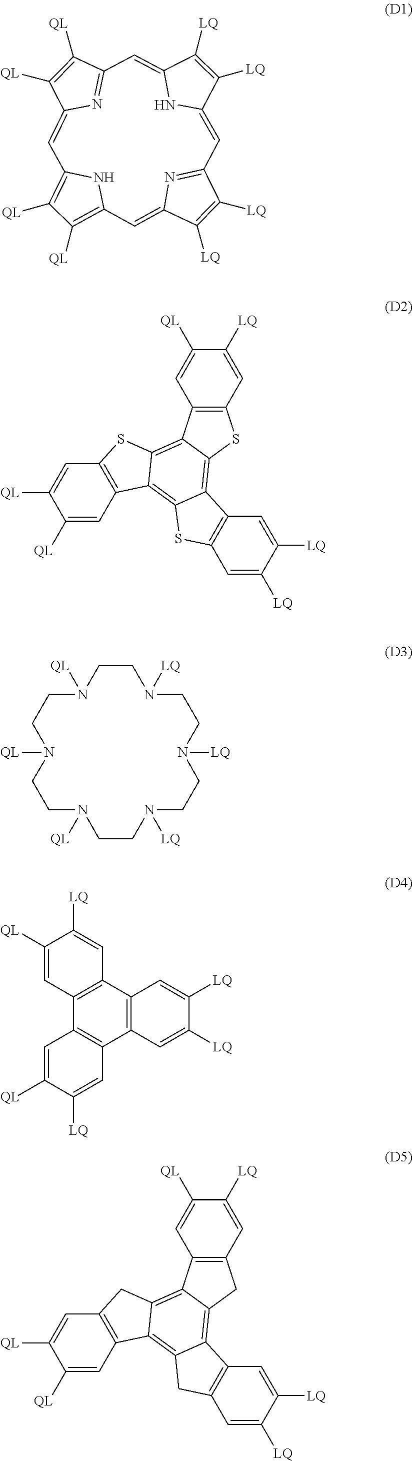

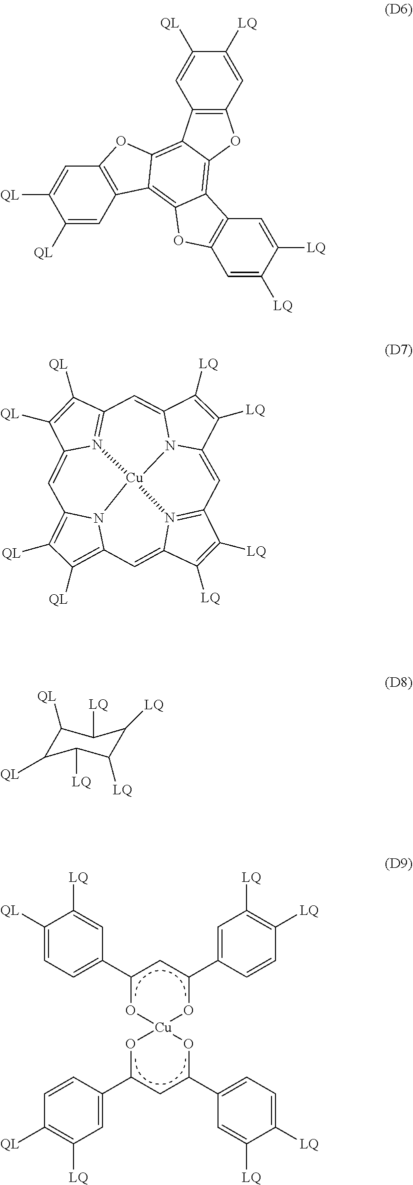

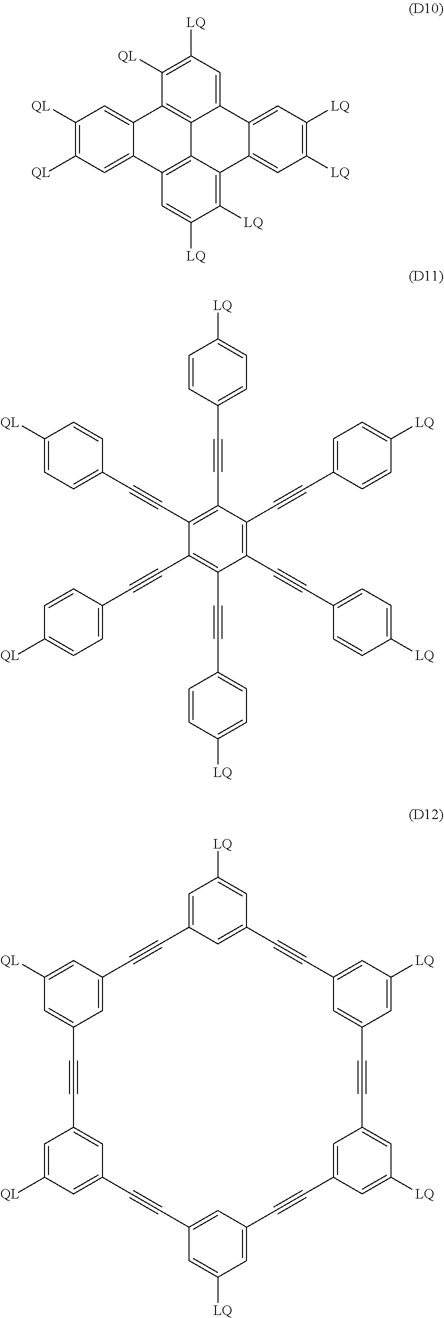

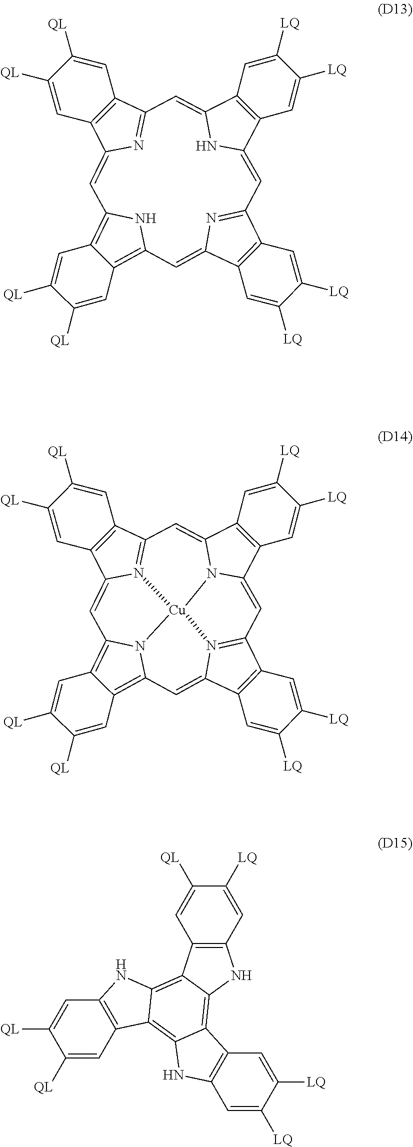

In General Formula (1), the divalent linking group (L⁴¹) is preferably a divalent linking group selected from the group consisting of an alkylene group, an alkenylene group, an arylene group, —CO—, —NH—, —O—, —S—, and a combination thereof. The divalent linking group (L⁴¹) is more preferably a group which is combination of at least two divalent groups selected from the group consisting of an alkylene group, an alkenylene group, an arylene group, —CO—, —NH—, —O—, and —S—. The divalent linking group (L⁴¹) is most preferably a group which is combination of at least two divalent groups selected from the group consisting of an alkylene group, an alkenylene group, an arylene group, —CO—, and —O—. The alkylene group preferably has 1 to 12 carbon atoms. The alkenylene group preferably has 2 to 12 carbon atoms. The arylene group preferably has 6 to 10 carbon atoms. The alkylene group, the alkenylene group, and the arylene group may have a substituent (for example, an alkyl group, a halogen atom, cyano, an alkoxy group, and an acyloxy group). Examples of the divalent linking group (L⁴¹) are shown below. * is bonded to the disk-like core (D⁴¹), and ** is bonded to the polymerizable group (Q⁴¹). AL means an alkylene group or an alkenylene group, and AR means an arylene group.

L₄₁-1: *—AL—CO—O—AL—**

L₄₁-2: *—AL—CO—O—AL—O—**

L₄₁-3: *—AL—CO—O—AL—O—AL—**

L₄₁-4: *—AL—CO—O—AL—O—CO—**

L₄₁-5: *—CO—AR—O—AL—**

L₄₁-6: *—CO—AR—O—AL—O—**

L₄₁-7: *—CO—AR—O—AL—O—CO—**

L₄₁-8: *—CO—NH—AL—**

L₄₁-9: *—NH—AL—O—**

L₄₁-10: *—NH—AL—O—CO—**

L₄₁-11: *—O—AL—**

L₄₁-12: *—O—AL—O—**

L₄₁-13: *—O—AL—O—CO—**

L₄₁-14: *—O—AL—O—CO—NH—AL—**

L₄₁-15: *—O—AL—S—AL—**

L₄₁-16: *—O—CO—AL-AR—O—AL—O—CO—**

L₄₁-17: *—O—CO—AR—O—AL—CO—**

L₄₁-18: *—O—CO—AR—O—AL—O—CO—**

L₄₁-19: *—O—CO—AR—O—AL—O—AL—O—CO—**

L₄₁-20: *—O—CO—AR—O—AL—O—AL—O—AL—CO—**

L₄₁-21: *—S—AL—**

L₄₁-22: *—S—AL—O—**

L₄₁-23: *—S—AL—O—CO—**

L₄₁-24: *—S—AL—S—AL—**

L₄₁-25: *—S—AR—AL—**

Q⁴¹ represents a polymerizable group, and has the same definition as the polymerizable group represented by Q^{X1} or Q^{X2} in General Formula (X). Furthermore, in a case where n41 is 2 or more, combinations of the plurality of L⁴¹'s and Q⁴¹'s present may be different, but are preferably the same.

As the structure derived from the compound represented by General Formula (1), the triphenylene derivatives represented by General Formulae (1) to (3) described in JP1995-306317A (JP-H07-306317A), the triphenylene derivative represented by General Formula (I) described in JP1995-309813A (JP-H07-309813A), and the triphenylene derivative represented by General Formula (I) described in JP2001-100028A are preferable. Among the triphenylene derivatives, the following compounds having a linking group between the triphenylene structure and the polymerizable group are the most preferable.

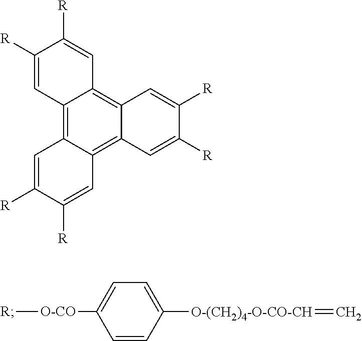

The fluorine-containing polymer of the embodiment of the present invention may have a structure derived from a liquid crystal compound other than those above. Specifically, the fluorine-containing polymer of the embodiment of the present invention may have a partial structure derived from the polymerizable liquid crystal compound in the section of “Composition” which will be described later. The partial structure is preferably introduced into the fluorine-containing polymer of the embodiment of the present invention as the repeating unit having a structure derived from a liquid crystal compound.

The partial structure includes a mesogen structure derived from a liquid crystal compound. Therefore, in a case where the fluorine-containing polymer of the embodiment of the present invention includes the partial structure, the compatibility between the polymerizable liquid crystal compound and the fluorine-containing polymer in the liquid crystal composition is improved. As a result, the wettability of the liquid crystal composition with respect to the substrate is further improved and cissing during application of the liquid crystal composition can be suppressed, whereby a more homogeneous film can be obtained. In particular, in a case where the content of the polymerizable liquid crystal compound in the liquid crystal composition is high, this effect is more remarkably expressed.

### Other Repeating Units

The fluorine-containing polymer of the embodiment of the present invention may further include a repeating unit other than those above. Examples of such the repeating unit include a repeating unit represented by Formula (VI).

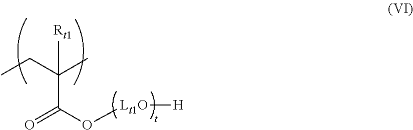

In Formula (VI), Rₜ₁ represents a hydrogen atom or a methyl group. Lₜ₁ represents an alkylene group having 1 to 4 carbon atoms. t represents an integer of 0 to 20.

The fluorine-containing polymer of the embodiment of the present invention is obtained by polymerizing monomers for obtaining each repeating unit by a known method. In the production of the fluorine-containing polymer of the embodiment of the present invention, only one kind of monomers for obtaining the repeating units represented by Formulae (I) to (III) may be used, or two or more kinds of the monomers may be mixed and used.

In addition, as the fluorine-containing polymer of the embodiment of the present invention, a monomer for obtaining a repeating unit other than the repeating units represented by Formulae (I) to (III) may be used alone or in mixture of two or more kinds thereof.

Specific examples of the fluorine-containing polymer of the embodiment of the present invention are shown below, but the present invention is not limited thereto.

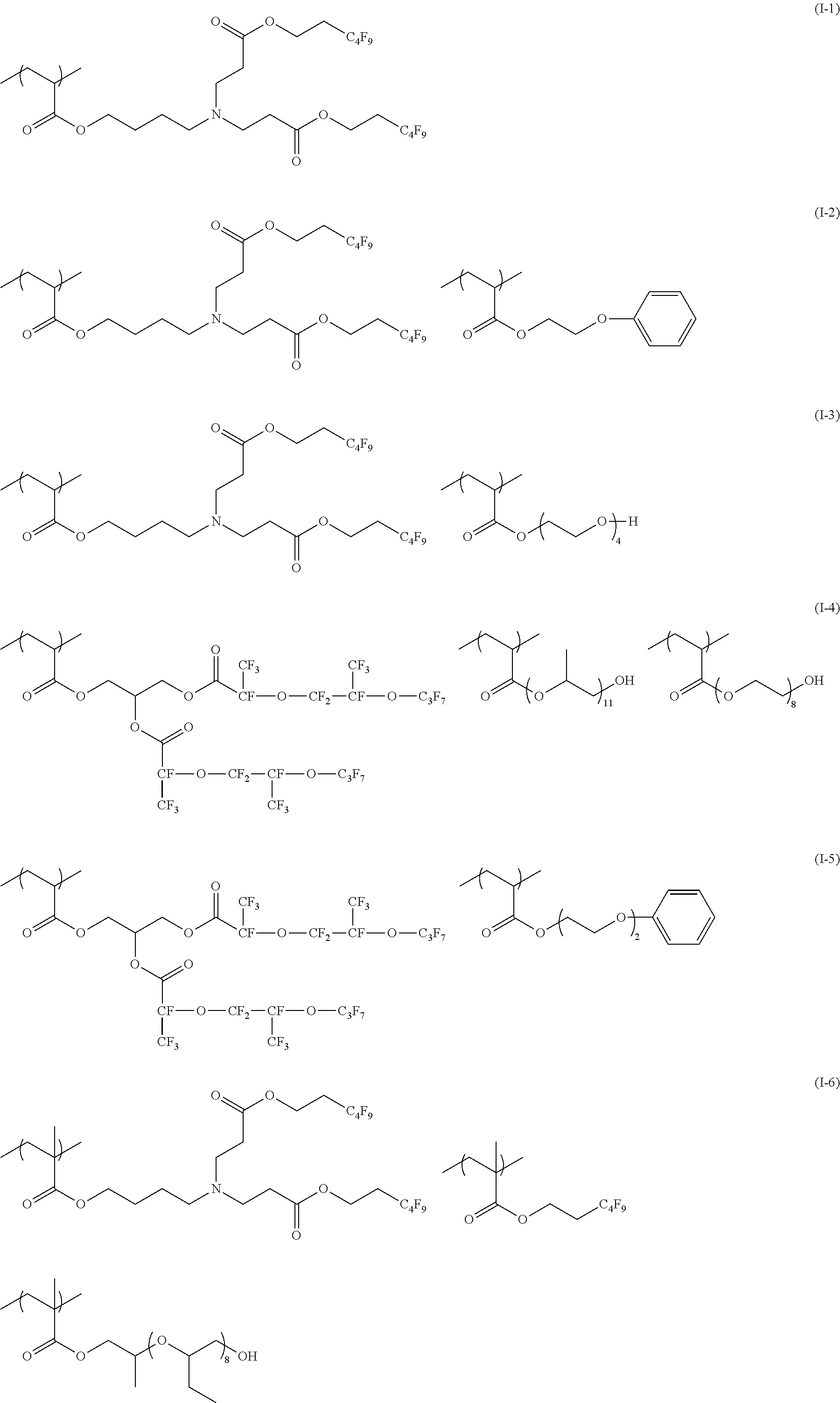

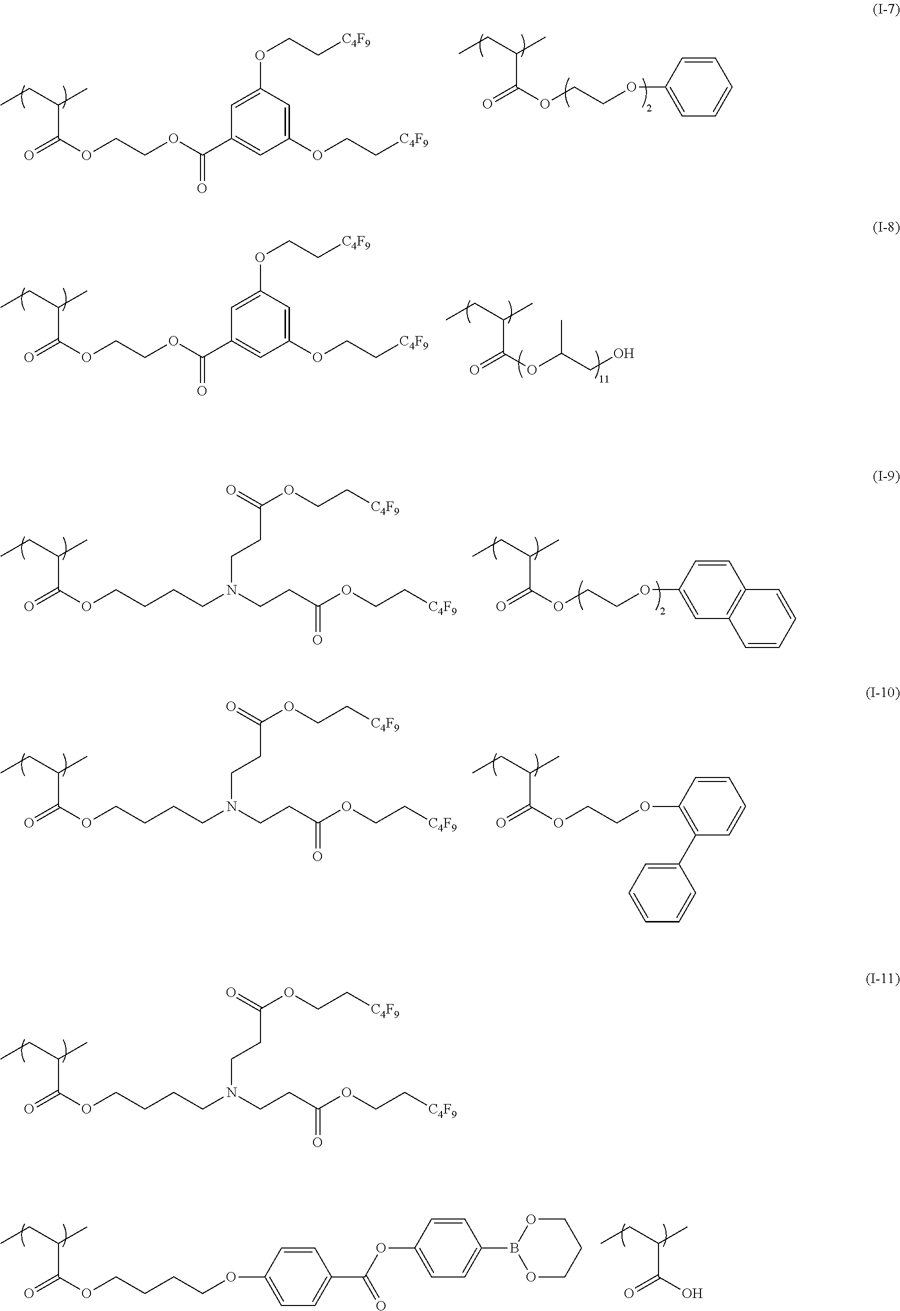

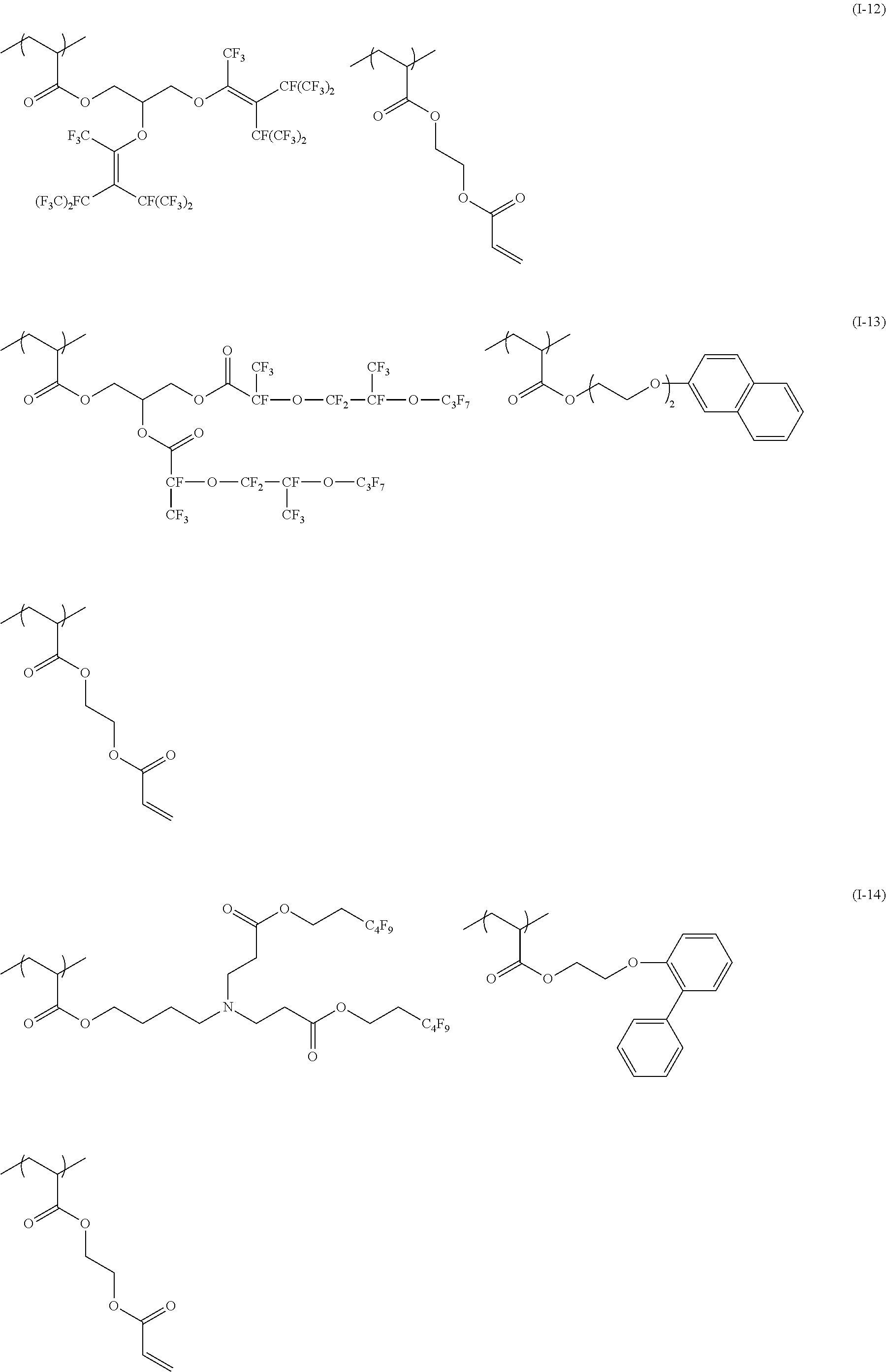

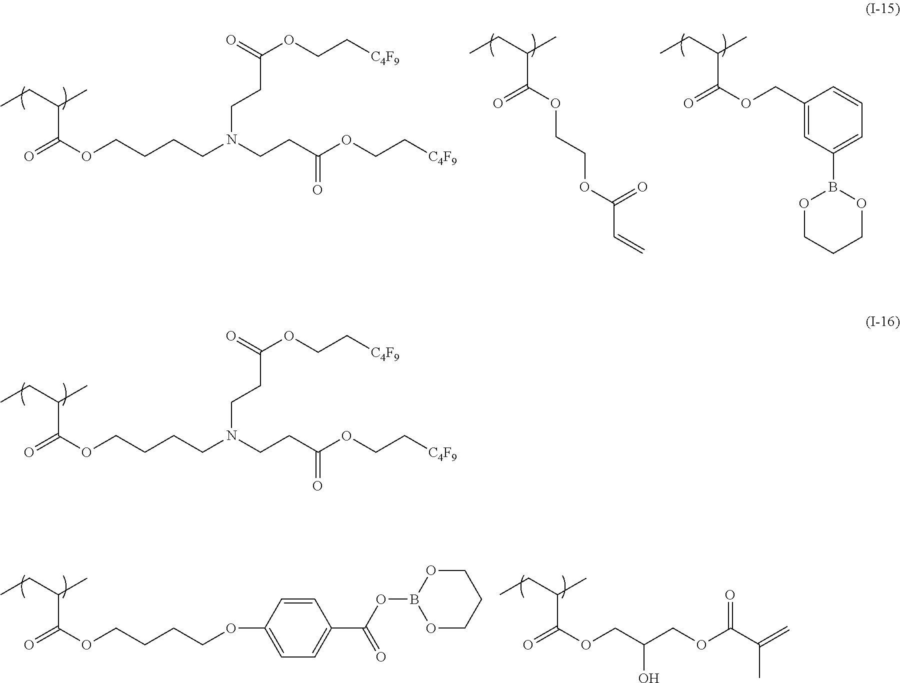

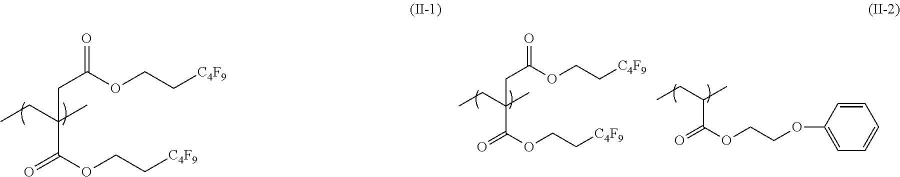

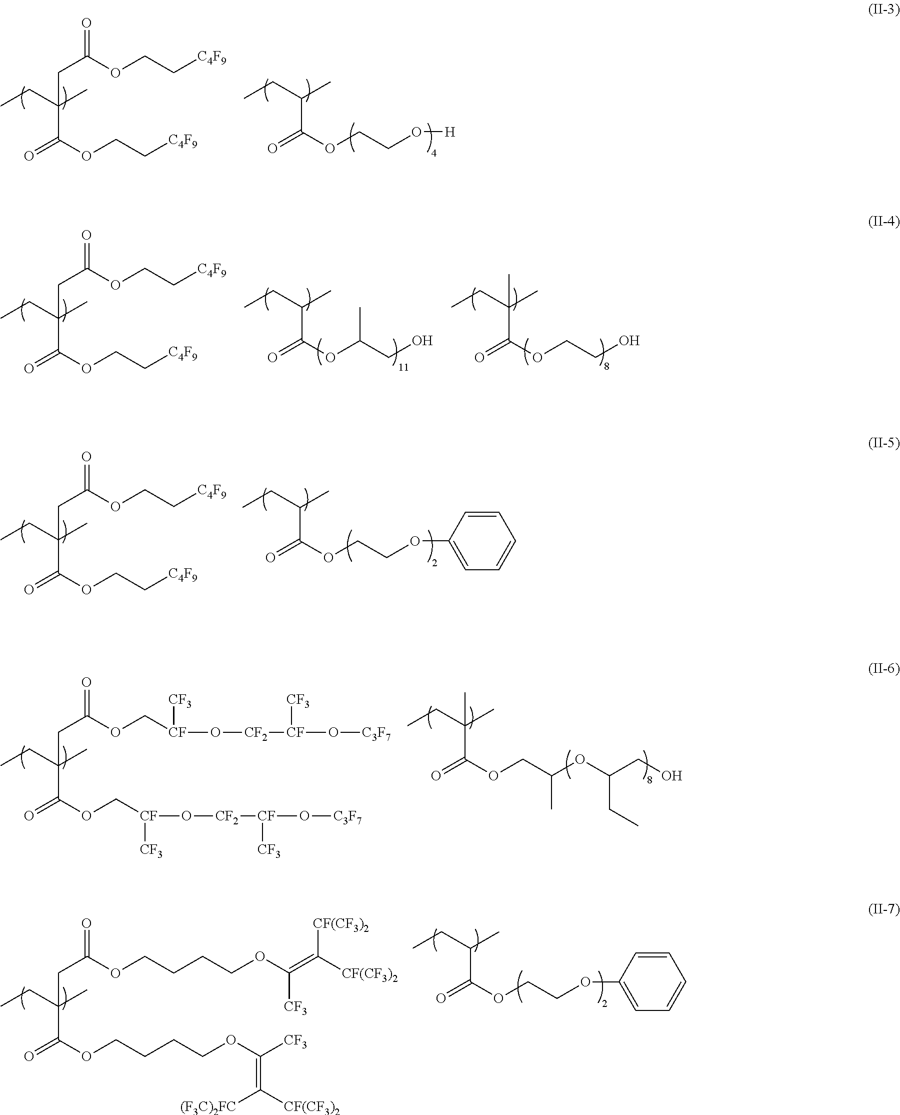

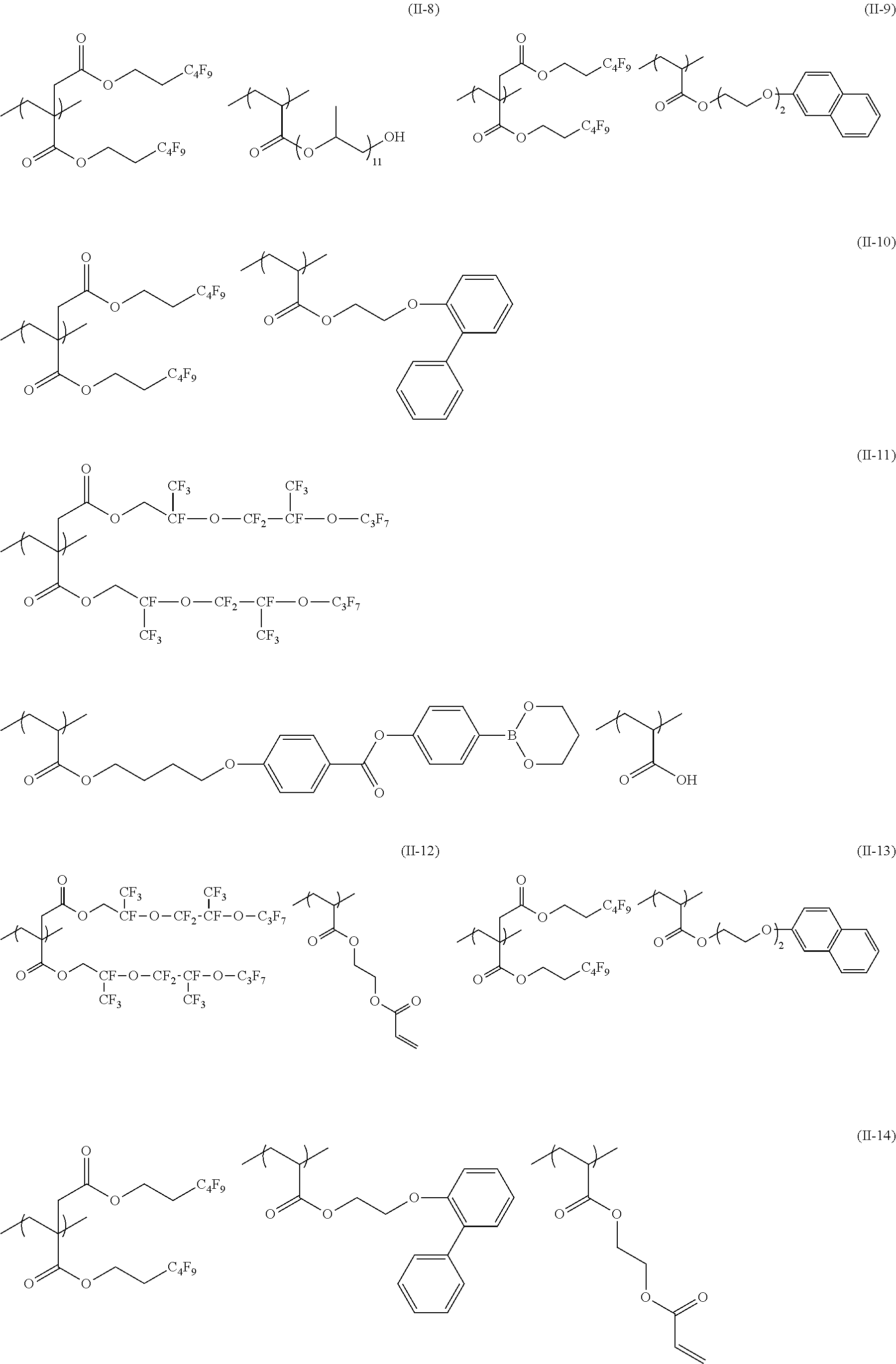

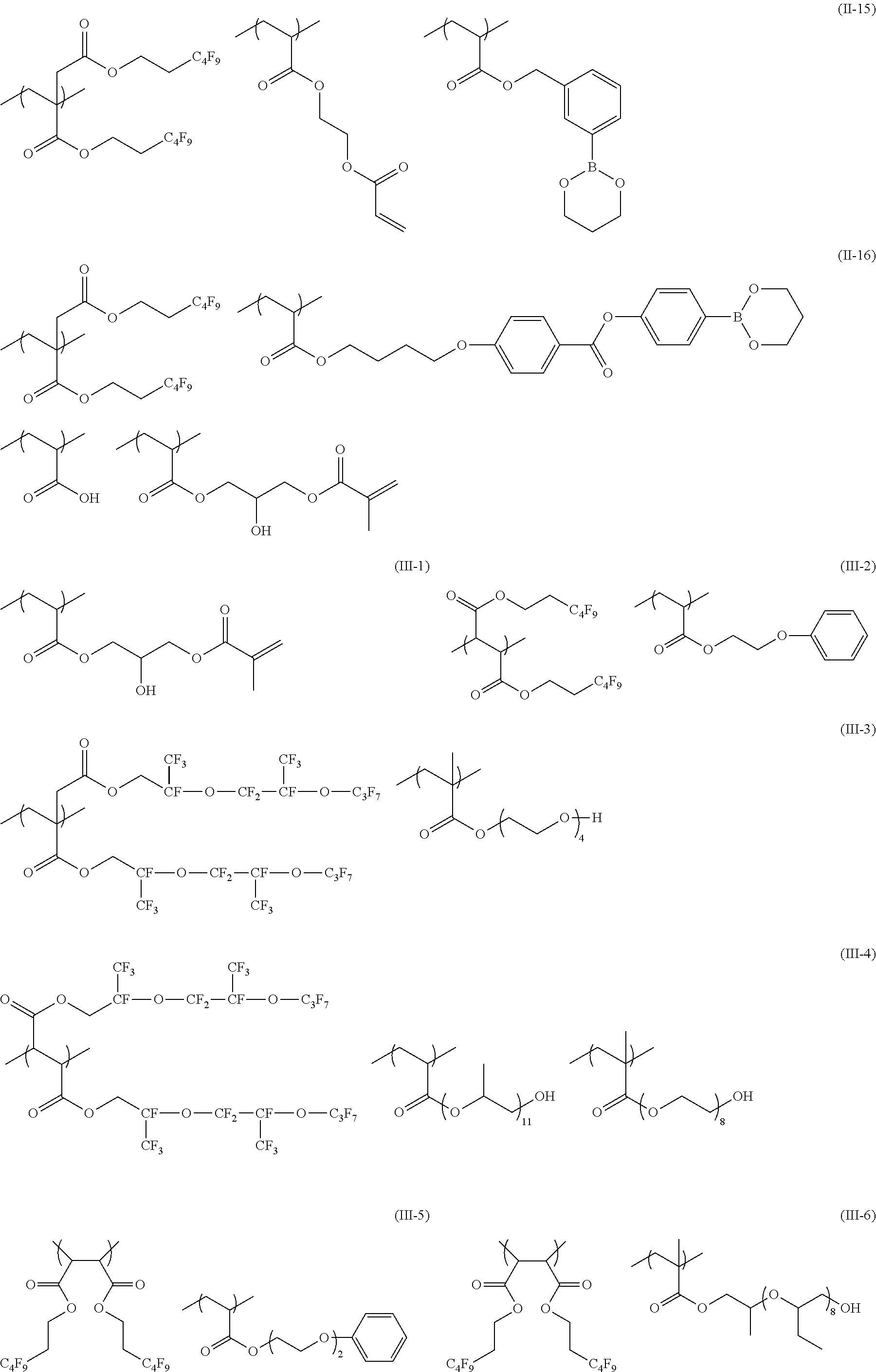

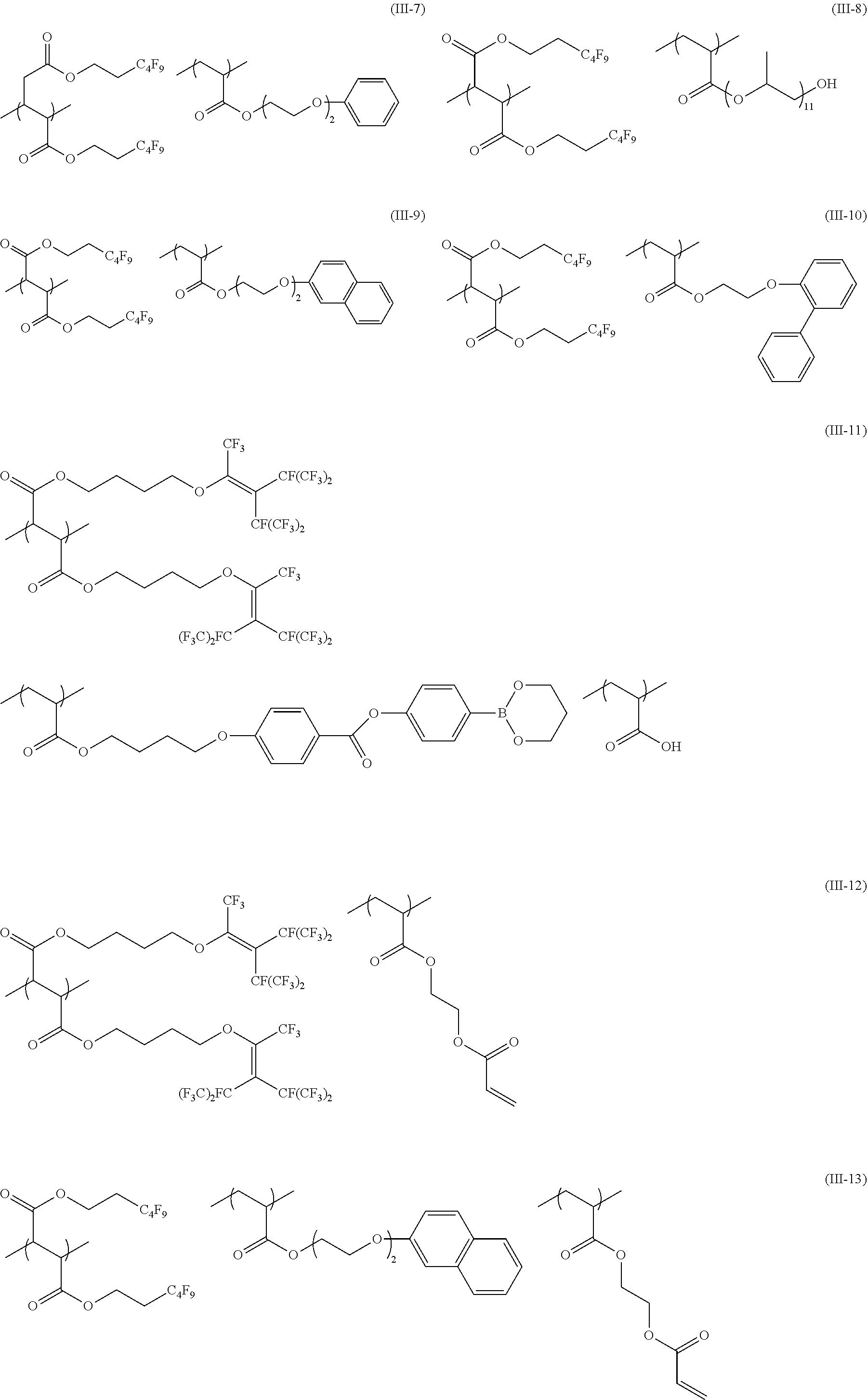

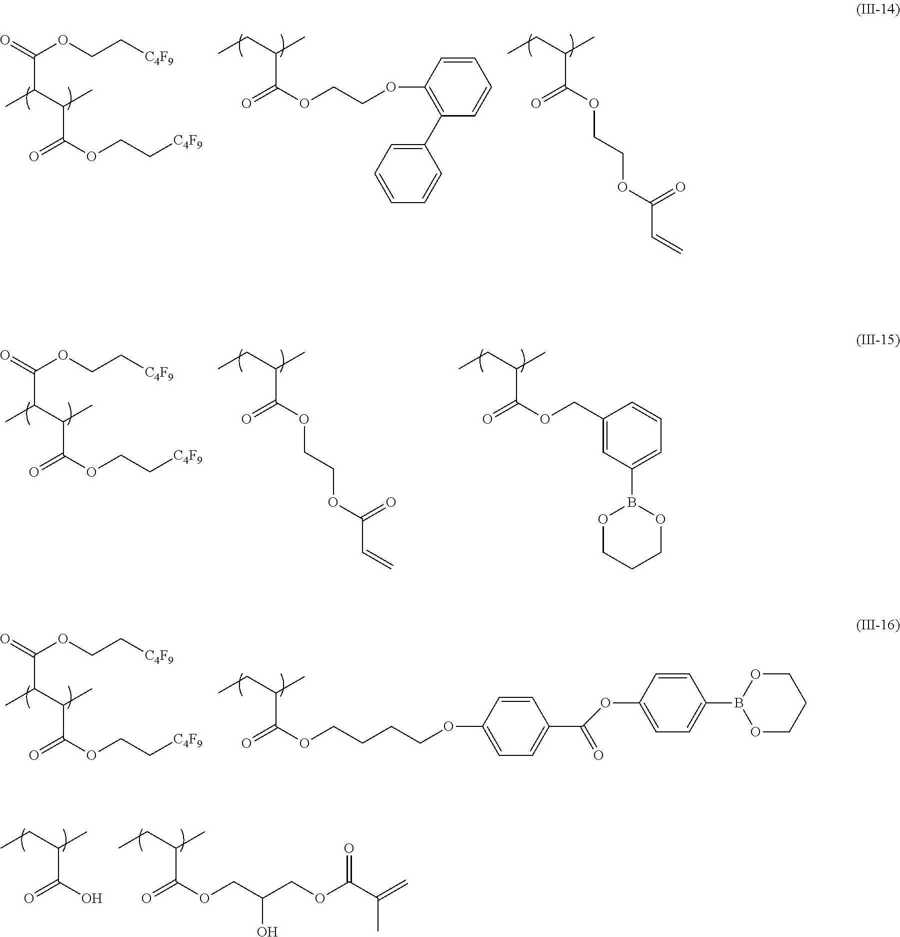

In the fluorine-containing polymer of the embodiment of the present invention, the content of the repeating units represented by General Formulae (I) to (III) is preferably 2% to 100% by mass, more preferably 3% to 90% by mass, and still more preferably 5% to 80% by mass with respect to the total mass of the fluorine-containing polymer.

In a case where the fluorine-containing polymer of the embodiment of the present invention includes a repeating unit represented by General Formula (IV), the content of the repeating unit represented by in General Formula (II) is preferably 1% to 95% by mass, more preferably 5% to 95% by mass, and still more preferably 10% to 90% by mass with respect to the total mass of the fluorine-containing polymer.

In a case where the fluorine-containing polymer of the embodiment of the present invention includes a repeating unit represented by General Formula (V), the content of the repeating unit represented by in General Formula (III) is preferably 0.1% to 95% by mass, more preferably 0.5% to 95% by mass, and still more preferably 1% to 90% by mass with respect to the total mass of the fluorine-containing polymer.

In a case where the fluorine-containing polymer of the embodiment of the present invention includes a repeating unit represented by General Formula (VI), the content of the repeating unit represented by in General Formula (IV) is preferably 0.1% to 90% by mass, more preferably 0.5% to 80% by mass, and still more preferably 1% to 70% by mass with respect to the total mass of the fluorine-containing polymer.

In a case where the fluorine-containing polymer of the embodiment of the present invention includes a partial structure formed by a radical polymerization of a compound having a mesogenic group derived from at least one liquid crystal compound selected from a rod-like liquid crystal compound or a disk-like liquid crystal compound, and two or more polymerizable groups, the content of the repeating unit including this partial structure is preferably 1% to 95% by mass, more preferably 5% to 95% by mass, and still more preferably 10% to 90% by mass with respect to the total mass of the fluorine-containing polymer.

In a case where the fluorine-containing polymer of the embodiment of the present invention is a copolymer obtained by using two or more kinds of monomers, it is also preferable that the fluorine-containing polymer of the embodiment of the present invention has a block structure, a graft structure, a branch structure, or a star structure.

The weight-average molecular weight (Mw) of the fluorine-containing polymer of the embodiment of the present invention is preferably 1,000 to 100,000, more preferably 1,500 to 90,000, and still more preferably 2,000 to 80,000. The number-average molecular weight (Mn) of the fluorine-containing polymer of the embodiment of the present invention is preferably 500 to 40,000, more preferably 600 to 35,000, and still more preferably 600 to 30,000.

The dispersity (Mw/Mn) of the fluorine-containing polymer of the embodiment of the present invention is preferably 1.00 to 12.00, more preferably 1.00 to 11.00, and still more preferably 1.00 to 10.00.

Furthermore, the weight-average molecular weight and the number-average molecular weight are values measured by gel permeation chromatography (GPC) under the following conditions.

[Eluent] Tetrahydrofuran (THF)

[Name of Device] EcoSEC HLC-8320GPC (manufactured by Tosoh Corporation)

[Column] TSKgel SuperHZM-H, TSKgel SuperHZ4000, TSKgel SuperHZ200 (manufactured by Tosoh Corporation)

[Column Temperature] 40° C.

[Flow Rate] 0.35 ml/min

### Composition

Next, a composition including the fluorine-containing polymer of the embodiment of the present invention (hereinafter also simply referred to as “the composition of an embodiment of the present invention”) will be described.

The composition of the embodiment of the present invention may contain a component other than the fluorine-containing copolymer, and preferably contains a compound for forming a film, and a solvent, in addition to the fluorine-containing polymer. In particular, by incorporating a polymerizable liquid crystal compound as the compound for forming a film, the composition can be used as a composition (coating liquid) for forming an optically anisotropic layer.

The liquid crystal composition, which is one of suitable aspects of the composition of the embodiment of the present invention, includes at least the fluorine-containing polymer of the embodiment of the present invention and a polymerizable liquid crystal compound.

Hereinafter, the components included in the liquid crystal composition will be described.

### Fluorine-Containing Polymer

The liquid crystal composition includes the fluorine-containing polymer of the embodiment of the present invention.

The content of the fluorine-containing polymer of the embodiment of the present invention is preferably 0.003% to 10% by mass, more preferably 0.005% to 5% by mass, and still more preferably 0.01% to 3% by mass with respect to the total mass of the liquid crystal composition. In a case where the content of the fluorine-containing polymer of the embodiment of the present invention is 0.003% by mass or more, a film having more excellent homogeneity can be obtained. In a case where the content of the fluorine-containing polymer of the embodiment of the present invention is 10% by mass or less, the aligning properties of the liquid crystal component included in the film are more excellent.

### Polymerizable Liquid Crystal Compound

The liquid crystal composition includes a polymerizable liquid crystal compound.

The polymerizable liquid crystal compound is a liquid crystal compound having at least one or more polymerizable groups.

Generally, the liquid crystal compounds can be classified into a rod-like type and a disk-like type, depending on the shape. Further, the respective types can further be classified into a low-molecular-weight type and a high-molecular-weight type. The high-molecular-weight compound generally refers to a polymer having a degree of polymerization of 100 or more (Kobunshi Butsuri Souten-I Dainamikusu (Polymer Physics and Phase Transition Dynamics), written by Masao Doi, p. 2, Iwanami Shoten, Publishers, 1992).

Any liquid crystal compound can be used as the polymerizable liquid crystal compound as long as it has a polymerizable group, and among those, the rod-like polymerizable liquid crystal compound or the disk-like polymerizable liquid crystal compound is preferably used, and the rod-like polymerizable liquid crystal compound is more preferably used.

In addition, the liquid crystal composition may further include a liquid crystal compound other than the polymerizable liquid crystal compound.

The polymerizable liquid crystal compound preferably has two or more polymerizable groups in one molecule. In addition, in a case where two or more polymerizable liquid crystal compounds are used, it is preferable that at least one of the polymerizable liquid crystal compounds has two or more polymerizable groups in one molecule.

Moreover, after fixing the liquid crystal compound by the polymerization, it is already not necessary to exhibit the liquid crystallinity, but a layer thus formed is conveniently referred to as a liquid crystal layer in some cases. The liquid crystal layer is preferably a layer in which the aligned liquid crystal compound is fixed while the alignment state is maintained.

The type of the polymerizable group contained in the polymerizable liquid crystal compound is not particularly limited, a functional group capable of performing an addition polymerization reaction is preferable, and an ethylenically unsaturated polymerizable group or a ring polymerizable group is preferable. More specifically, a (meth)acryloyl group, a vinyl group, a styryl group, an allyl group, an epoxy group, or an oxetane group is preferable, and from the viewpoint of a high rate in the polymerization reaction rate, the (meth)acryloyl group is more preferable.

Examples of the rod-like polymerizable liquid crystal compound include the compounds described in claim 1 of JP1999-513019A (JP-H11-513019A) and paragraphs [0026] to [0098] of JP2005-289980A. Examples of the disk-like polymerizable liquid crystal compound include the compounds described in paragraphs [0020] to [0067] of JP2007-108732A and the compounds described in paragraphs [0013] to [0108] of JP2010-244038A.

Moreover, examples of the rod-like polymerizable liquid crystal compound include a liquid crystal compound capable of expressing a smectic phase, and include, for example, the compounds described in JP2016-51178A, JP2008-214269A, JP2008-19240A, and JP2006-276821A.

Furthermore, as the rod-like polymerizable liquid crystal compound, a polymerizable liquid crystal compound having a maximum absorption wavelength in a wavelength range of 330 to 380 nm is preferable.

In addition, the rod-like polymerizable liquid crystal compound is a preferably polymerizable liquid crystal compound having reverse wavelength dispersibility.

Here, the polymerizable liquid crystal compound having “reverse wavelength dispersibility” in the present specification means that in a case where an in-plane retardation value (Re) at a specific wavelength (visible light range) of a phase difference film (an optically anisotropic layer and the like) manufactured using the polymerizable liquid crystal compound is measured, Re is equal to or higher as the measurement wavelength is increased.

Specifically, a polymerizable liquid crystal compound capable of forming an optically anisotropic layer satisfying Formula is preferable.

Re(450)/Re(550)<1.00

Here, in the formula, Re(450) represents an in-plane retardation at a wavelength of 450 nm of the optically anisotropic layer, and Re(550) represents an in-plane retardation at a wavelength of 550 nm of the optically anisotropic layer. The in-plane retardation value can be measured with light at a measurement wavelength using AxoScan OPMF-1 (manufactured by Opto Science, Inc.).

### General Formulae (A1) to (A7)

The polymerizable liquid crystal compound is preferably a compound having a group selected from the group consisting of groups represented by General Formulae (A1) to (A7). By incorporation of such a group, reverse wavelength dispersibility is easily incorporated into the polymerizable liquid crystal compound.

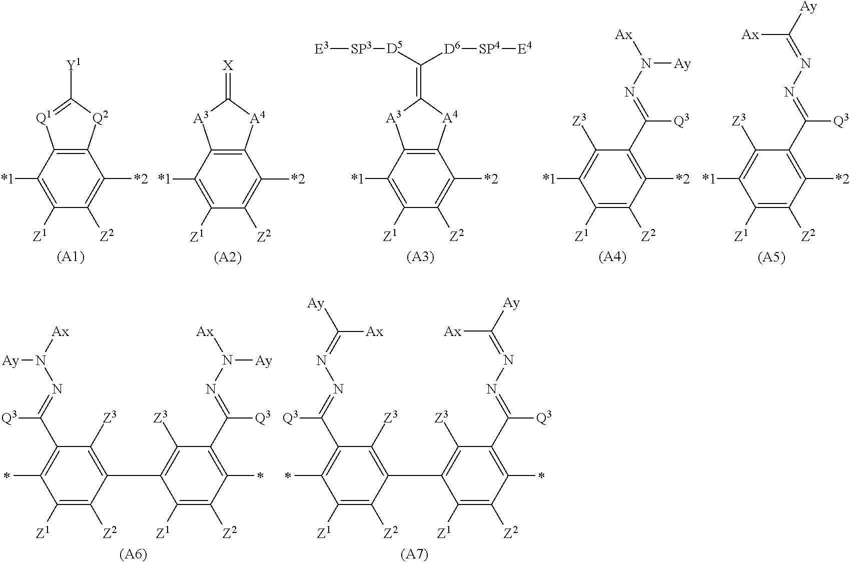

In General Formulae (A1) to (A7), *1 and *2 each represent a bonding position.

In General Formula (A1), Q¹ represents N or CH, Q² represents —S—, —O—, or —N(J⁵)—, J⁵ represents a hydrogen atom or an alkyl group having 1 to 6 carbon atoms, and Y¹ represents an aromatic hydrocarbon group having 6 to 12 carbon atoms or an aromatic heterocyclic group having 3 to 12 carbon atoms, each of which may have a substituent.

Specific examples of the alkyl group having 1 to 6 carbon atoms, represented by J⁵, include a methyl group, an ethyl group, a propyl group, an isopropyl group, an n-butyl group, an isobutyl group, a sec-butyl group, a tert-butyl group, an n-pentyl group, and an n-hexyl group.

Examples of the aromatic hydrocarbon group having 6 to 12 carbon atoms, represented by Y¹, include an aryl group such as a phenyl group, a 2,6-diethylphenyl group, and a naphthyl group.

Examples of the aromatic heterocyclic group having 3 to 12 carbon atoms, represented by Y¹, include a heteroaryl group such as a thienyl group, a thiazolyl group, a furyl group, and a pyridyl group.

Furthermore, examples of the substituent which may be contained in Y¹ include an alkyl group, an alkoxy group, and a halogen atom.

As the alkyl group, for example, a linear, branched, or cyclic alkyl group having 1 to 18 carbon atoms is preferable, an alkyl group having 1 to 8 carbon atoms (for example, a methyl group, an ethyl group, a propyl group, an isopropyl group, an n-butyl group, an isobutyl group, a sec-butyl group, a t-butyl group, and a cyclohexyl group) is more preferable, an alkyl group having 1 to 4 carbon atoms is still more preferable, and the methyl group or the ethyl group is particularly preferable.

As the alkoxy group, for example, an alkoxy group having 1 to 18 carbon atoms is preferable, and an alkoxy group having 1 to 8 carbon atoms (for example, a methoxy group, an ethoxy group, an n-butoxy group, and a methoxyethoxy group) is more preferable, an alkoxy group having 1 to 4 carbon atoms is still more preferable, and the methoxy group or the ethoxy group is particularly preferable.

Examples of the halogen atom include a fluorine atom, a chlorine atom, a bromine atom, and an iodine atom, and among those, the fluorine atom or the chlorine atom is preferable.

In addition, in General Formulae (A1) to (A7), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —NJ⁶J⁷, or —SJ⁸, J⁶ to J⁸ each independently represent a hydrogen atom or an alkyl group having 1 to 6 carbon atoms, and Z¹ and Z² may be bonded to each other to form an aromatic ring.

As the monovalent aliphatic hydrocarbon group having 1 to 20 carbon atoms, an alkyl group having 1 to 15 carbon atoms is preferable, an alkyl group having 1 to 8 carbon atoms is more preferable, specifically, a methyl group, an ethyl group, an isopropyl group, a tert-pentyl group (1,1-dimethylpropyl group), a tert-butyl group, or a 1,1-dimethyl-3,3-dimethyl-butyl group is still more preferable, and the methyl group, the ethyl group, or the tert-butyl group is particularly preferable.

Examples of the monovalent alicyclic hydrocarbon group having 3 to 20 carbon atoms include a monocyclic saturated hydrocarbon group such as a cyclopropyl group, a cyclobutyl group, a cyclopentyl group, a cyclohexyl group, a cycloheptyl group, a cyclooctyl group, a cyclodecyl group, a methylcyclohexyl group, and an ethylcyclohexyl group; a monocyclic unsaturated hydrocarbon group such as a cyclobutenyl group, a cyclopentenyl group, a cyclohexenyl group, a cycloheptenyl group, a cyclooctenyl group, a cyclodecenyl group, a cyclopentadienyl group, a cyclohexadienyl group, a cyclooctadienyl group, and cyclodecadiene; and a polycyclic saturated hydrocarbon group such as a bicyclo[2.2.1]heptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Specific examples of the monovalent aromatic hydrocarbon group having 6 to 20 carbon atoms include a phenyl group, a 2,6-diethylphenyl group, a naphthyl group, and a biphenyl group, and an aryl group having 6 to 12 carbon atoms (particularly a phenyl group) is preferable.

Examples of the halogen atom include a fluorine atom, a chlorine atom, a bromine atom, and an iodine atom, and among those, the fluorine atom, the chlorine atom, or the bromine atom is preferable.

On the other hand, examples of the alkyl group having 1 to 6 carbon atoms, represented by each of J⁶ to J⁸, include a methyl group, an ethyl group, a propyl group, an isopropyl group, an n-butyl group, an isobutyl group, a sec-butyl group, a tert-butyl group, an n-pentyl group, and an n-hexyl group.

In addition, as described above, Z¹ and Z² may be bonded to each other to form an aromatic ring, and examples of the structure in a case where Z¹ and Z² in Formula (A1) are bonded to each other form an aromatic ring include a group represented by Formula (Ar-1a). Furthermore, in Formula (Ar-1a), * represents a bonding position, and examples of Q¹, Q², and Y¹ include the same ones as those described in Formula (A1).

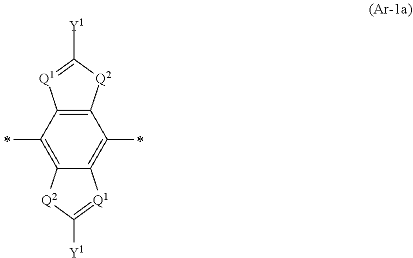

Moreover, in General Formulae (A2) and (A3), A³ and A⁴ each independently represent a group selected from the group consisting of —O—, —N(J⁹)—, —S—, and —CO—, and J⁹ represents a hydrogen atom or a substituent.

Examples of the substituent represented by J⁹ include the same ones as the substituents which may be contained in Y¹ in General Formula (A1).

In addition, in General Formula (A2), X represents a hydrogen atom or a non-metal atom of Groups 14 to 16 to which a substituent may be bonded.

Examples of the non-metal atom of Groups XIV to XVI represented by X include an oxygen atom, a sulfur atom, a nitrogen atom to which a hydrogen atom or a substituent is bonded [═N—R^{N1}, R^{N1} represents a hydrogen atom or a substituent], and a carbon atom to which a hydrogen atom or a substituent is bonded [═C—(R^{C1})₂, R^{C1} represents a hydrogen atom or a substituent].

Specific examples of the substituent include an alkyl group, an alkoxy group, an alkyl-substituted alkoxy group, a cyclic alkyl group, an aryl group (for example, a phenyl group and a naphthyl group), a cyano group, an amino group, a nitro group, an alkylcarbonyl group, a sulfo group, and a hydroxyl group.

Moreover, in General Formula (A3), D⁵ and D⁶ each independently represent a single bond, —CO—O—, —C(═S)O—, —CJ¹J²—, —CJ¹J²—CJ³J⁴—, —O—CJ¹J²—, —CJ¹J²—O—CJ³J⁴—, —CO—O—CJ¹J²—, —O—CO—CJ¹J²—, —CJ¹J²—O—CO—CJ³J⁴—, —CJ¹J²—CO—O—CJ³J⁴—, —NJ¹—CJ²J³—, or —CO—NJ¹—. J¹, J², J³, and J⁴ each independently represent a hydrogen atom, a fluorine atom, or an alkyl group having 1 to 4 carbon atoms.

Furthermore, in General Formula (A3), SP³ and SP⁴ each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)—, or —CO—, and Q represents a substituent. Examples of the substituent include the same ones as the substituents which may be contained in Y¹ in General Formula (A1).

Here, suitable examples of the linear or branched alkylene group having 1 to 12 carbon atoms, represented by one aspect of SP³ and SP⁴, include a methylene group, an ethylene group, a propylene group, a butylene group, a pentylene group, a hexylene group, a methylhexylene group, and a heptylene group.

In addition, in General Formula (A3), E³ and E⁴ each independently represent a monovalent organic group.

Examples of the monovalent organic group represented by each of E³ and E⁴ include an alkyl group, an aryl group, and a heteroaryl group.

The alkyl group may be linear, branched, or cyclic, but is preferably linear. The number of carbon atoms of the alkyl group is preferably 1 to 30, more preferably 1 to 20, and still more preferably 1 to 10.

In addition, the aryl group may be a monocycle or a polycycle, but is preferably the monocycle. The number of carbon atoms of the aryl group is preferably 6 to 25, and more preferably 6 to 10.

In addition, the heteroaryl group may be a monocycle or a polycycle. The number of heteroatoms constituting the heteroaryl group is preferably 1 to 3. The heteroatom constituting the heteroaryl group is preferably a nitrogen atom, a sulfur atom, or an oxygen atom. The number of carbon atoms of the heteroaryl group is preferably 6 to 18, and more preferably 6 to 12.

In addition, the alkyl group, the aryl group, and the heteroaryl group may be unsubstituted or have a substituent. Examples of the substituent include the same ones as the substituents which may be contained in Y¹ in General Formula (Ar-1).

Moreover, in General Formulae (A4) to (A7), Ax represents an organic group having 2 to 30 carbon atoms, which has at least one aromatic ring selected from the group consisting of an aromatic hydrocarbon ring and an aromatic heterocyclic ring.

In addition, in General Formulae (A4) to (A7), Ay represents a hydrogen atom, an alkyl group having 1 to 6 carbon atoms, which may have a substituent, or an organic group having 2 to 30 carbon atoms, which has at least one aromatic ring selected from the group consisting of an aromatic hydrocarbon ring and an aromatic heterocyclic ring.

Here, the aromatic ring in each of Ax and Ay may have a substituent, and Ax and Ay may be bonded to each other to form a ring.

In addition, Q³ represents a hydrogen atom, or an alkyl group having 1 to 6 carbon atoms, which may have a substituent.

Examples of each of Ax and Ay include the ones described in paragraphs [0039] to [0095] of WO2014/010325A.

Incidentally, examples of the alkyl group having 1 to 6 carbon atoms, represented by Q³, include a methyl group, an ethyl group, a propyl group, an isopropyl group, an n-butyl group, an isobutyl group, a sec-butyl group, a tert-butyl group, an n-pentyl group, and an n-hexyl group, and examples of the substituent include the same ones as the substituents which may be contained in Y¹ in General Formula (A1).

### General Formula (W)

Among those, the polymerizable liquid crystal compound is preferably a polymerizable liquid crystal compound having reverse wavelength dispersibility, represented by General Formula (W).

E¹—SP¹—A¹—D³—G¹—D¹—Ar—D²—G²—D⁴—A²—SP²—E² (W)

In General Formula (W), Ar represents any one group selected from the group consisting of the above-mentioned groups represented by General Formulae (A1) to (A7). Incidentally, in this case, it is preferable that in General Formulae (A1) to (A7), *1 represents a bonding position to D¹, and *2 represents a bonding position to D².

In General Formula (W), D¹, D², D³, and D⁴ each independently represent a single bond, —CO—O—, —C(═S)O—, —CJ¹J²—, —CJ¹J²—CJ³J⁴—, —O—CJ¹J²—, —CJ¹J²—O—CJ³J⁴—, —CO—O—CJ¹J²—, —O—CO—CJ¹J²—, —CJ¹J²—O—CO—CJ³J⁴—, —CJ¹J²—CO—O—CJ³J⁴—, —NJ¹—CJ²J³—, or —CO—NJ¹—. J¹, J², J³, and J⁴ each independently represent a hydrogen atom, a fluorine atom, or an alkyl group having 1 to 4 carbon atoms.

Moreover, in General Formula (W), G¹ and G² each independently represent a divalent alicyclic hydrocarbon group having 5 to 8 carbon atoms, and one or more of —CH₂—'s constituting the alicyclic hydrocarbon group may be substituted with —O—, —S—, or —NH—.

In addition, in General Formula (W), A¹ and A² each independently represent an aromatic ring group having 6 or more carbon atoms or a cycloalkylene ring group having 6 or more carbon atoms.

Moreover, in General Formula (W), SP¹ and SP² each independently represent a single bond, a linear or branched alkylene group having 1 to 12 carbon atoms, or a divalent linking group in which one or more of —CH₂—'s constituting the linear or branched alkylene group having 1 to 12 carbon atoms may be substituted with —O—, —S—, —NH—, —N(Q)—, or —CO—, and Q represents a substituent.

In addition, in General Formula (W), E¹ and E² each independently represent a monovalent organic group, and at least one of E¹ or E² represents a polymerizable group. It should be noted that in a case where Ar is the group represented by General Formula (A3), at least one of E¹ or E², or of E³ or E⁴ in General Formula (A3) mentioned above represents a polymerizable group.

In General Formula (W), G¹ and G² each independently represent a divalent alicyclic hydrocarbon group having 5 to 8 carbon atoms.

The divalent alicyclic hydrocarbon group having 5 to 8 carbon atoms, represented by each of G¹ and G², is preferably a 5- or 6-membered ring. In addition, the alicyclic hydrocarbon group may be saturated or unsaturated, but is preferably a saturated alicyclic hydrocarbon group. With regard to the divalent alicyclic hydrocarbon group represented by each of G¹ and G², reference can be made to the description in, for example, paragraph [0078] of JP2012-21068A, the contents of which are incorporated herein by reference.

In General Formula (W), A¹ and A² each independently represent an aromatic ring group having 6 or more carbon atoms or a cycloalkylene ring group having 6 or more carbon atoms.

Examples of the aromatic ring group having 6 or more carbon atoms, represented by each of A¹ and A², include an aromatic hydrocarbon ring group such as a benzene ring group, a naphthalene ring group, an anthracene ring group, and a phenanthroline ring group; and an aromatic heterocyclic group such as a furan ring group, a pyrrole ring group, a thiophene ring group, a pyridine ring group, a thiazole ring group, and a benzothiazole ring group. Among these, the benzene ring group (for example, a 1,4-phenyl group) is preferable.

Examples of the cycloalkylene ring group having 6 or more carbon atoms, represented by each of A¹ and A², include a cyclohexane ring group and a cyclohexene ring group, and among these, the cyclohexane ring (for example, a cyclohexane-1,4-diyl group) is preferable.

In General Formula (W), SP¹ and SP² each independently represent a linear or branched alkylene group having 1 to 12 carbon atoms.

As the linear or branched alkylene group having 1 to 12 carbon atoms, represented by each of SP¹ and SP², a methylene group, an ethylene group, a propylene group, or a butylene group is preferable.

In General Formula (W), E¹ and E² each independently represent a monovalent organic group, and at least one of E¹ or E² represents a polymerizable group.

Here, examples of the monovalent organic group represented by each of E¹ and E² include the same ones to those explained in E³ and E⁴ in Formula (A3).

In addition, the polymerizable group represented by at least one of E¹ or E² is not particularly limited, but a polymerizable group which is radically polymerizable or cationically polymerizable group is preferable.

As the radically polymerizable group, a generally known radically polymerizable group can be used, and an acryloyl group or a methacryloyl group is preferable. In this case, it is known that the acryloyl group generally exhibits a fast polymerization rate, the acryloyl group is preferable from the viewpoint of an improvement in productivity, but similarly, the methacryloyl group can also be used as a high-birefringence liquid crystalline polymerizable group.

A generally known cationically polymerizable group can be used as the cationically polymerizable group, and specific examples thereof include an alicyclic ether group, a cyclic acetal group, a cyclic lactone group, a cyclic thioether group, a spiroorthoester group, and a vinyloxy group. Among those, the alicyclic ether group or the vinyloxy group is preferable, and an epoxy group, an oxetane group, or the vinyloxy group is more preferable.

Particularly preferred examples of the polymerizable group include a polymerizable group represented by any of Formulae (P-1) to (P-20).

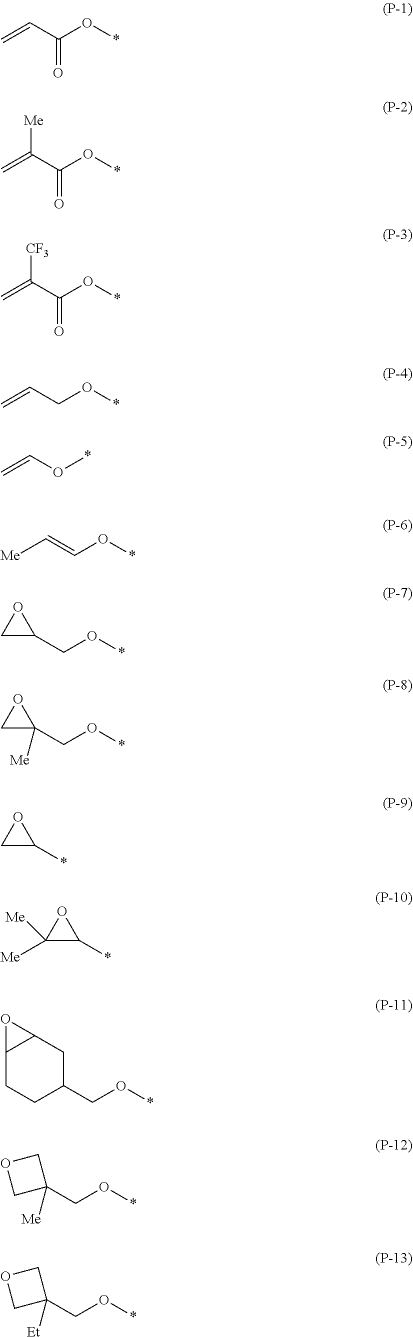

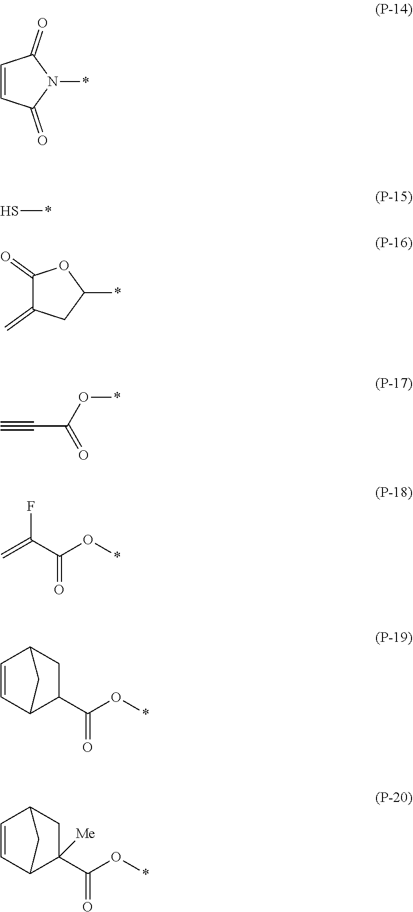

In Formula (W), for a reason that the durability is better, either of E¹ and E² in Formula (I) is preferably a polymerizable group, and more preferably an acryloyloxy group or a methacryloyloxy group.

Preferred examples of the liquid crystal compound represented by General Formula (W) are shown below, but are not limited to these liquid crystal compounds. Further, the 1,4-cyclohexylene groups in Formulae are all trans-1,4-cyclohexylene groups.

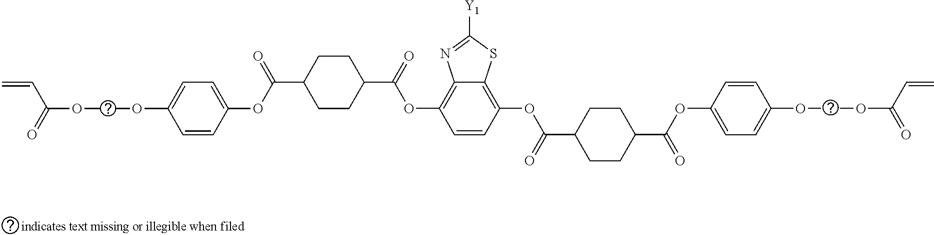

| No | Y1 | n |
|---|---|---|
| II-1-1 | 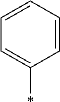 [SMILES: *c1ccccc1] | 6 |
| II-1-2 | 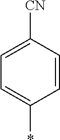 [SMILES: *c1ccc(C#N)cc1] | 6 |
| II-1-3 | 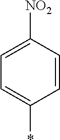 [SMILES: *c1ccc([N+](=O)[O-])cc1] | 6 |
| II-1-4 | 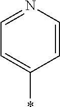 [SMILES: *c1ccncc1] | 6 |
| II-1-5 | 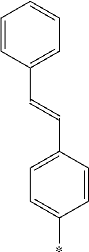 [SMILES: *c1ccc(/C=C/c2ccccc2)cc1] | 6 |
| II-1-6 | 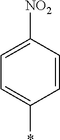 [SMILES: *c1ccc([N+](=O)[O-])cc1] | 11 |
| II-1-7 | 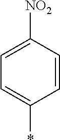 [SMILES: *c1ccc([N+](=O)[O-])cc1] | 8 |
| II-1-8 | 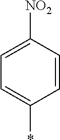 [SMILES: *c1ccc([N+](=O)[O-])cc1] | 4 |
| II-1-9 | 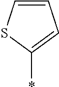 [SMILES: *c1cccs1] | 6 |
| II-1-10 | 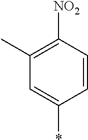 [SMILES: *c1ccc([N+](=O)[O-])c(C)c1] | 6 |
| II-1-11 | 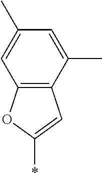 [SMILES: *c1cc2c(C)cc(C)cc2o1] | 6 |
| II-1-12 | 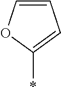 [SMILES: *c1ccco1] | 6 |
| II-1-13 | 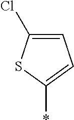 [SMILES: *c1ccc(Cl)s1] | 6 |
| II-1-14 | 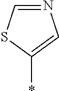 [SMILES: *c1cncs1] | 6 |
| II-1-15 | 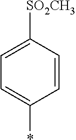 [SMILES: *c1ccc(S(C)(=O)=O)cc1] | 6 |

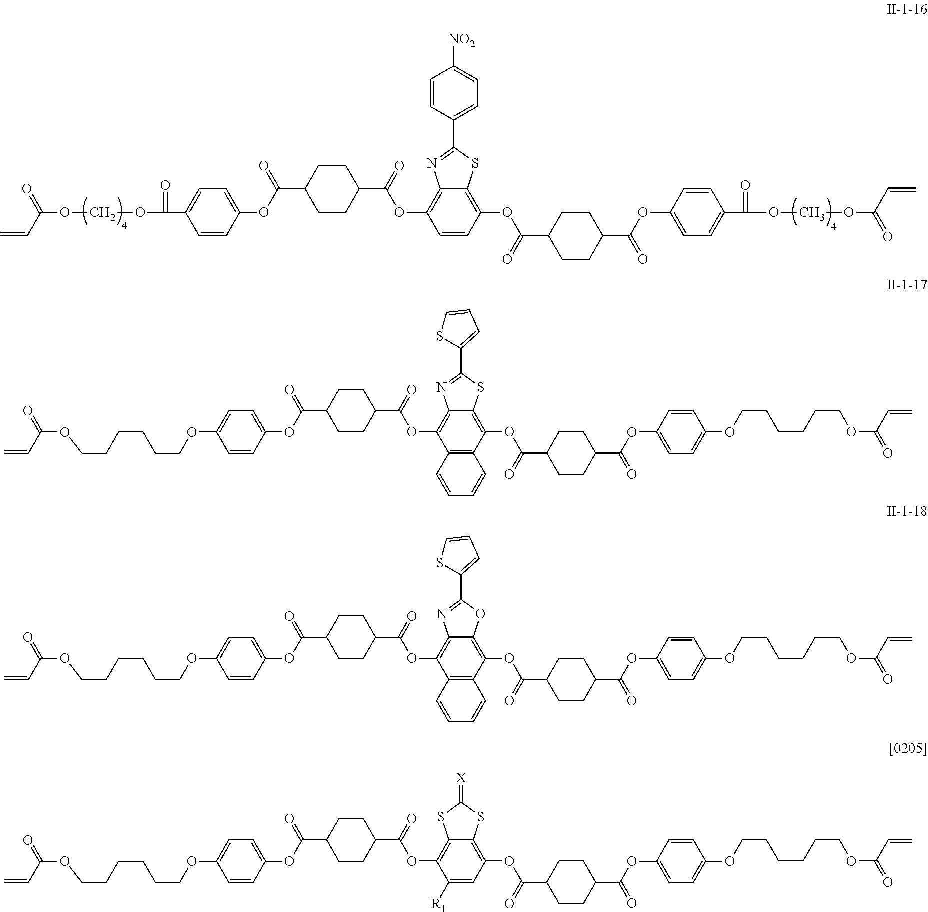

| No | X | R1 |
|---|---|---|
| II-2-1 | 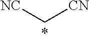 | H |
| II-2-2 | 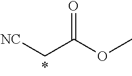 | H |
| II-2-3 | 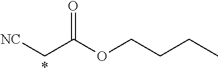 | H |
| II-2-4 | 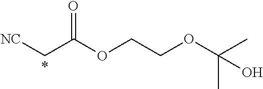 | H |
| II-2-5 | 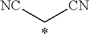 | CH₃ |
| II-2-6 | 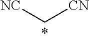 | 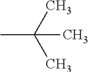 |
| II-2-7 | S | H |

Furthermore, in the formulae, “*” represents a bonding position.

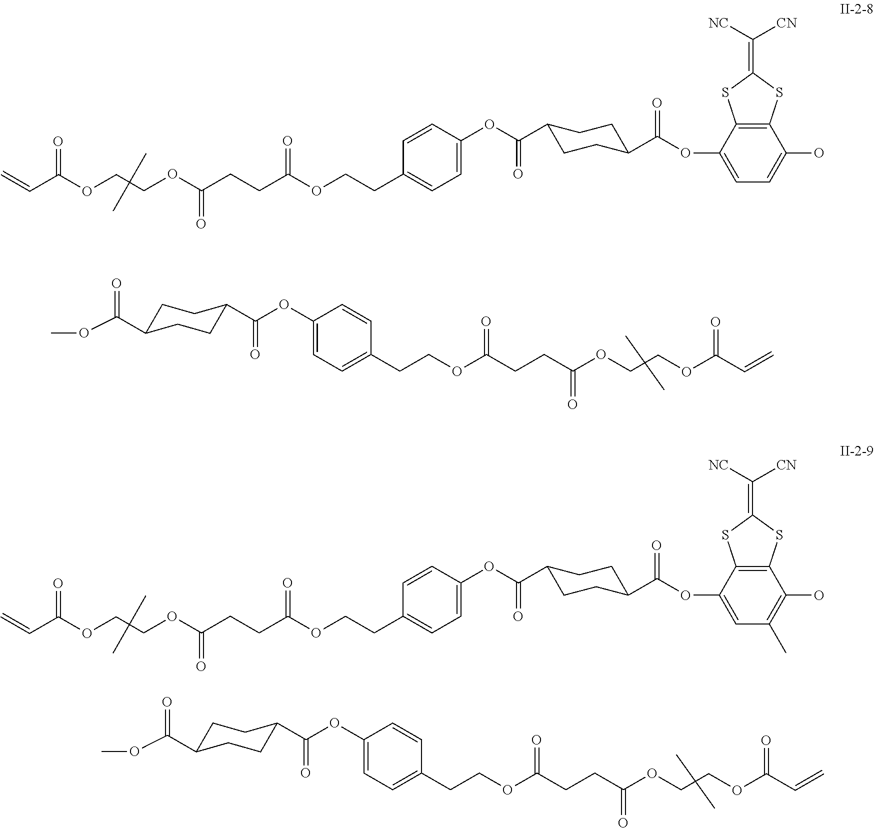

Moreover, a group adjacent to the acryloyloxy group in each of Formulae II-2-8 and II-2-9 represents a propylene group (a group in which a methyl group is substituted with an ethylene group), and represents a mixture of regioisomers having different positions of the methyl groups.

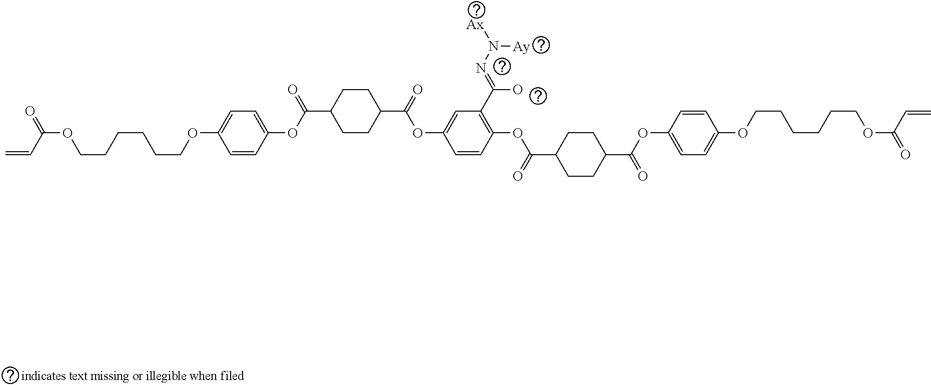

| No | Ax | Ay | Q2 |
|---|---|---|---|
| II-3-1 | 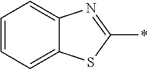 [SMILES: *c1nc2ccccc2s1] | H | H |
| II-3-2 | 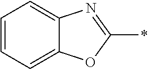 [SMILES: *c1nc2ccccc2o1] | H | H |
| II-3-3 | 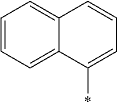 [SMILES: *c1cccc2ccccc12] | H | H |
| II-3-4 | Ph | Ph | H |
| II-3-5 | 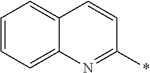 [SMILES: *c1ccc2ccccc2n1] | H | H |
| II-3-6 | 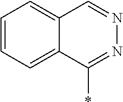 [SMILES: *c1nncc2ccccc12] | H | H |
| II-3-7 | 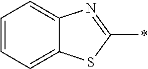 [SMILES: *c1nc2ccccc2s1] | CH₃ | H |
| II-3-8 | 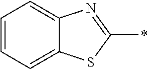 [SMILES: *c1nc2ccccc2s1] | C₄H₉ | H |
| II-3-9 | 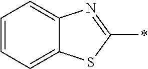 [SMILES: *c1nc2ccccc2s1] | C₆H₁₃ | H |
| II-3-10 | 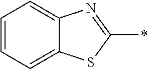 [SMILES: *c1nc2ccccc2s1] | 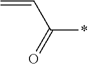 [SMILES: *C(=O)C=C] | H |
| II-3-11 | 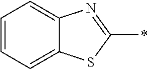 [SMILES: *c1nc2ccccc2s1] | 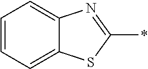 [SMILES: *c1nc2ccccc2s1] | H |
| II-3-12 | 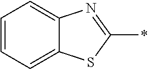 [SMILES: *c1nc2ccccc2s1] | CH₃CN | H |
| II-3-13 | 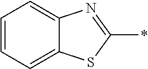 [SMILES: *c1nc2ccccc2s1] | 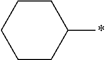 [SMILES: *C1CCCCC1] | H |
| II-3-14 | 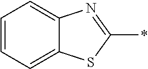 [SMILES: *c1nc2ccccc2s1] | 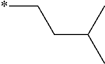 [SMILES: *CCC(C)C] | H |
| II-3-15 | 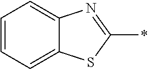 [SMILES: *c1nc2ccccc2s1] | CH₂CH₂OH | H |
| II-3-16 | 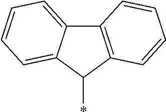 [SMILES: *C1c2ccccc2-c2ccccc21] | H | H |
| II-3-17 | 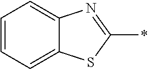 [SMILES: *c1nc2ccccc2s1] | CH₂CF₃ | H |
| II-3-18 | 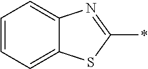 [SMILES: *c1nc2ccccc2s1] | H | CH₃ |
| II-3-19 | 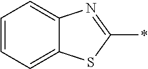 [SMILES: *c1nc2ccccc2s1] | 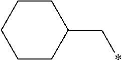 [SMILES: *CC1CCCCC1] | H |
| II-3-20 | 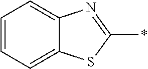 [SMILES: *c1nc2ccccc2s1] | 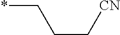 [SMILES: *CCCC#N] | H |
| II-3-21 | 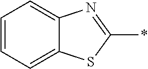 [SMILES: *c1nc2ccccc2s1] | 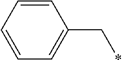 [SMILES: *Cc1ccccc1] | H |
| II-3-22 | 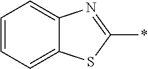 [SMILES: *c1nc2ccccc2s1] | 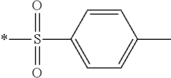 [SMILES: *S(=O)(=O)c1ccc(C)cc1] | H |
| II-3-23 | 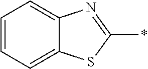 [SMILES: *c1nc2ccccc2s1] | 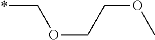 [SMILES: *COCCOC] | H |
| II-3-24 | 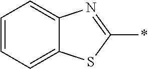 [SMILES: *c1nc2ccccc2s1] | 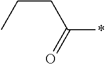 [SMILES: *C(=O)CCC] | H |
| II-3-25 | 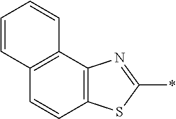 [SMILES: *c1nc2c(ccc3ccccc32)s1] | C₆H₁₀ | H |

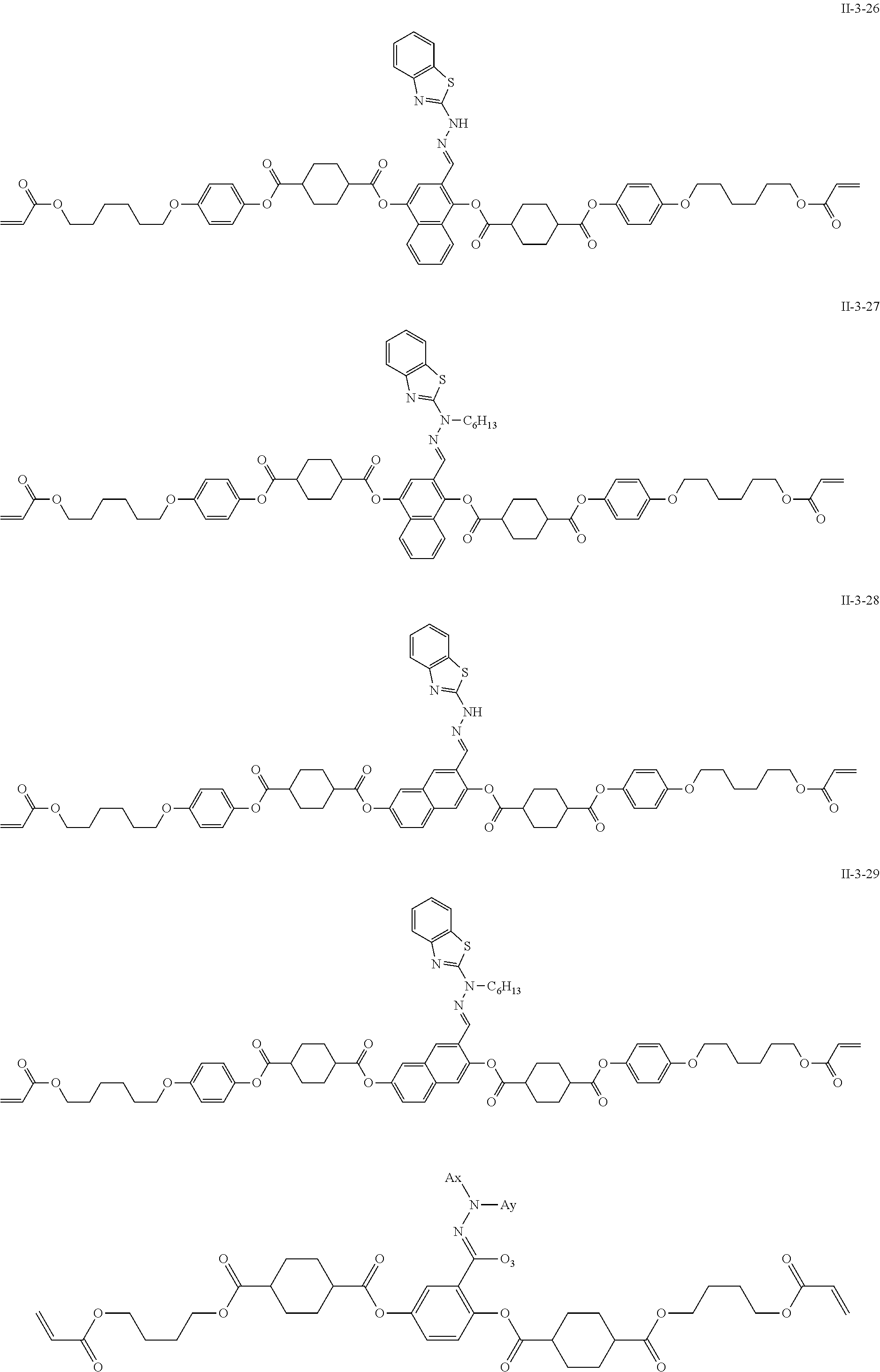

| No | Ax | Ay | Q2 |
|---|---|---|---|
| II-3-30 | 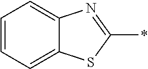 [SMILES: *c1nc2ccccc2s1] | H | H |
| II-3-31 | 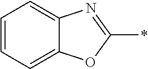 [SMILES: *c1nc2ccccc2o1] | H | H |
| II-3-32 | 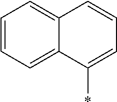 [SMILES: *c1cccc2ccccc12] | H | H |
| II-3-33 | Ph | Ph | H |
| II-3-34 | 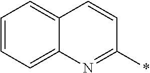 [SMILES: *c1ccc2ccccc2n1] | H | H |
| II-3-35 | 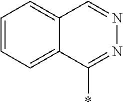 [SMILES: *c1nncc2ccccc12] | H | H |
| II-3-36 | 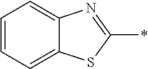 [SMILES: *c1nc2ccccc2s1] | CH₃ | H |
| II-3-37 | 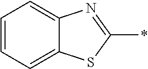 [SMILES: *c1nc2ccccc2s1] | C₄H₉ | H |
| II-3-38 | 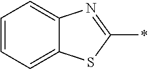 [SMILES: *c1nc2ccccc2s1] | C₆H₁₃ | H |
| II-3-39 | 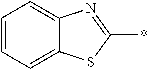 [SMILES: *c1nc2ccccc2s1] | 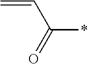 [SMILES: *C(=O)C=C] | H |
| II-3-40 | 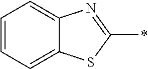 [SMILES: *c1nc2ccccc2s1] | 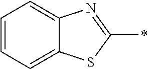 [SMILES: *c1nc2ccccc2s1] | H |
| II-3-41 | 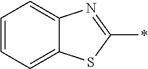 [SMILES: *c1nc2ccccc2s1] | CH₂CN | H |
| II-3-42 | 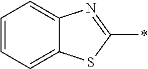 [SMILES: *c1nc2ccccc2s1] | 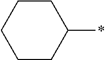 [SMILES: *C1CCCCC1] | H |
| II-3-43 | 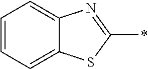 [SMILES: *c1nc2ccccc2s1] | 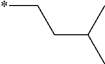 [SMILES: *CCC(C)C] | H |
| II-3-46 | 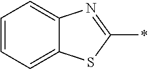 [SMILES: *c1nc2ccccc2s1] | CH₂CH₃OH | H |
| II-3-45 | 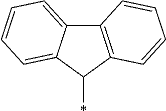 [SMILES: *C1c2ccccc2-c2ccccc21] | H | H |
| II-3-46 | 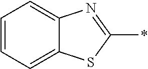 [SMILES: *c1nc2ccccc2s1] | CH₂CF₃ | H |
| II-3-47 | 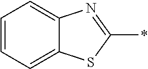 [SMILES: *c1nc2ccccc2s1] | H | CH₃ |
| II-3-48 | 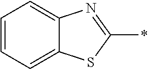 [SMILES: *c1nc2ccccc2s1] | 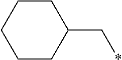 [SMILES: *CC1CCCCC1] | H |
| II-3-49 | 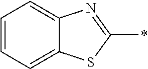 [SMILES: *c1nc2ccccc2s1] | 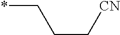 [SMILES: *CCCC#N] | H |
| II-3-50 | 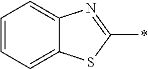 [SMILES: *c1nc2ccccc2s1] | 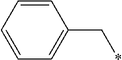 [SMILES: *Cc1ccccc1] | H |
| II-3-51 | 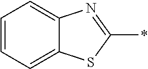 [SMILES: *c1nc2ccccc2s1] | 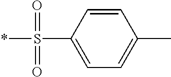 [SMILES: *S(=O)(=O)c1ccc(C)cc1] | H |
| II-3-52 | 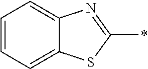 [SMILES: *c1nc2ccccc2s1] | 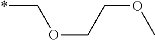 [SMILES: *COCCOC] | H |
| II-3-53 | 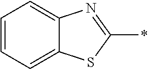 [SMILES: *c1nc2ccccc2s1] | 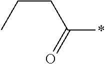 [SMILES: *C(=O)CCC] | H |
| II-3-54 | 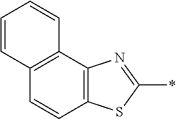 [SMILES: *c1nc2c(ccc3ccccc32)s1] | C₆H₁₃ | H |

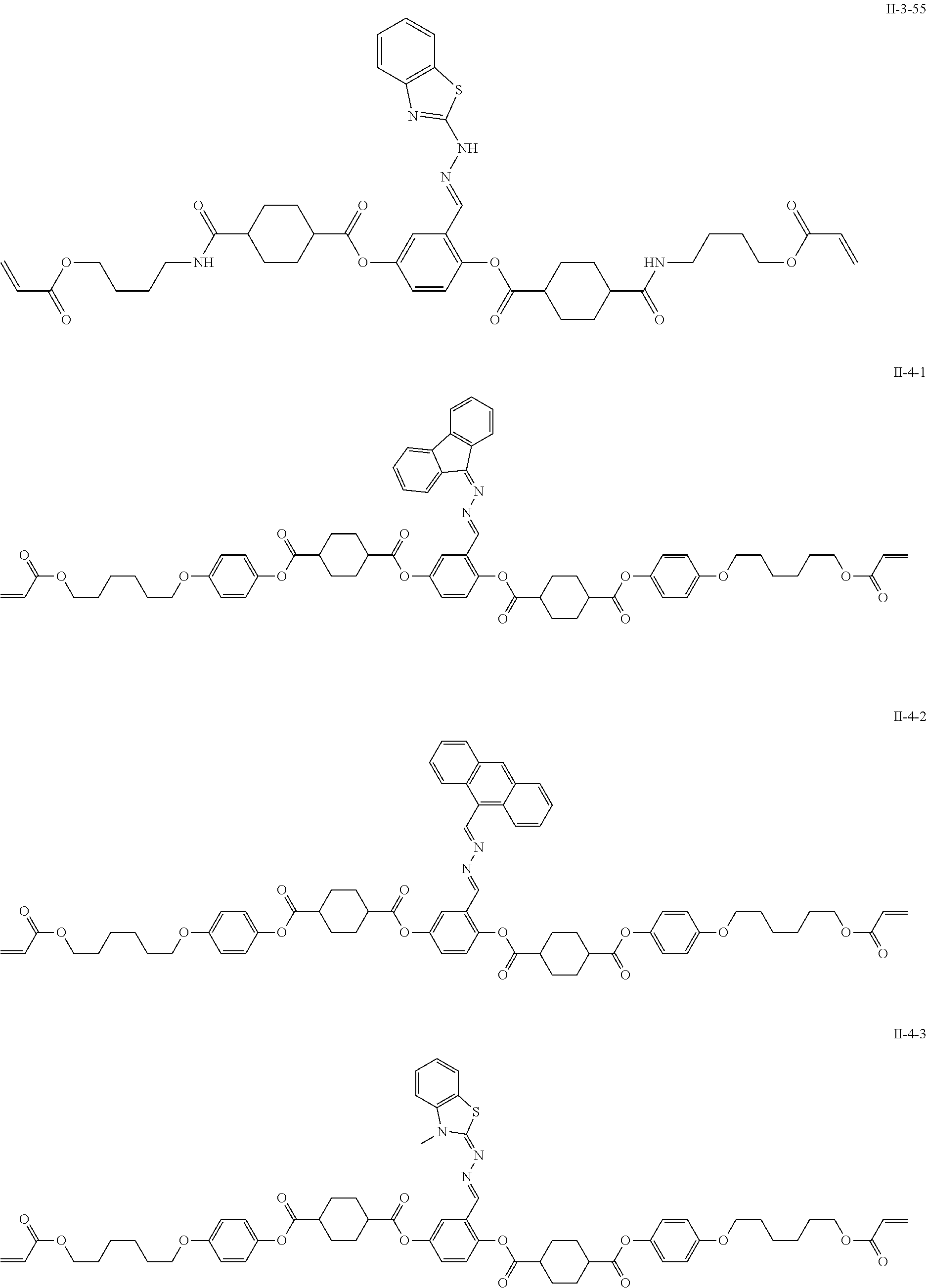

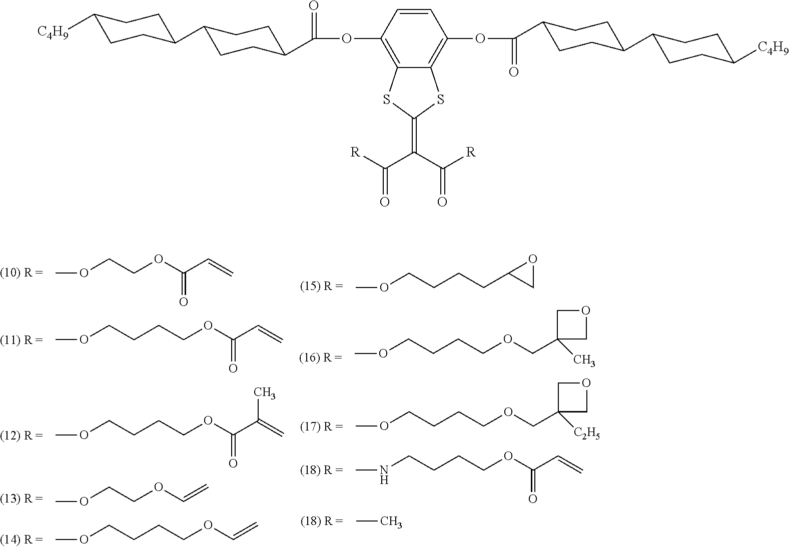

Moreover, suitable examples of the compound represented by Formula (W) include compounds represented by Formulae (1) to (22), and specific examples thereof include the compounds having side chain structures shown in Tables 1 to 3 below as K (side chain structure) in Formulae (1) to (22).

Furthermore, in Tables 1 to 3 below, “*” shown in the side chain structure of K represents a bonding position to an aromatic ring.

In addition, in the side chain structures shown in 2-2 in Table 2 below and 3-2 in Table 3 below, a group adjacent to each of the acryloyloxy group and the methacryloyl group represents a propylene group (a group in which a methyl group is substituted with an ethylene group), and represents a mixture of regioisomers in which the positions of the methyl groups are different.

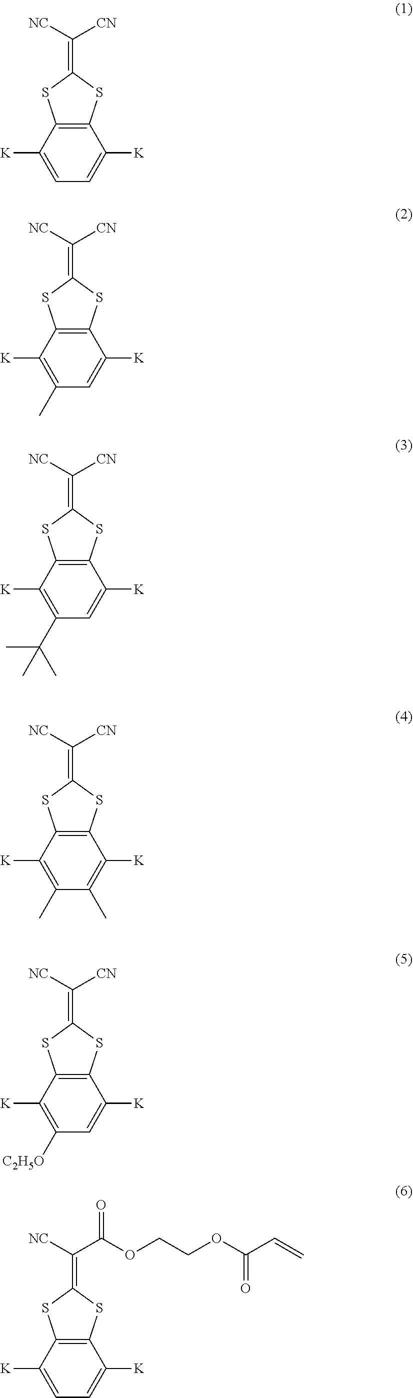

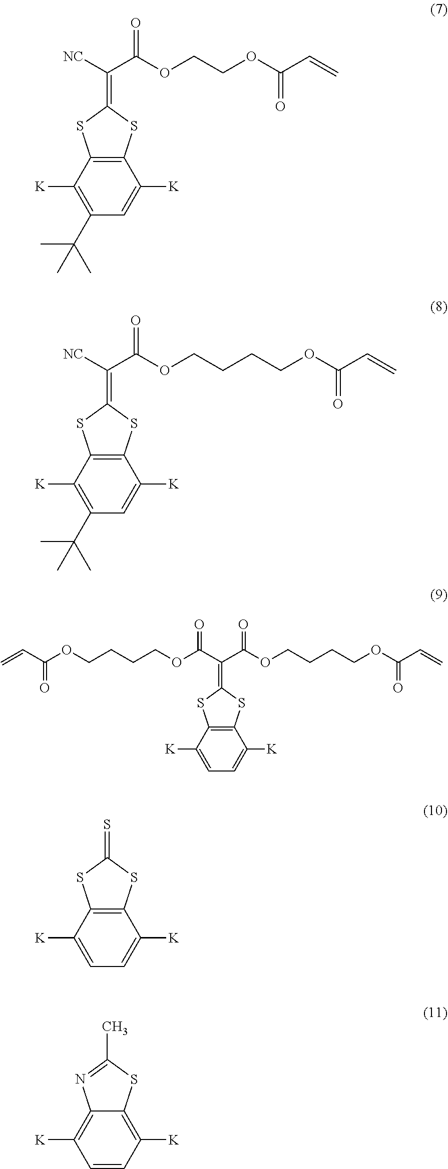

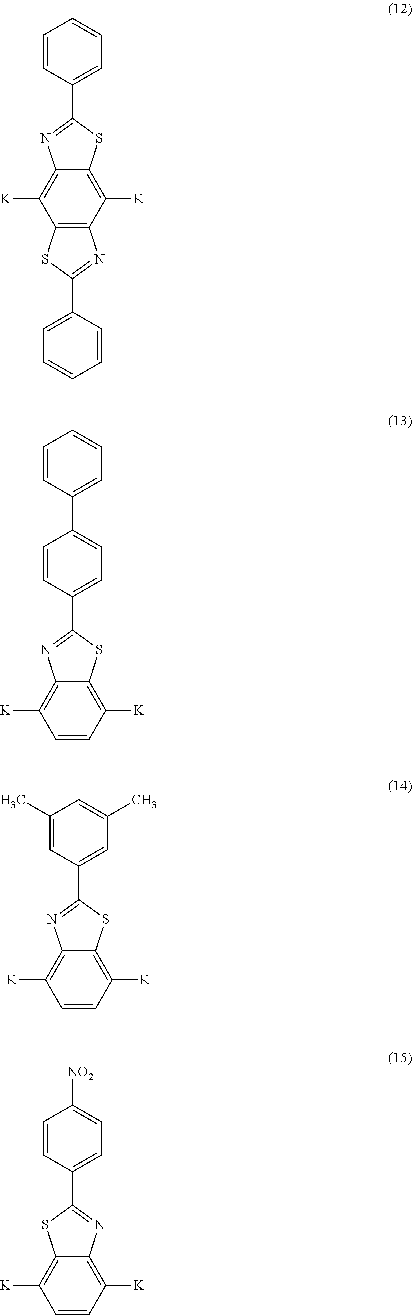

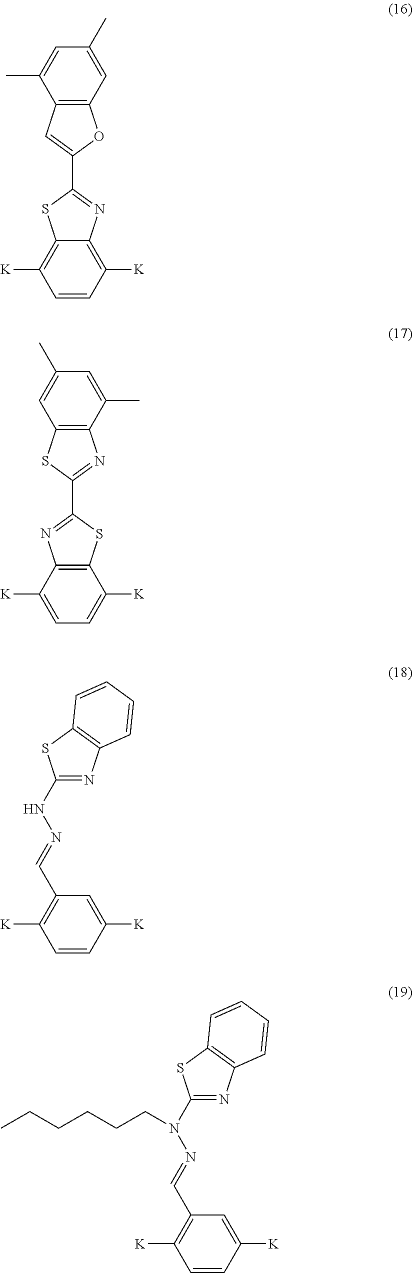

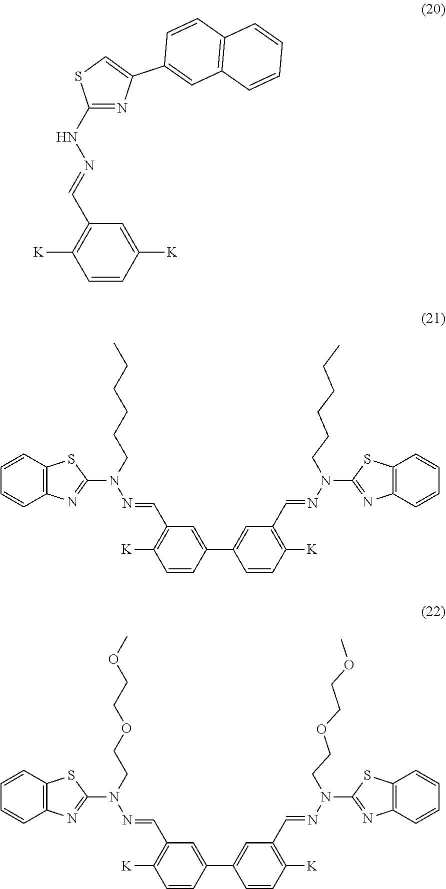

TABLE 1

| | K (side chain structure) |
|---|---|
| 1-1 | 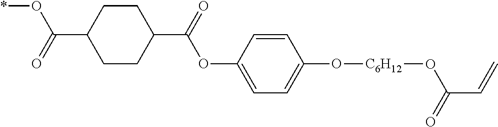 |
| 1-2 | 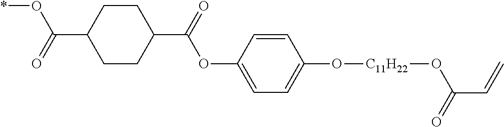 |
| 1-3 | 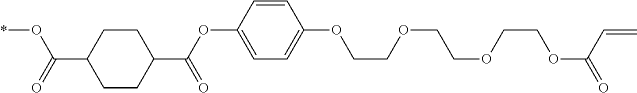 [SMILES: *OC(=O)C1CCC(C(=O)Oc2ccc(OCCOCCOCCOC(=O)C=C)cc2)CC1] |
| 1-4 | 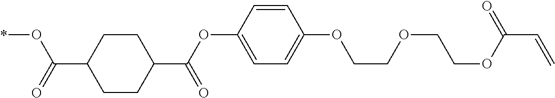 [SMILES: *OC(=O)C1CCC(C(=O)Oc2ccc(OCCOCCOC(=O)C=C)cc2)CC1] |
| 1-5 | 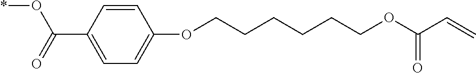 [SMILES: *OC(=O)c1ccc(OCCCCCCOC(=O)C=C)cc1] |
| 1-6 | 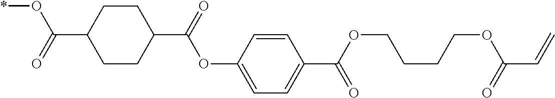 [SMILES: *OC(=O)C1CCC(C(=O)Oc2ccc(C(=O)OCCCCOC(=O)C=C)cc2)CC1] |

TABLE 2

| | K (side chain structure) |
|---|---|
| 2-1 | 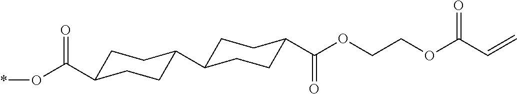 [SMILES: *OC(=O)C1CCC(C2CCC(C(=O)OCCOC(=O)C=C)CC2)CC1] |
| 2-2 | 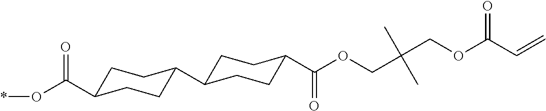 [SMILES: *OC(=O)C1CCC(C2CCC(C(=O)OCC(C)(C)COC(=O)C=C)CC2)CC1] |
| 2-3 | 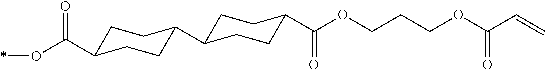 [SMILES: *OC(=O)C1CCC(C2CCC(C(=O)OCCCOC(=O)C=C)CC2)CC1] |
| 2-4 | 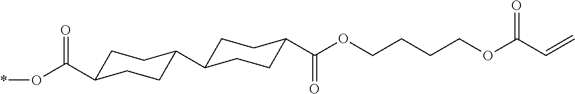 [SMILES: *OC(=O)C1CCC(C2CCC(C(=O)OCCCCOC(=O)C=C)CC2)CC1] |
| 2-5 | 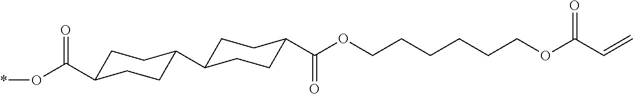 [SMILES: *OC(=O)C1CCC(C2CCC(C(=O)OCCCCCCOC(=O)C=C)CC2)CC1] |
| 2-6 | 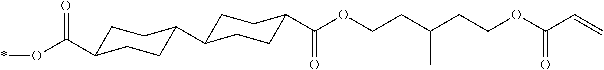 [SMILES: *OC(=O)C1CCC(C2CCC(C(=O)OCCC(C)CCOC(=O)C=C)CC2)CC1] |
| 2-7 | 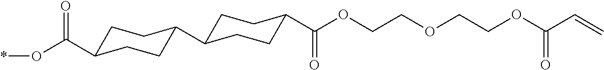 [SMILES: *OC(=O)C1CCC(C2CCC(C(=O)OCCOCCOC(=O)C=C)CC2)CC1] |
| 2-8 | 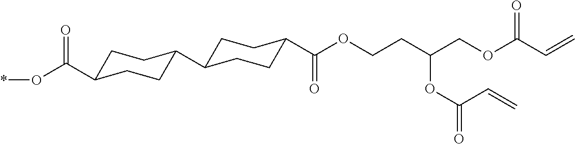 [SMILES: *OC(=O)C1CCC(C2CCC(C(=O)OCCC(COC(=O)C=C)OC(=O)C=C)CC2)CC1] |
| 2-9 | 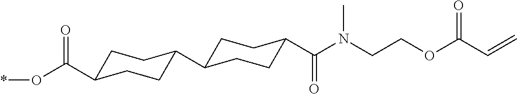 [SMILES: *OC(=O)C1CCC(C2CCC(C(=O)N(C)CCOC(=O)C=C)CC2)CC1] |
| 2-10 | 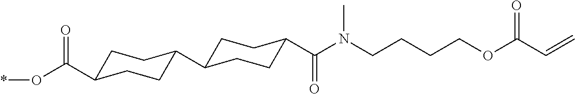 [SMILES: *OC(=O)C1CCC(C2CCC(C(=O)N(C)CCCCOC(=O)C=C)CC2)CC1] |
| 2-11 | 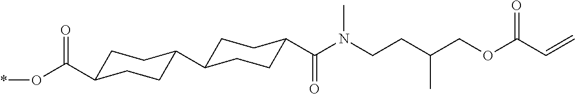 [SMILES: *OC(=O)C1CCC(C2CCC(C(=O)N(C)CCC(C)COC(=O)C=C)CC2)CC1] |
| 2-12 | 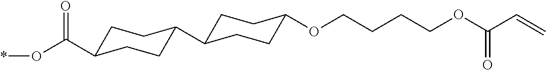 [SMILES: *OC(=O)C1CCC(C2CCC(OCCCCOC(=O)C=C)CC2)CC1] |
| 2-13 | 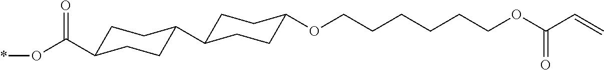 [SMILES: *OC(=O)C1CCC(C2CCC(OCCCCCCOC(=O)C=C)CC2)CC1] |
| 2-14 | 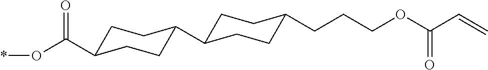 [SMILES: *OC(=O)C1CCC(C2CCC(CCCOC(=O)C=C)CC2)CC1] |

TABLE 3

| | K (side chain structure) |
|---|---|
| 3-1 | 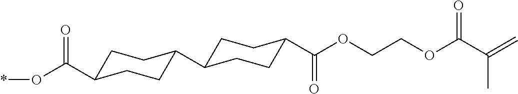 [SMILES: *OC(=O)C1CCC(C2CCC(C(=O)OCCOC(=O)C(=C)C)CC2)CC1] |
| 3-2 | 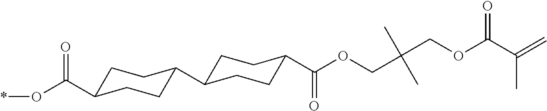 [SMILES: *OC(=O)C1CCC(C2CCC(C(=O)OCC(C)(C)COC(=O)C(=C)C)CC2)CC1] |
| 3-3 | 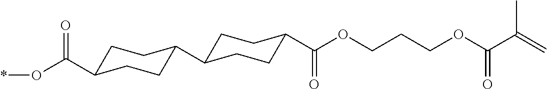 [SMILES: *OC(=O)C1CCC(C2CCC(C(=O)OCCCOC(=O)C(=C)C)CC2)CC1] |
| 3-4 | 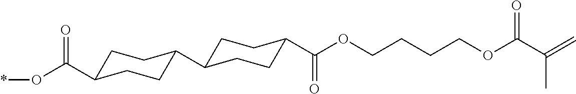 [SMILES: *OC(=O)C1CCC(C2CCC(C(=O)OCCCCOC(=O)C(=C)C)CC2)CC1] |
| 3-5 | 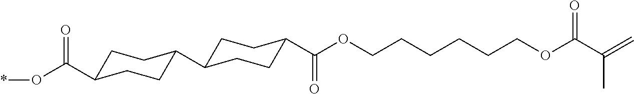 [SMILES: *OC(=O)C1CCC(C2CCC(C(=O)OCCCCCCOC(=O)C(=C)C)CC2)CC1] |
| 3-6 | 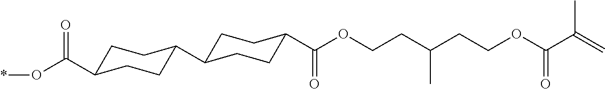 [SMILES: *OC(=O)C1CCC(C2CCC(C(=O)OCCC(C)CCOC(=O)C(=C)C)CC2)CC1] |
| 3-7 | 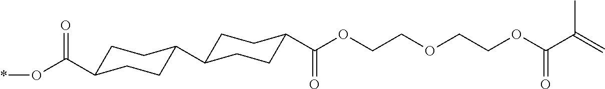 [SMILES: *OC(=O)C1CCC(C2CCC(C(=O)OCCOCCOC(=O)C(=C)C)CC2)CC1] |
| 3-8 | 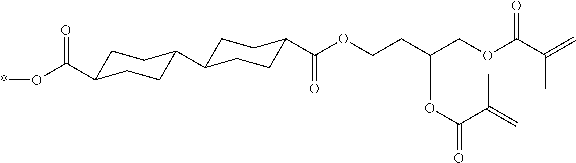 [SMILES: *OC(=O)C1CCC(C2CCC(C(=O)OCCC(COC(=O)C(=C)C)OC(=O)C(=C)C)CC2)CC1] |
| 3-9 | 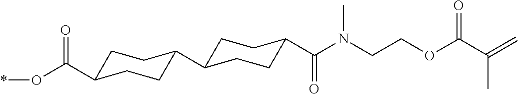 [SMILES: *OC(=O)C1CCC(C2CCC(C(=O)N(C)CCOC(=O)C(=C)C)CC2)CC1] |
| 3-10 | 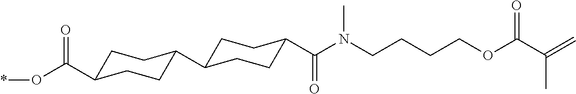 [SMILES: *OC(=O)C1CCC(C2CCC(C(=O)N(C)CCCCOC(=O)C(=C)C)CC2)CC1] |
| 3-11 | 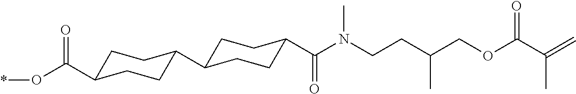 [SMILES: *OC(=O)C1CCC(C2CCC(C(=O)N(C)CCC(C)COC(=O)C(=C)C)CC2)CC1] |
| 3-12 | 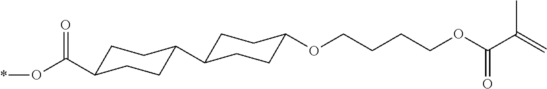 [SMILES: *OC(=O)C1CCC(C2CCC(OCCCCOC(=O)C(=C)C)CC2)CC1] |
| 3-13 | 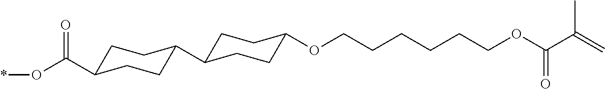 [SMILES: *OC(=O)C1CCC(C2CCC(OCCCCCCOC(=O)C(=C)C)CC2)CC1] |
| 3-14 | 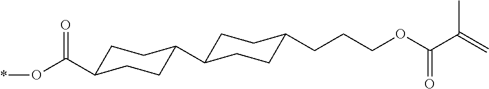 [SMILES: *OC(=O)C1CCC(C2CCC(CCCOC(=O)C(=C)C)CC2)CC1] |

The polymerizable liquid crystal compounds may be used singly or in combination of two or more kinds thereof. From the viewpoint of suppressing the crystallinity of the polymerizable liquid crystal compound, thereby realizing good solubility and liquid crystallinity, it is preferable that two or more kinds of the polymerizable liquid crystal compounds are used. In addition, a polymerizable liquid crystal compound other than the above-mentioned polymerizable liquid crystal compounds may be used.

As the polymerizable liquid crystal compound, the polymerizable liquid crystal compound described in Handbook of Liquid Crystals (edited by Society of editing handbook of Liquid crystal, published by Maruzen on Oct. 30, 2000), and known polymerizable liquid crystal compounds may be used.

The content of the polymerizable liquid crystal compound is preferably 20% by mass or more, and more preferably 40% by mass or more with respect to the total mass of the liquid crystal composition. In a case where the fluorine-containing polymer of the embodiment of the present invention includes a partial structure derived from a liquid crystal compound, an effect that the cissing during application of the liquid crystal composition is suppressed is obtained even with the content of the polymerizable liquid crystal compound in the liquid crystal composition being as high as 40% by mass or more.

The upper limit of the content of the polymerizable liquid crystal compound is preferably 60% by mass or less, more preferably 55% by mass or more, and still more preferably 50% by mass or more with respect to the total mass of the liquid crystal composition.

The content of the polymerizable liquid crystal compound is preferably 50% to 99.99% by mass, more preferably 65% to 99.5% by mass, and still more preferably 70% to 99% by mass with respect to the total mass of the solid content of the liquid crystal composition.

The polymerizable liquid crystal compounds may be used singly or in combination of two or more kinds thereof.

In a case where two or more kinds of the polymerizable liquid crystal compounds are used, the total content thereof is preferably within the range.

The solid content of the liquid crystal composition is a component capable of forming an optically anisotropic layer and does not include a solvent. Further, even in a case where the properties and the state of the component are liquid phases and the component is also capable of forming an optically anisotropic layer, it is used for calculation of the solid content.

Moreover, in a case where a polymerizable liquid crystal compound having reverse wavelength dispersibility (preferably the polymerizable liquid crystal compound represented by General Formula (W)) is used as the polymerizable liquid crystal compound, the content thereof is preferably 50% to 100% by mass, more preferably 65% to 95% by mass, and still more preferably 70% to 90% by mass with respect to the total mass of the liquid crystal compound in the liquid crystal composition, from the viewpoint of imparting the optically anisotropic layer with reverse wavelength dispersibility.

The polymerizable liquid crystal compounds having reverse wavelength dispersibility (preferably the polymerizable liquid crystal compound represented by General Formula (W)) may be used singly or in combination of two or more kinds thereof In a case where two or more kinds of the polymerizable liquid crystal compounds having reverse wavelength dispersibility are used, the total content thereof is preferably within the range.

In addition, the total mass of the liquid crystal compound is a total mass of the compounds exhibiting liquid crystallinity in the liquid crystal composition, and in a case where the liquid crystal composition also includes a non-polymerizable liquid crystal compound, the total mass is a mass obtained by adding up not only the mass of the polymerizable liquid crystal compound but also the mass of the non-polymerizable liquid crystal compound.

### Polymerization Initiator

The liquid crystal composition may include a polymerization initiator.

The polymerization initiator to be used is selected depending on the type of the polymerization reaction, and examples thereof include a thermal polymerization initiator and a photopolymerization initiator.

Examples of the photopolymerization initiator include a benzoin compound, a benzophenone compound, an alkylphenone compound, an acylphosphine oxide compound, a triazine compound, oxime esters, and onium salts. The photopolymerization initiator may be combined with a sensitizer and/or a chain transfer agent, as desired.

In a case where the liquid crystal composition contains a polymerization initiator, the content of the polymerization initiator is preferably 0.01% to 20% by mass, and more preferably 0.5% to 5% by mass with respect to the total content of the polymerizable liquid crystal compound and a non-liquid crystal polymerizable monomer which will be described later.

The polymerization initiators may be used singly or in combination of two or more kinds thereof. In a case where two or more kinds of the polymerization initiators are used, the total content thereof is preferably within the range.

### Non-Liquid Crystal Polymerizable Monomer

The liquid crystal composition may include a non-liquid crystal polymerizable monomer from the viewpoint of the uniformity of a coating film and the strength of a film.

Examples of the non-liquid crystal polymerizable monomer include radically polymerizable or cationically polymerizable compounds. For example, a radically polymerizable polyfunctional monomer can be used, and the monomer is preferably copolymerizable with the polymerizable group-containing liquid crystal compound. Examples thereof include esters of a polyhydric alcohol and a (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,2,3-cyclohexane tetramethacrylate, polyurethane polyacrylate, and polyester polyacrylate), vinylbenzene and a derivative thereof (for example, 1,4-divinylbenzene, 4-vinylbenzoic acid-2-acryloyl ethyl ester, and 1,4-divinylcyclohexanone), vinylsulfone (for example, divinylsulfone), acrylamide (for example, methylene bisacrylamide) and methacrylamide, and the ester of a polyhydric alcohol and a (meth)acrylic acid is particularly preferable.

In a case where the liquid crystal composition contains a non-liquid crystal polymerizable monomer, the content of the non-liquid crystal polymerizable monomer is preferably 1% to 50% by mass, and more preferably 2% to 30% by mass with respect to the total mass of the polymerizable liquid crystal compound.

The non-liquid crystal polymerizable monomers may be used singly or in combination of two or more kinds thereof.

In a case where two or more kinds of the non-liquid crystal polymerizable monomers are used, the total content thereof is preferably within the range.

### Organic Solvent

The liquid crystal composition may include an organic solvent. As the organic solvent, a solvent which can completely dissolve the above-mentioned polymerizable liquid crystal compound is preferable, and a solvent which is inert to a polymerization reaction of the polymerizable liquid crystal compound is preferable.

Examples of the organic solvent include alcohol solvents such as methanol, ethanol, ethylene glycol, isopropyl alcohol, propylene glycol, ethylene glycol methyl ether, ethylene glycol butyl ether, and propylene glycol monomethyl ether; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, 2-heptanone, and methyl isobutyl ketone; aliphatic hydrocarbon solvents such as pentane, hexane, and heptane; aromatic hydrocarbon solvents such as toluene and xylene; nitrile solvents such as acetonitrile; ether solvents such as tetraethylene glycol dimethyl ether, tetrahydrofuran, and dimethoxyethane; and chlorine-containing solvents such as chloroform and chlorobenzene.

The content of the organic solvent in the liquid crystal composition can be appropriately adjusted from the viewpoints of the solubility of a solid content, a liquid viscosity, the pot life of a coating liquid, the suitability for a coating machine and a coating method, the uniformity of a coating film, control of a film thickness, control of alignment, and the like.

In a case where the liquid crystal composition contains an organic solvent, the content of the organic solvent in the liquid crystal composition is, for example, an amount such that the concentration of the solid content of the liquid crystal composition is preferably 13% to 50% by mass, and more preferably 15% to 40% by mass.

The organic solvent may be used singly or in combination of two or more kinds thereof. In a case where two or more kinds of the organic solvents are used, the total content thereof is preferably within the range.

### Other Components

The liquid crystal composition may include other components, in addition to the above-mentioned components.

As such other components, a surfactant, a chiral agent, or the like may be used from the viewpoint of, for example, adjustment of the aligning properties of the optically anisotropic layer.

In addition, from the viewpoints of adjustments of the viscosity, the phase transition temperature, and the alignment uniformity of the liquid crystal composition, adjustment of the film properties and the optical characteristics of the optically anisotropic layer, and the like, a sub-liquid crystal compound (non-polymerizable liquid crystal compound) may be used. The sub-liquid crystal compound may be a low-molecular-weight liquid crystal compound. In addition, the sub-liquid crystal compound may be a main chain-type liquid crystal high-molecular-weight compound or a side chain-type liquid crystal high-molecular-weight compound.

From the viewpoint of imparting the liquid crystal composition with a pot life; improving the durability of the optically anisotropic layer; or the like, a polymerization inhibitor, an antioxidant, an ultraviolet absorber, or the like may be used.

From the viewpoint of imparting further functions, adjusting liquid properties, adjusting film properties, or the like, a plasticizer, a retardation adjuster, a dichroic coloring agent, a fluorescent coloring agent, a photochromic coloring agent, a thermochromic coloring agent, a photoisomerization material, a photodimerization material, nanoparticles, a thixotropic agent, or the like may also be added.

### Optical Film

The optical film of an embodiment of the present invention is an optical film having a layer formed from the above-mentioned composition of the embodiment of the present invention.

Examples of such an optical film include an antireflection film, a brightness improving film, an antiglare film, a diffusion film, and a light collecting film, and among these, the optical film is preferably used as the antireflection film.

In addition, suitable examples of the composition for forming an antireflection film include a composition having the above-mentioned fluorine-containing polymer of the embodiment of the present invention incorporated into a known composition for forming an antireflection layer containing particles, a compound for forming a binder resin, and a solvent (for example, the composition for forming an antireflection layer described in paragraphs [0050] to [0072] of JP2017-187584A).

### Liquid Crystal Film

The liquid crystal film of an embodiment of the present invention is an optical film having a layer (optically anisotropic layer) formed from the above-mentioned liquid crystal composition.

### Forming Method

A method for forming an optically anisotropic layer formed of the above-mentioned liquid crystal composition is not particularly limited, and for example, a liquid crystal film having an optically anisotropic layer can be formed by directly applying a liquid crystal composition onto a support to form a coating film, and subjecting the obtained coating film to an alignment forming treatment such as heating and/or cooling, and a curing treatment (irradiation with ultraviolet rays (light irradiation treatment) or a heating treatment). In addition, the optically anisotropic layer may also be formed by applying a liquid crystal composition onto an alignment film which will be described later and subjecting the film to the same treatment as the above-mentioned treatment.

Application of the liquid crystal composition can be carried out by a known method (for example, a wire bar coating method, an extrusion coating method, a direct gravure coating method, a reverse gravure coating method, and a die coating method).

In the present invention, the thickness of the optically anisotropic layer is not particularly limited, but is preferably 0.1 to 10 μm, and more preferably 0.5 to 5 μm.

### Aligning Properties and Optical Characteristics of Optically Anisotropic Layer

The optically anisotropic layer can be aligned in various alignment states such as horizontal alignment, vertical alignment, tilt alignment, hybrid alignment, random homogeneous alignment, and cholesteric alignment, and can be imparted with various optical characteristics by appropriately selecting the optical anisotropy and the alignment state of the polymerizable liquid crystal compound.

For example, in a preferred aspect, the optically anisotropic layer may serve as a positive A-plate. The positive A-plate can be obtained by horizontally aligning a rod-like polymerizable liquid crystal compound. Further, in a case where the in-plane retardation Re(550) is set to 100 to 160 nm (preferably 120 to 150 nm), the plate can be suitably used as a positive uniaxial λ/4 plate. In addition, by setting Re(550) to be in the range of 250 to 300 nm, the plate can be used as a positive uniaxial λ/2 plate. Here, Re(550) represents an in-plane retardation at a wavelength of 550 nm of the optically anisotropic layer. The in-plane retardation value can be measured using AxoScan OPMF-1 (manufactured by Opto Science, Inc.).

In addition, in one preferred aspect, the optically anisotropic layer may also serve as a positive C-plate.

The positive C-plate can be obtained by vertically aligning a rod-like polymerizable liquid crystal compound. The thickness-direction retardation Rth(550) is, for example, 20 to 200 nm, and is preferably 50 to 120 nm from the viewpoint of imparting various optical compensation functions and/or a viewing angle enhancing function, and the like.

In addition, the optically anisotropic layer may be either a negative A-plate or a negative C-plate. Incidentally, by cholesterically aligning the liquid crystal layer, it is also possible to impart the layer with optical rotation, wavelength selective reflectivity, and the like.

Moreover, in the present specification, the A-plate is defined as follows.

The A-plate encompasses two kinds of plates, that is, a positive A-plate and a negative A-plate, and in a case where a refractive index in the slow axis direction in the film plane (a direction in which the refractive index becomes a maximum in the plane) is defined as nx, a refractive index in the direction in-plane orthogonal to the in-plane slow axis is defined as ny, and a refractive index in the thickness direction is defined as nz, the positive A-plate satisfies a relationship of Formula (A1) and the negative A-plate satisfies a relationship of Formula (A2). In addition, in the positive A-plate, Rth represents a negative value, and in the negative A-plate, Rth represents a positive value.

nx>ny≈nz Formula (A1)

ny<nx≈nz Formula (A2)

Furthermore, “≈” encompasses a case where both sides are completely the same as each other as well as a case where the both sides are substantially the same as each other. With regard to the expression, “substantially the same”, for example, a case where (ny−nz)×d (in which d is the thickness of a film) is −10 to 10 nm, and preferably −5 to 5 nm is also encompassed by “ny≈nz”, and a case where (nx−nz)×d is −10 to 10 nm, and preferably −5 to 5 nm is also encompassed by “nx≈nz”.

The C-plate encompasses two kinds of plates, that is, a positive C-plate and a negative C-plate, the positive C-plate satisfies the relationship of Formula (C1), and the negative C-plate satisfies the relationship of Formula (C2). Furthermore, in the positive C-plate, Rth represents a negative value, and in the negative C-plate, Rth represents a positive value.

nz>nx≈ny Formula (C1)

nz<nx≈ny Formula (C2)

Furthermore, “≈” encompasses a case where both sides are completely the same as each other as well as a case where the both sides are substantially the same as each other. With regard to the expression, “substantially the same”, for example, a case where (nx−ny)×d (in which d is the thickness of a film) is 0 to 10 nm, and preferably 0 to 5 nm is also encompassed by “nx≈ny”.

Moreover, it is possible to appropriately adjust the optically anisotropic wavelength dispersibility by adjusting the polymerizable liquid crystal compound, the other components used in the liquid crystal composition, and the like.

The optically anisotropic layer preferably exhibits reverse wavelength dispersibility. As a specific example of the optically anisotropic layer, it is preferable that the optically anisotropic layer satisfies Formula (II) as a uniaxial phase difference layer.

Δn(450)/Δn(550)<1.00 (II)

Here, in Formula (II), Δn(450) represents a refractive index difference between the refractive index in the direction such that the refractive index is maximum at a wavelength of 450 nm of the optically anisotropic layer and the refractive index in a direction orthogonal thereto, and Δn(550) represents a refractive index difference between the refractive index in the direction such that the refractive index is maximum at a wavelength of 550 nm of the optically anisotropic layer and the refractive index in a direction orthogonal thereto.

### Support

The liquid crystal film of the embodiment of the present invention preferably has a support as described above. The support is not particularly limited and various known materials can be used. Among those, a long polymer film is preferable from the viewpoint that it enables continuous production.

Examples of the polymer film include polymer films obtained by forming polyolefin cyclic olefin-based resins such as polypropylene and a norbornene-based polymer; polyvinyl alcohols; polyester resins such as polyethylene terephthalate, polybutylene terephthalate, and polyethylene naphthalate; polymethacrylic acid esters·polyacrylic acid esters such as polymethyl methacrylate; cellulose esters such as triacetyl cellulose, diacetyl cellulose, and cellulose acetate propionate; polyethylene naphthalate; polycarbonates; or a copolymer thereof into films. These polymer films can be appropriately selected on the basis of the viewpoints of an elastic modulus, a flexural modulus, a parallel light ray transmittance, a haze, optical anisotropy, optical isotropy, easy peelability, easy adhesion, and the like.

In the present invention, from the viewpoint of obtaining an optically anisotropic layer having uniform alignment, the coating-side surface of the support is preferably smooth and the surface roughness Ra is preferably 3 to 50 nm in a case of forming an optically anisotropic layer by directly applying a liquid crystal composition onto a support.

In addition, in a case where an alignment layer which will be described later is provided on a support and a liquid crystal composition is applied onto the alignment layer to form an optically anisotropic layer, the surface of the alignment layer only needs to be smooth and the surface roughness Ra is preferably 3 to 50 nm. It is also possible that an interlayer which will be described later, or the like is provided and a surface roughness thereof is adjusted.

Moreover, in use of the long polymer film, from the viewpoint of preventing a phenomenon of shape transfer and blocking between the film surfaces in the state of a wound body formed by winding a liquid crystal film produced, a surface on the opposite side to a surface of the support, on which the liquid crystal composition is applied, can be subjected to an anti-blocking treatment, a mat treatment, or the like. In addition, knurling may be provided on an end of the film.

Moreover, it is also preferable that the support is provided so as to be peeled. That is, it is also preferable that the support is peelably disposed from an adjacent layer in the liquid crystal film. Here, in a case where an optically anisotropic layer is directly arranged on the support, it is preferable that peeling can occur at the interface between the support and the optically anisotropic layer. In addition, in a case where an alignment layer which will be described later and/or the other layers (interlayer) are arranged between the support and the optically anisotropic layer, it is preferable that peeling can occur at any interface between the support and the optically anisotropic layer or within the layer.

### Alignment Layer

The liquid crystal film of the embodiment of the present invention may have an alignment layer, as desired. From the viewpoint that an optically anisotropic layer having more excellent aligning properties is easily obtained, it is preferable that an alignment layer is provided on a support and the above-mentioned optically anisotropic layer is further provided on the alignment layer. That is, it is preferable that the liquid crystal film of the embodiment of the present invention has a photoalignment layer between the support and the optically anisotropic layer.

Various known alignment layers can be used as the alignment layer, and examples thereof include a rubbing film (rubbing alignment film) formed from an organic compound such as a polymer), an oblique deposition film from an inorganic compound, a film having microgrooves, and a film formed by accumulating a Langmuir-Blodgett film (LB film) formed with an organic compound (for example, ω-trichosanic acid, dioctadecylmethylammonium chloride, and a methyl stearate) by a Langmuir-Blodgett method.

From the viewpoint of preventing alignment defects caused by foreign matters, a photoalignment layer formed from a photoalignment film is also preferable as the alignment layer.

Examples of the rubbing alignment film include coating films of a polyimide, a polyvinyl alcohol, the polymer having a polymerizable group described in JP1997-152509A (JP-H09-152509A), and the like, and the alignment films described in JP2005-97377A, JP2005-99228A, and JP2005-128503A.

A composition for forming a photoalignment film used for formation of a photoalignment film which can be used in the present invention is described in a number of documents, and the like. For example, the materials using azo compounds described in WO08/056597A, JP2008-76839A, and JP2009-109831A; the photoalignment polyorganosiloxane composite materials described in JP2012-155308A, JP2014-26261A, JP2014-123091A, and JP2015-26050A; the cinnamic acid group-containing cellulose ester materials described in JP2012-234146A; the materials using an optical Fries rearrangement reaction or its analogous reaction described in JP2012-145660A and JP2013-238717A; the photodimerizable compounds (for example, materials in which a cinnamate compound, a chalcone compound, and/or a coumarin compound are pendant on various polymers) described in JP2016-71286A, JP2013-518296A, JP2014-533376A, JP2016-535158A, WO10/150748A, WO11/126022A, WO13/054784A, WO14/104320A, and WO16/002722A; or the like can be used in the composition for forming a photoalignment film.

Among those, from the viewpoint of irradiation energy, alignment regulating force, and the like required for photoalignment, a photoalignment film using the photoisomerization reaction of an azo group or a photoalignment film using the photoreaction of a cinnamate compound is preferable.

A crosslinking agent, a binder, a plasticizer, a sensitizer, a crosslinking catalyst, an adhesion modifier, a leveling agent, or the like may be added to a composition for forming an alignment film (preferably a composition for forming a photoalignment film) used for formation of an alignment film, as desired.

The film thickness of the alignment layer is not particularly limited, can be appropriately selected depending on purposes, and is, for example, preferably 10 to 1,000 nm, and more preferably 10 to 300 nm. The surface roughness of the alignment layer is the same as described above.

### Other Layers (Interlayer)

The liquid crystal film of the embodiment of the present invention can further include other layers, as desired. Examples of the layer include a smoothing layer, an easy adhesive layer, an easy peelable layer, a light-blocking layer, a colored layer, a fluorescent layer, an oxygen barrier layer, and a water vapor barrier layer. Layers having one or more of the functions of such layers are collectively referred to as an interlayer. The interlayer may be a layer having a function other than the functions as described above.

Various functions can be expressed by providing the interlayer, for example, between the support and the optically anisotropic layer and/or between the support and the above-mentioned alignment layer, or the like.

### Method for Producing Liquid Crystal Film

The liquid crystal film of the embodiment of the present invention can be manufactured by, for example, sequentially laminating and applying compositions for forming the respective layers (a liquid crystal composition and the like) onto a support.

Preferred aspects of the method include an aspect including the following steps (1) to (4) in this order.

(1) A step of applying a composition for forming an alignment film onto a support to obtain a coating film (coating step)

(2) A step of subjecting the coating film to a rubbing treatment or a photoalignment treatment to impart the coating film with an alignment regulating force, thereby forming the coating film into an alignment layer (alignment regulating force imparting step)

(3) A step of applying a liquid crystal composition onto the alignment layer

(4) A step of aligning the polymerizable liquid crystal compound and then fixing the alignment state

Furthermore, the process after the step (3) is the same as described above in the method for forming an optically anisotropic layer.

### Applying Step

An applying method in the applying step is not particularly limited, and can be appropriately selected depending on the purposes, and examples of the method include spin coating, die coating, gravure coating, flexography, and ink jet printing. It is preferable that a solvent removing step (drying step) is included after application of the composition for forming an alignment film, and a post-baking step can further be included.

### Alignment Regulating Force Imparting Step

An alignment regulating force imparting step is a step of subjecting the coating film formed with the composition for forming an alignment film to a rubbing treatment, a light irradiation treatment, or the like. The rubbing treatment can be performed by a method known in the related art.

For the light irradiation treatment to which the coating film formed with the composition for forming a photoalignment film is subjected, it is preferable to perform irradiation with polarized light. The polarized light is not particularly limited, examples thereof include linearly polarized light, circularly polarized light, and elliptically polarized light, and among these, the linearly polarized light is preferable. From the viewpoint of forming a liquid crystal layer which is horizontally aligned, it is preferable to perform irradiation with polarized light from the vertical direction, and from the viewpoint of imparting tilt alignment or a tilt, it is preferable to perform irradiation with polarized light from the oblique direction.

The wavelength with regard to polarized light or non-polarized light is not particularly limited as long as it can impart a coating film formed with the composition for forming a photoalignment film with an alignment control ability on a polymerizable liquid crystal compound or the like. Examples of the light used include ultraviolet rays, near-ultraviolet rays, and visible light. Among those, near-ultraviolet rays at 250 to 450 nm are preferable.

In addition, examples of a light source for irradiation with polarized light or non-polarized light include a xenon lamp, a high-pressure mercury lamp, an ultra-high-pressure mercury lamp, a metal halide lamp, a laser, and a light emitting diode (LED). A wavelength range for irradiation can be limited by using an interference filter, a color filter, or the like with respect to ultraviolet rays or visible light obtained from the light source, as desired. In addition, linearly polarized light can be obtained by using a polarizing filter, a polarizing prism, or the like with respect to light from these light sources.

An integrated amount of the polarized light or non-polarized light is not particularly limited as long as it can impart the coating film from the composition for forming a photoalignment film with an alignment control ability on the polymerizable liquid crystal compound, and is, for example, preferably 1 to 300 mJ/cm², and more preferably 3 to 100 mJ/cm².

An illuminance of the polarized light or non-polarized light is not particularly limited as long as it can impart the coating film from the composition for forming a photoalignment film with an alignment control ability on the liquid crystal compound, and is, for example, preferably 0.1 to 300 mW/cm², and more preferably 1 to 100 mW/cm².

### Hardcoat Film

The hardcoat film of an embodiment of the present invention is a hardcoat film having a layer formed from the above-mentioned composition of the embodiment of the present invention.

Suitable examples of the composition for forming such a hardcoat film include a composition having the above-mentioned fluorine-containing polymer of the embodiment of the present invention incorporated into a curable composition (for example, a curable composition containing a polyorganosylsesquioxane including the siloxane constitutional unit containing an epoxy group described in JP2017-008143A, JP2018-192704A, and the like).

In addition, such a hardcoat film can be produced, for example, by applying the above-mentioned composition on a cellulose ester substrate, followed by drying and then irradiating with ultraviolet rays to cure the coating layer.

### Polarizing Plate

The polarizing plate of an embodiment of the present invention is a polarizing plate having a layer formed from the composition of the above-mentioned embodiment of the present invention.

Examples of the structure of the polarizing plate of the embodiment of the present invention include a polarizer and the hardcoat film of the embodiment of the present invention provided as a protective film on at least one surface of the polarizer.

In addition, in another configuration of the polarizing plate of the embodiment of the present invention, the polarizing plate may include a polarizer, the hardcoat film of the embodiment of the present invention provided as a protective film on one surface of the polarizer, and an optical compensation film having optical anisotropy provided on the other surface of the polarizer. The optical compensation film in this case can be the same as the above-mentioned optically anisotropic layer.

As described above, it is preferable that the polarizing plate of the embodiment of the present invention is composed of a polarizer and a protective film that protects both sides thereof, and it is more preferable that the protective film is bonded to one surface of the polarizing plate and a separate film is bonded on the opposite surface.

The protective film and the separate film are used for the purpose of protecting the polarizing plate at the time of shipping of the polarizing plate, product inspection, or the like. Incidentally, the protective film is bonded for the purpose of protecting the surface of the polarizing plate, and is used on the opposite surface side of a surface where the polarizing plate is bonded to a liquid crystal plate. In addition, the separate film is used for the purpose of covering an adhesive layer to be bonded to the liquid crystal plate, and is used on a surface side where the polarizing plate is bonded to the liquid crystal plate.

The method for manufacturing a polarizing plate of the embodiment of the present invention is not particularly limited, and the polarizing plate can be manufactured by a general method.

For example, a method in which the obtained hardcoat film is subjected to an alkali treatment and is adhered to both sides of a polarizer manufactured by immersing a polyvinyl alcohol film in an iodine solution and stretching the film, using a completely saponified aqueous polyvinyl alcohol solution. In addition, instead of the alkali treatment, the easy-adhesion processing as described in JP1994-94915A (JP-H06-94915A) and JP1994-118232A (JP-H06-118232A) may be carried out. Moreover, the surface treatment as mentioned above may be performed. The surface on which the hardcoat film is bonded to the polarizer may be a surface on which the hardcoat layer is laminated or a surface on which the hardcoat layer is not laminated.

Examples of the adhesive used for adhering the protective film-treated surface to the polarizer include a polyvinyl alcohol-based adhesive such as a polyvinyl alcohol and a polyvinyl butyral, and a vinyl-based latex such as butyl acrylate.

### EXAMPLES

Hereinafter, the present invention will be described in more detail with reference to Examples. The materials, the amounts of materials used, the proportions, the treatment details, the treatment procedure, and the like shown in Examples below may be appropriately modified as long as the modifications do not depart from the spirit of the present invention. Therefore, the scope of the present invention should not be construed as being limited to Examples shown below.

### Synthesis of Fluorinated Monomer

<Synthesis Example 1-a>

14.76 g (165.6 mmol) of 4-amino-2-butanol and 40 g of acetonitrile were placed in a 300 mL three-necked flask equipped with a cooling tube, a stirrer, a dropping funnel, and a thermometer, and cooled to an internal temperature of 10° C. or lower. 115.92 g (364.36 mmol) of 2-(perfluorobutyl)ethyl acrylate (FAAC-4 manufactured by Unimatec Co., Ltd.) was added dropwise thereto over 30 minutes. Then, the mixture was reacted at 60° C. for 10 hours. The progress of the reaction was confirmed by 1H NMR and the reaction rate was 99.9%.

The internal temperature of the obtained reaction solution was set to 10° C. or lower again. 21.79 g (215.28 mmol) of triethylamine was added thereto, followed by dropwise addition of 19.48 g (215.28 mmol) of chloride acrylate over 2 hours, and the mixture was reacted at room temperature for 2 hours. The reaction solution was transferred to a liquid separation funnel, the liquid separation was performed twice with 2 N hydrochloric acid, and then the liquid separation was performed twice with aqueous sodium bicarbonate. Finally, the liquid separation was performed twice with water, and the organic layer was taken out and dried over magnesium sulfate. After magnesium sulfate was removed by filtration, a small amount of 4-methoxyphenol as a polymerization inhibitor was added to the residue, and the solvent was distilled off 100 g of hexane was added to the obtained liquid, and the mixture was stirred for 2 hours at room temperature to remove the supernatant.

The solvent was distilled off to obtain 38.49 g of a desired monomer (I-a).

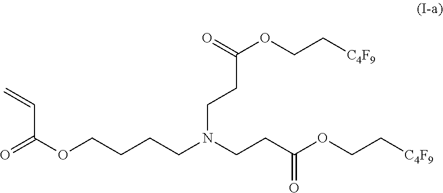

The raw materials used in Synthesis Example 1-a were changed to obtain fluorinated monomers (I-b) to (I-d).

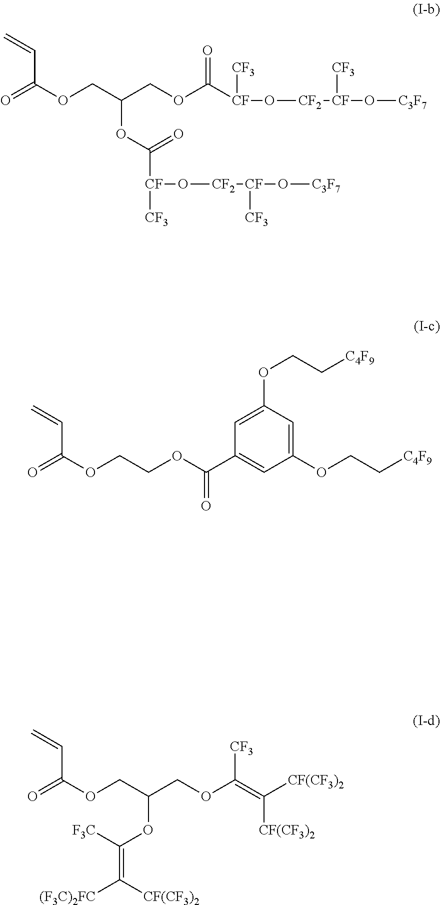

### Synthesis Example 2-a

2-(Perfluorobutyl)ethanol (25 g, 0.095 mol), itaconic acid (8.4 g, 0.065 mol), methanesulfonic acid (26 g, 0.27 mol), and p-methoxyphenol (40 mg) were added into 0.2 L three-necked flask equipped with a stirring blade, a thermometer, and a circulating tube, and the mixture was stirred at an internal temperature of 90° C. for 9 hours. The reaction solution was cooled to room temperature (23° C.) and diluted with ethyl acetate (300 mL). 8 wt % aqueous NaCl (150 mL) was added to the reaction solution to separate the layers, and the aqueous layer was removed. Subsequently, a 7.5 wt % aqueous sodium hydrogen carbonate solution (150 mL) was added to the remaining upper layer and subjected to liquid separation, and the aqueous layer was removed. Further, 8 wt % aqueous NaCl (50 mL) was added to the upper layer and subjected to liquid separation, and the aqueous layer was removed. The obtained organic layer was dried over magnesium sulfate, and filtered. P-methoxyphenol (30 mg) was added to the obtained filtrate, the solvent was distilled off by concentration under reduced pressure, and the mixture was purified and concentrated by silica gel column chromatography (hexane/ethyl acetate=3/1) to obtain 23 g of a colorless and transparent monomer (II-a) (yield 78%).

(NMR: 400 MHz/CDCl₃) 6.38 (s, 1 H), 5.78 (s, 1 H), 4.48 (t, J=6.4 Hz, 2 H), 4.40 (t, J=6. 4 Hz, 2 H), 3.37 (s, 2 H), 2.39-2.26 (m, 4 H).

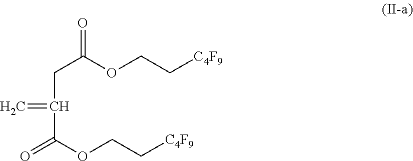

The raw materials used in Synthesis Example 2-a were changed to obtain fluorinated monomers (II-b), (II-c), (III-a), (III-b), (III-c), and (III-d).

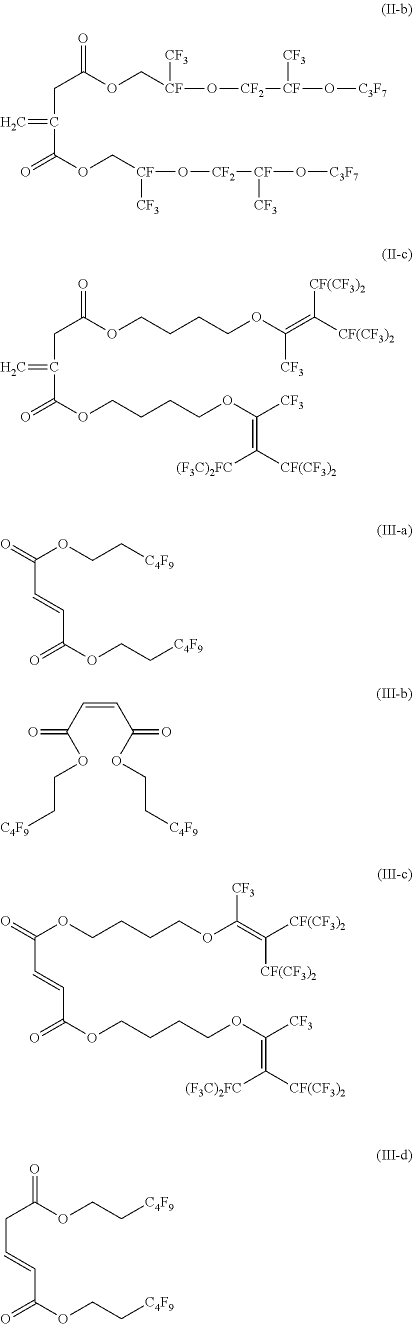

### Synthesis Example 1

10.0 g of cyclohexanone was placed in a 200 mL three-necked flask equipped with a stirrer, a cooling tube, a nitrogen introduction tube, and a thermometer, and heated to 80° C. Under a nitrogen flow, a mixed solution of 6.5 g of the monomer (I-a), 13.5 g of ethoxylated-o-phenylphenol acrylate (A-LEN-10, manufactured by Shin-Nakamura Chemical Co., Ltd.), 0.1 g of dimethyl 2,2′-azobis(isobutyrate), and 10.0 g of cyclohexanone was added dropwise thereto over 3 Hours. After aging for 1 Hour, a mixed solution of 0.5 g of dimethyl 2,2′-azobis(isobutyrate) and 1.0 g of cyclohexanone was added thereto, and the internal temperature was adjusted to 90° C. for further aging for 3 Hours. Then, the mixture was cooled and diluted by addition of 10.0 g of cyclohexanone to obtain 48.0 g of a fluorine-containing polymer (Ia-1). The obtained polymer had a weight-average molecular weight of 22,800 and a molecular weight distribution of 1.85 (calculated in terms of polystyrene under the measurement conditions of an eluent of THF, a flow rate of 0.35 ml/min, and a temperature of 40° C., and columns used of TSKgel SuperHZM-H, TSKgel SuperHZ4000, and TSKgel SuperHZ200 (manufactured by Tosoh Corporation), using gel permeation chromatography (EcoSEC HLC-8320GPC (manufactured by Tosoh Corporation)).

### Synthesis Examples 2 to 25

Fluorine-containing polymers (Ia-2) to (Ia-8), (IIa-1) to (IIa-10), and (IIIa-1) to (IIIa-7) were obtained in the same manner as in Synthesis Example 1, except that the monomers and the compositional ratios used in Synthesis Example 1 were changed to the monomers forming the repeating unit of the fluorine-containing polymers having the structures shown in Table 4 below, and compositional ratios thereof.

The fluorine-containing polymers synthesized in Synthesis Examples 1 to 25 are shown. Furthermore, the subscripts of the monomer constitutional units in the structural formulae represent % by mass of the entire polymer.

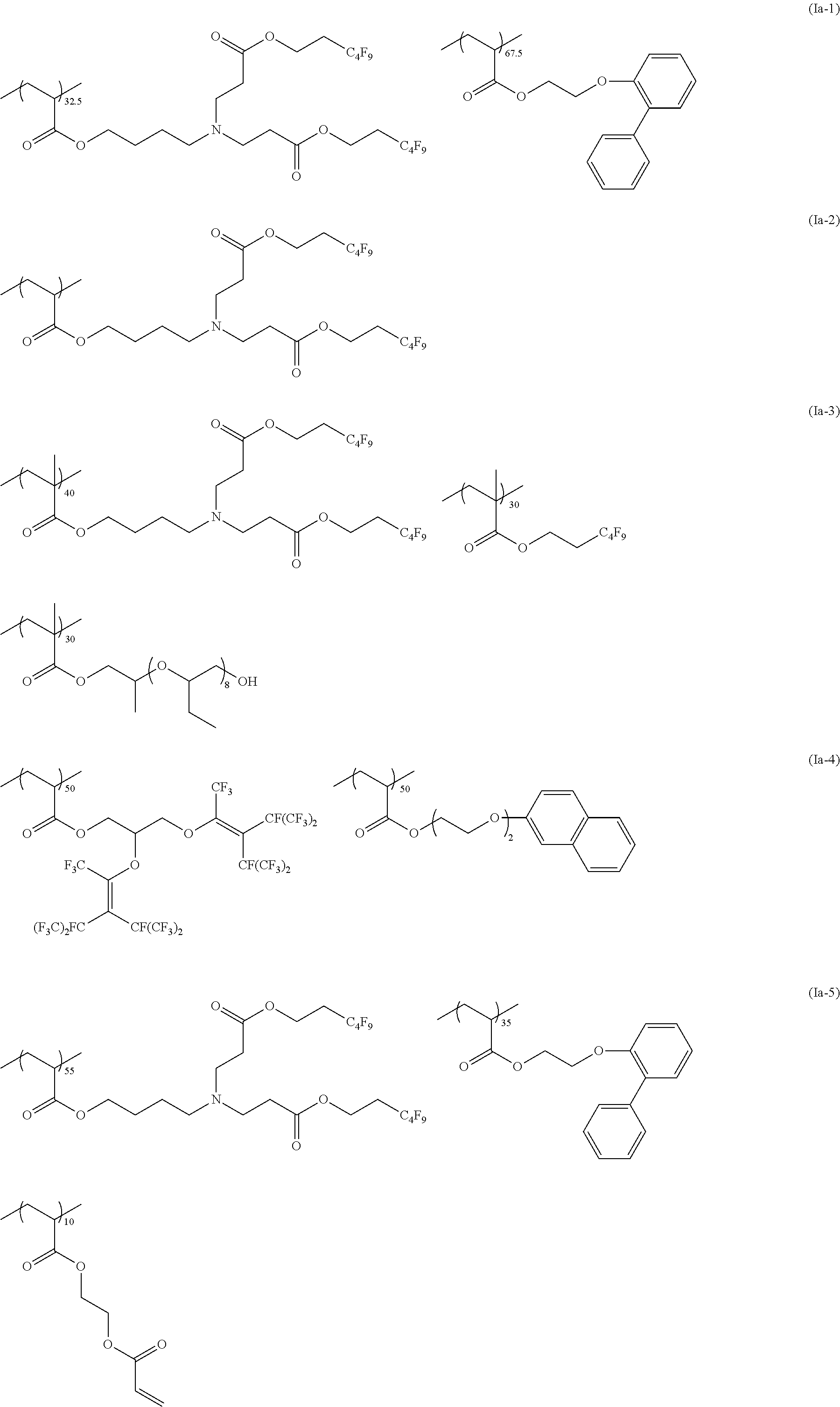

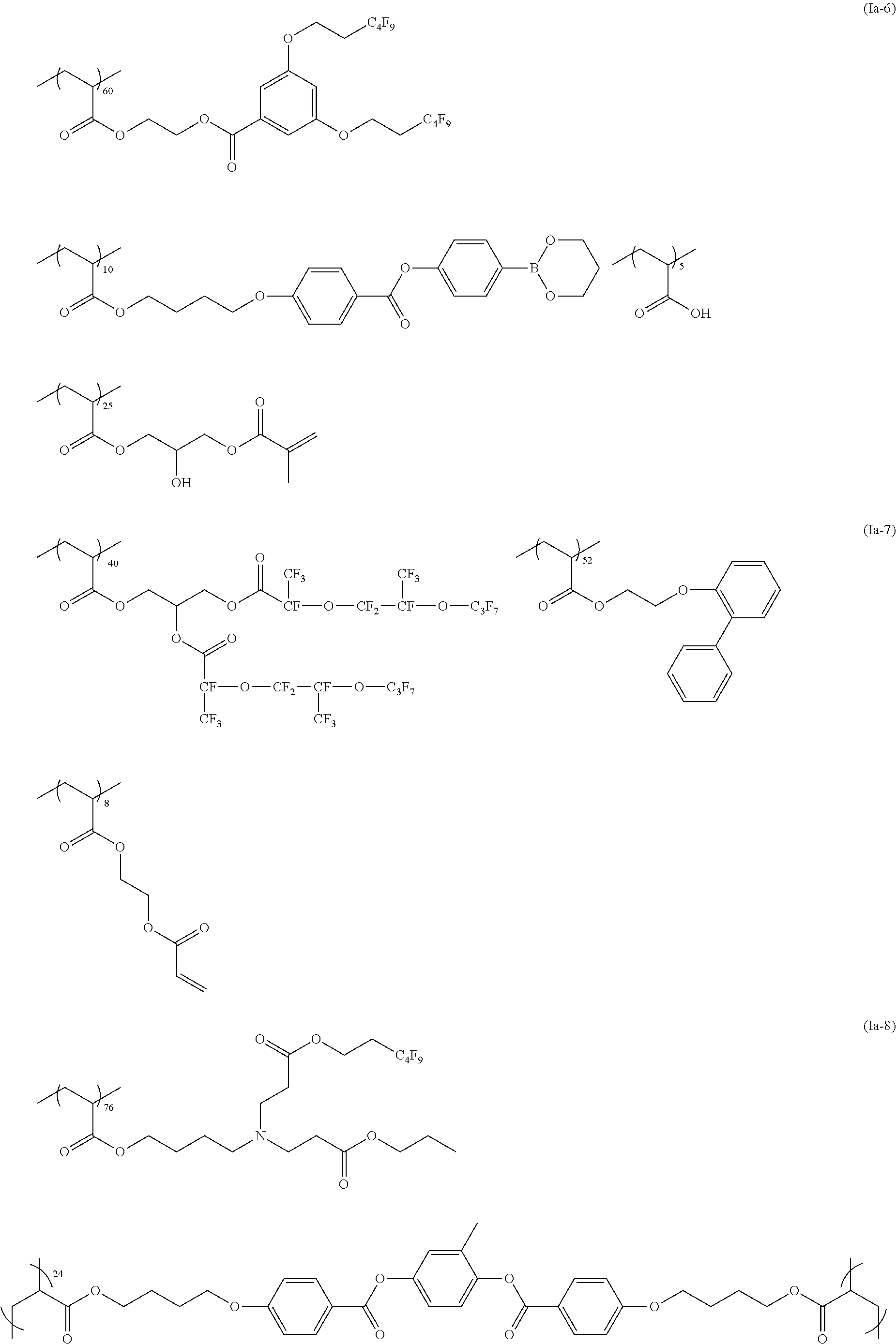

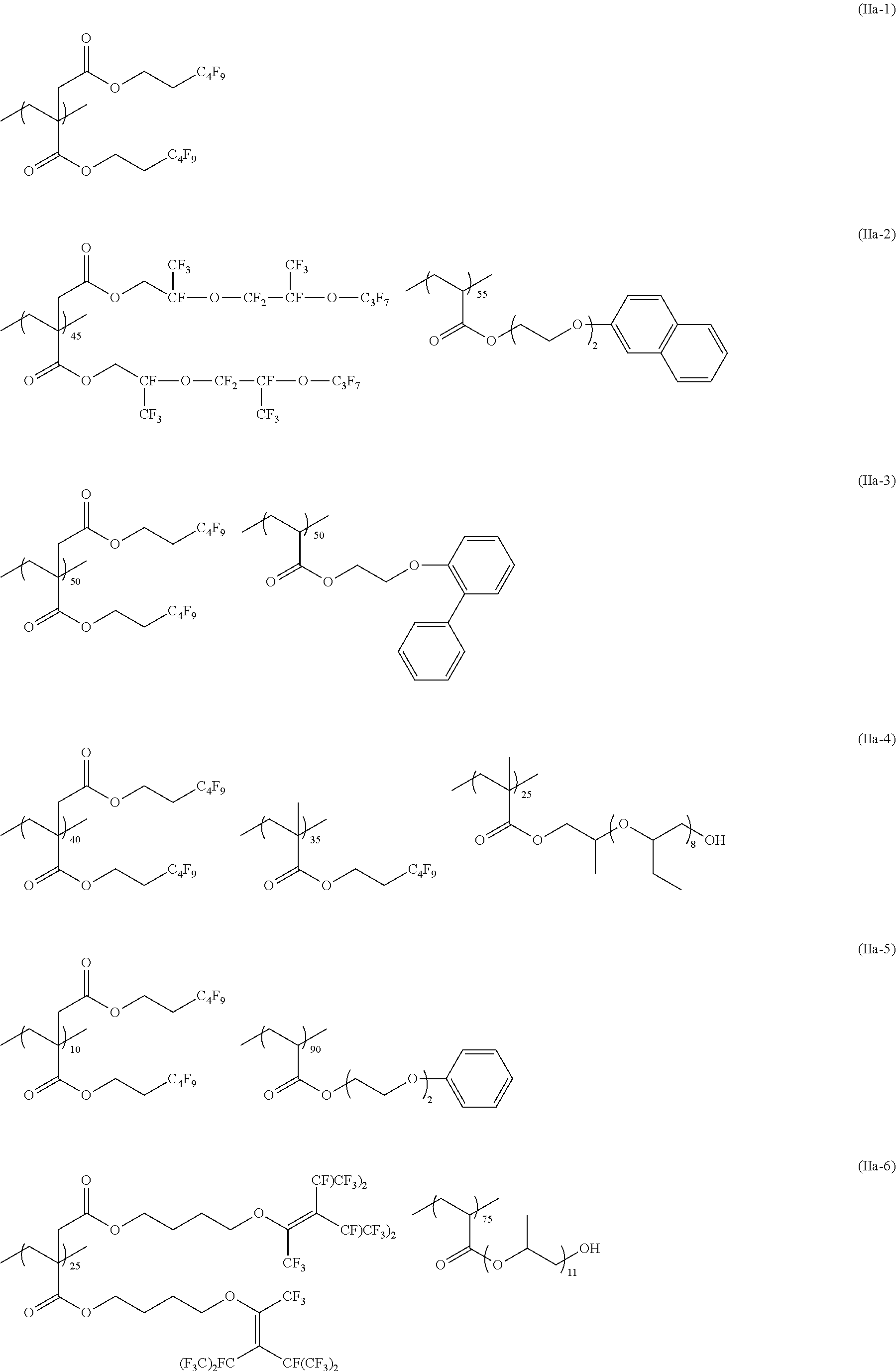

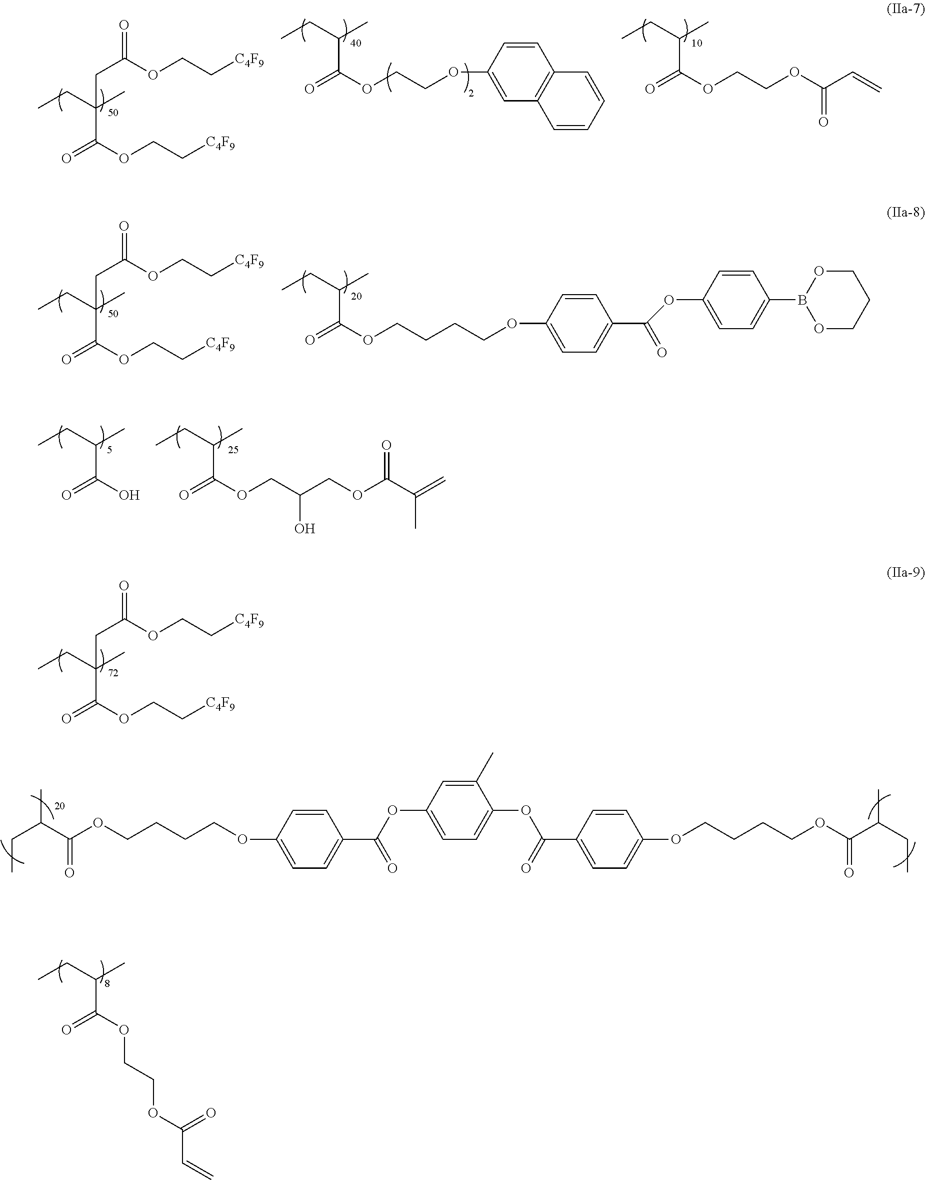

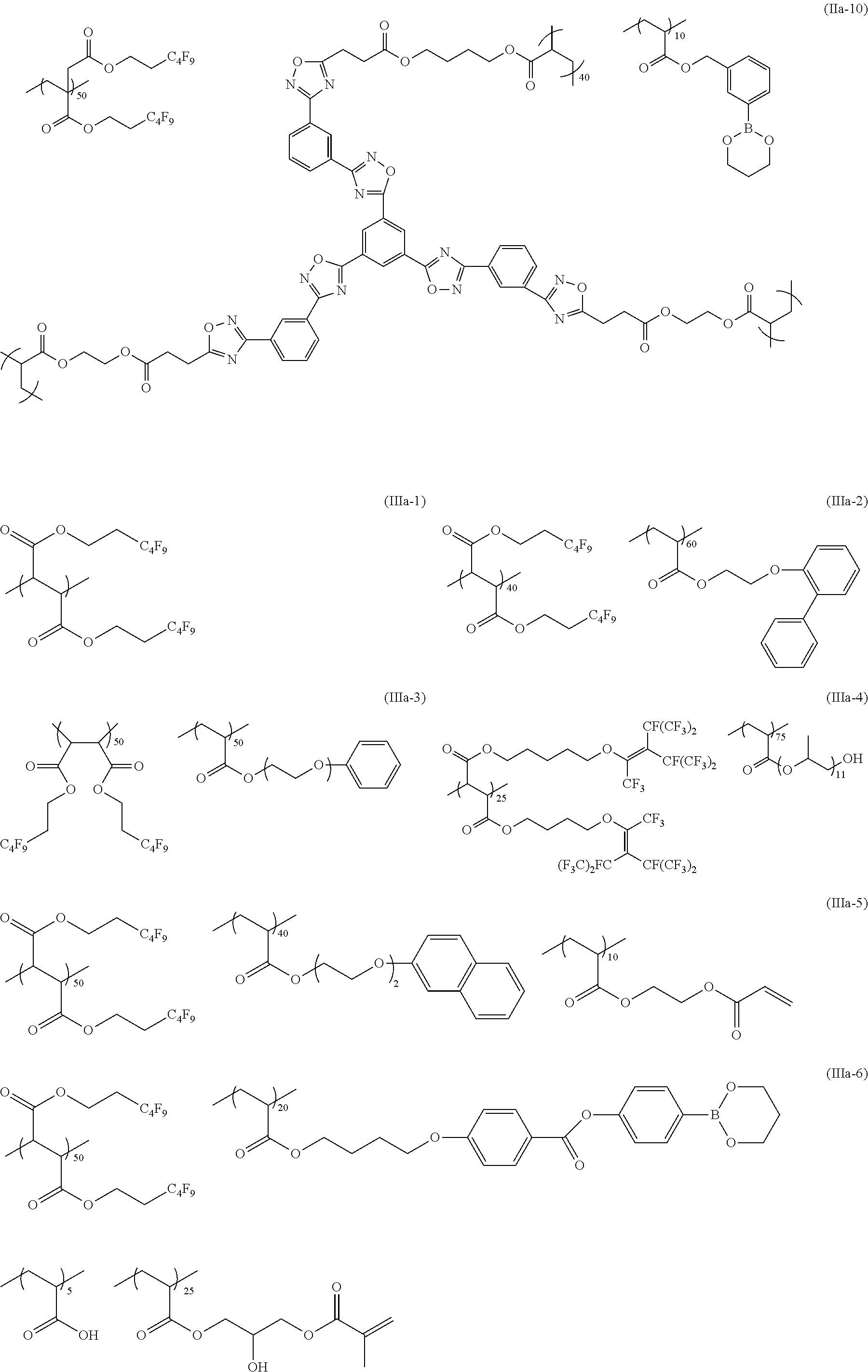

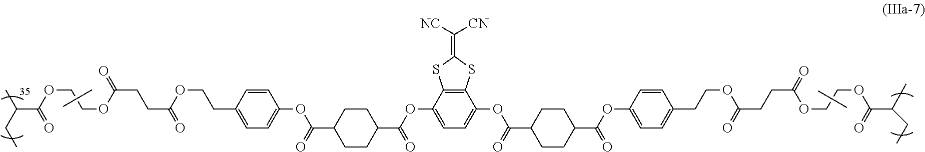

TABLE 4

| | | Molecular weight (GPC) | | |
|---|---|---|---|---|
| | Structure | Mw | Mn | Mw/Mn |
| Synthesis Example 1 | Ia-1 | 22,800 | 12,300 | 1.85 |
| Synthesis Example 2 | Ia-2 | 19,500 | 8,500 | 2.29 |
| Synthesis Example 3 | Ia-3 | 13,100 | 6,400 | 2.05 |
| Synthesis Example 4 | Ia-4 | 16,500 | 6,800 | 2.43 |
| Synthesis Example 5 | Ia-5 | 29,900 | 13,600 | 2.20 |
| Synthesis Example 6 | Ia-6 | 24,400 | 9,900 | 2.46 |
| Synthesis Example 7 | Ia-7 | 8,800 | 3,400 | 2.59 |
| Synthesis Example 8 | IIa-1 | 12,300 | 3,800 | 3.24 |
| Synthesis Example 9 | IIa-2 | 21,300 | 9,800 | 2.17 |
| Synthesis Example 10 | IIa-3 | 26,400 | 8,800 | 3.00 |
| Synthesis Example 11 | IIa-4 | 44,500 | 18,400 | 2.42 |
| Synthesis Example 12 | IIa-5 | 36,500 | 13,300 | 2.74 |
| Synthesis Example 13 | IIa-6 | 22,500 | 9,300 | 2.42 |
| Synthesis Example 14 | IIa-7 | 11,200 | 3,300 | 3.39 |
| Synthesis Example 15 | IIa-8 | 29,400 | 11,300 | 2.60 |
| Synthesis Example 16 | IIIa-1 | 11,100 | 4,500 | 2.47 |
| Synthesis Example 17 | IIIa-2 | 8,400 | 2,900 | 2.90 |
| Synthesis Example 18 | IIIa-3 | 41,100 | 13,400 | 3.07 |
| Synthesis Example 19 | IIIa-4 | 23,400 | 10,200 | 2.29 |
| Synthesis Example 20 | IIIa-5 | 10,700 | 3,800 | 2.82 |
| Synthesis Example 21 | IIIa-6 | 21,400 | 9,200 | 2.33 |
| Synthesis Example 22 | Ia-8 | 25,200 | 10,500 | 2.40 |
| Synthesis Example 23 | IIa-9 | 11,200 | 2,800 | 4.00 |
| Synthesis Example 24 | Ila-10 | 9,100 | 2,200 | 4.14 |
| Synthesis Example 25 | IIIa-7 | 35,400 | 11,200 | 3.16 |

### Examples 1 to 25 and Comparative Examples 1 to 4

[Preparation of Composition for Forming Photoalignment Film]

The photoalignment film forming material described in Example 1 of WO2016/002722A was prepared and used for producing the liquid crystal film of the embodiment of the present invention.

[Preparation of Liquid Crystal Composition]

A liquid crystal composition having the following composition was prepared.

### Liquid Crystal Compositions (Examples 1 to 25 and Comparative Examples 1 to 4)

| The following polymerizable | 43.00 | parts by mass |
|---|---|---|
| liquid crystal compound L-3 | | |
| The following polymerizable | 43.00 | parts by mass |
| liquid crystal compound L-4 | | |
| The following polymerizable | 14.00 | parts by mass |
| liquid crystal compound A-l | | |
| The following polymerization | 0.50 | parts by mass |
| initiator S-1 (oxime esters) | | |
| Fluorine-containing polymer | Addition amount shown in Table 5 below | |
| HISOLVE MTEM (manufactured by | 2.00 | parts by mass |
| TOHO Chemical Industry Co., Ltd.) | | |
| NKester A-200 (manufactured by | 1.00 | part by mass |
| Shin-Nakamura Chemical Co., Ltd.) | | |
| Pentaerythritol tetraacrylate (manufactured | 6.00 | parts by mass |
| by Shin-Nakamura Chemical Co., Ltd.) | | |
| Methyl ethyl ketone (solvent) | 160.00 | parts by mass |
| Cyclopentanone (solvent) | 51.00 | parts by mass |

In addition, a group adjacent to each of the acryloyloxy groups of the following polymerizable liquid crystal compounds L-3 and L-4 represents a propylene group (a group in which a methyl group is substituted with an ethylene group), and the following polymerizable liquid crystal compounds L-3 and L-4 each represent a mixture of regioisomers having different positions of the methyl groups.

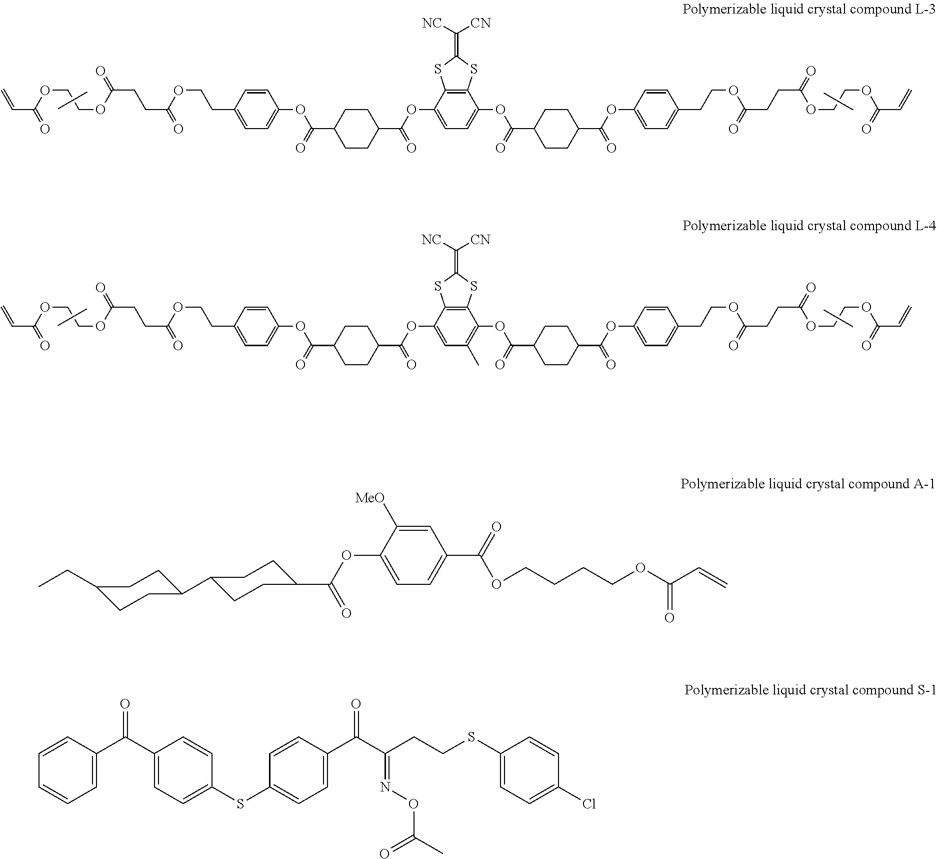

### Manufacture of Cellulose Acylate Film

(Manufacture of Core Layer Cellulose Acylate Dope)

The following composition was introduced into a mixing tank and stirred to dissolve the respective components to prepare a cellulose acetate solution for use as a core layer cellulose acylate dope.

### Core Layer Cellulose Acylate Dope

| | | |
|---|---|---|
| Cellulose acetate having degree of | 100 | parts by mass |
| substitution with acetyl of 2.88 | | |
| Polyester compound B described in | 12 | parts by mass |
| Examples of JP2015-227955A | | |
| The following compound G | 2 | parts by mass |
| Methylene chloride (first solvent) | 430 | parts by mass |
| Methanol (second solvent) | 64 | parts by mass |

### Compound G

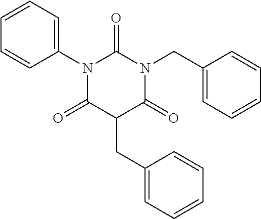 [SMILES: O=C1C(Cc2ccccc2)C(=O)N(c2ccccc2)C(=O)N1Cc1ccccc1]

### Manufacture of Outer Layer Cellulose Acylate Dope

10 parts by mass of the following matting agent solution was added to 90 parts by mass of the core layer cellulose acylate dope to prepare a cellulose acetate solution for use as an outer layer cellulose acylate dope.

### Matting Agent Solution

| | | |
|---|---|---|
| Silica particles having average | 2 | parts by mass |
| particle size of 20 nm (AEROSIL R972, | | |
| manufactured by Nippon Aerosil Co., Ltd.) | | |
| Methylene chloride (first solvent) | 76 | parts by mass |
| Methanol (second solvent) | 11 | parts by mass |
| The core layer cellulose acylate dope | 1 | part by mass |

### Manufacture of Cellulose Acylate Film 1

The core layer cellulose acylate dope and the outer layer cellulose acylate dope were filtered through a filter paper having an average pore diameter of 34 μm and a sintered metal filter having an average pore diameter of 10 μm and then all the three layers of the core layer cellulose acylate dope and the outer layer cellulose acylate dopes of both sides thereof were simultaneously cast on a drum at 20° C. from a casting port (band casting machine). Peeling was performed in the state where the solvent content was approximately 20% by mass, and the both ends of the film in the width direction were fixed with a tenter clip and dried while stretching the film at a stretching ratio of 1.1 times in the transverse direction. Thereafter, the obtained film was transported between rolls of a heat treatment device and further dried to manufacture an optical film having a thickness of 40 μm which was taken as a cellulose acylate film 1. In the obtained cellulose acylate film 1, the thickness of the core layer was 36 μm and the thickness of each of the outer layers arranged on the both sides of the core layer was 2 μm. The in-plane retardation of the obtained cellulose acylate film 1 at a wavelength of 550 nm was 0 nm.

The obtained cellulose acylate film 1 was taken as a support.

### Manufacture of Liquid Crystal Film

The composition for forming a photoalignment film prepared above was applied onto a surface of one side of the manufactured cellulose acylate film 1 with a bar coater.

After applying the composition for forming a photoalignment film, the obtained film was dried for 1 minute on a hot plate at 120° C. to remove the solvent, thereby forming a composition layer for forming a photoalignment film having a thickness of 0.3 μm.

The obtained composition layer for forming a photoalignment film was irradiated with polarized ultraviolet rays (10 mJ/cm², an ultra-high pressure mercury lamp was used) to form a photoalignment layer.

Subsequently, the liquid crystal compositions prepared above (Examples 1 to 25 and Comparative Examples 1 to 4) were each applied onto the photoalignment layer with a bar coater, thereby forming a liquid crystal composition layer.

The formed liquid crystal composition layer was once heated to 110° C. on a hot plate and then cooled to 60° C. to stabilize the alignment.

Thereafter, the liquid crystal composition layer was kept at 60° C. and irradiated with ultraviolet rays (500 mJ/cm², an ultra-high pressure mercury lamp was used) in a nitrogen atmosphere (an oxygen concentration of 100 ppm) to fix the alignment, thereby forming an optically anisotropic layer having a thickness of 2.3 μm, from which a liquid crystal film was manufactured. The in-plane retardation of the obtained liquid crystal film at a wavelength of 550 nm was 140 nm.

### Evaluation of Aligning Properties

The manufactured liquid crystal film was observed in the state of being 2° shifted from an extinction position with a polarizing microscope. A state where a partial difference in brightness upon observation did not exist was evaluated as a case where the liquid crystal director is uniformly aligned (excellent aligning properties).

The results of observation were classified in light of the following standard. The results are shown in Table 5 below.

AA: The liquid crystal director is finely arranged and aligned, and the display performance is very excellent.

A: The liquid crystal director is uniformly arranged and aligned, and the display performance is excellent.

B: Disturbance of the liquid crystal director is partial and the surface state is stable.

C: The liquid crystal director is significantly disturbed, the surface state is not stable, and thus, the display performance is extremely deteriorated.

### Evaluation of Interference Unevenness in Liquid Crystal Composition Layer

In order to prevent reflection on a surface (back surface) of the liquid crystal film opposite to the liquid crystal composition layer, the back surface was painted with a black marker, and then the front surface (the surface on which the liquid crystal composition layer was applied) of the liquid crystal film was observed under a 3-wavelength fluorescent lamp with a diffuser mounted on the front surface. The liquid crystal film was visually observed from the front surface and evaluated according to the following evaluation standard.

A: There were no interference fringes.

B: Very few interference fringes were seen, but they were not noticeable.

C: Interference fringes were seen in some places, but were acceptable for a product.

D: Interference fringes were strongly generated, and are problematic.

### Evaluation of Bumpy Defects in Liquid Crystal Composition Layer

Irradiation with a fluorescent lamp was performed from the back surface side, and 3 m² inspection was performed by a transmission visual inspection from the liquid crystal composition layer coating surface (front surface) side and a reflection visual inspection irradiated with the fluorescent lamp from the liquid crystal composition layer coating surface side, and bright spot-like defects were collected. Furthermore, the collected defects were analyzed with a microscope, IR, and a microscopic Raman spectroscope, the number of defects whose composition is the same as that of the normal part was counted, and the value was divided by 3 to calculate the number of bumpy defects per m².

A: The number of bumpy defects is 0 in terms of 1 m², and no defects are generated.

B: One to five bumpy defects were generated in terms of 1 m², which is, however, infrequent and is not problematic.

C: Six or more bumpy defects were generated in terms of conversion to 1 m², which is problematic.

### Evaluation of Cissing

A liquid crystal film for evaluation of cissing was manufactured in the same manner as in the production of the above-mentioned production of the liquid crystal film, except that the liquid crystal composition layer obtained using the following liquid crystal composition was used instead of the liquid crystal composition layer used in the above-mentioned evaluations (aligning properties, interference unevenness, and bumpy defects).

### Liquid Crystal Composition (Examples 1 to 25 and Comparative Examples 1 to 4: For Evaluation of Cissing)

| Polymerizable liquid crystal compound L-3 | 43.00 | parts by mass |
|---|---|---|
| Polymerizable liquid crystal compound L-4 | 43.00 | parts by mass |
| Polymerizable liquid crystal compound A-1 | 14.00 | parts by mass |
| Polymerization initiator S-1 (oxime esters) | 0.50 | parts by mass |
| Fluorine-containing polymer of the | Addition amount shown in Table 5 below | |
| embodiment of the present invention | | |
| HISOLVE MTEM (manufactured by | 2.00 | parts by mass |
| TOHO Chemical Industry Co., Ltd.) | | |
| NKester A-200 (manufactured by | 1.00 | part by mass |
| Shin-Nakamura Chemical Co., Ltd.) | | |
| Pentaerythritol tetraacrylate (manufactured | 6.00 | parts by mass |
| by Shin-Nakamura Chemical Co., Ltd.) | | |
| Methyl ethyl ketone (solvent) | 85.00 | parts by mass |
| Cyclopentanone (solvent) | 33.00 | parts by mass |

The number of cissings in the liquid crystal composition layer in each of the manufactured liquid crystal films was counted. Furthermore, a region on the surface of the photoalignment layer, where the liquid crystal composition layer was not formed, was designated as a cissing. Based on the results, evaluation was performed according to the following standard. The evaluation standard A or B indicates that the production efficiency is excellent and the product can be suitably used, and thus, the evaluation standard A is more preferable.

A: There are 1 or less cissings

B: There are 1 to 3 cissings

C: There are 4 to 9 cissings

D: There are 10 or more cissings

The results above are shown in Table 5 below. Furthermore, in Table 5 below, SURFLON S243 is a fluorine-containing material manufactured by AGC Seimi Chemical Co., Ltd., and MEGFACE F-444 and F-554 are both a fluorine-containing material manufactured by

DIC Corporation.

TABLE 5

| | Fluorine-containing polymer | | | | | |
|---|---|---|---|---|---|---|
| | | Addition | Evaluation results | | | |
| | Structure | amount | Aligning | Interference | Bumpy | |
| | and the like | (parts by mass) | properties | unevenness | defects | Cissing |
| Example 1 | Ia-1 | 0.23 | AA | A | A | B |
| Example 2 | Ia-2 | 0.23 | B | B | B | B |
| Example 3 | Ia-3 | 0.15 | A | A | A | B |
| Example 4 | Ia-4 | 0.09 | AA | A | A | B |
| Example 5 | Ia-5 | 0.15 | AA | A | A | B |
| Example 6 | Ia-6 | 0.25 | AA | A | A | B |
| Example 7 | Ia-7 | 0.32 | AA | A | A | B |
| Example 8 | IIa-1 | 0.15 | B | B | B | B |
| Example 9 | IIa-2 | 0.09 | AA | A | A | B |
| Example 10 | IIa-3 | 0.23 | AA | A | A | B |
| Example 11 | IIa-4 | 0.18 | A | A | A | B |
| Example 12 | IIa-5 | 0.09 | AA | A | A | B |
| Example 13 | IIa-6 | 0.25 | B | B | B | B |
| Example 14 | IIa-7 | 0.09 | AA | A | A | B |
| Example 15 | IIa-8 | 0.45 | AA | A | A | B |
| Example 16 | IIIa-1 | 0.48 | B | B | B | B |
| Example 17 | IIIa-2 | 0.23 | AA | A | A | B |
| Example 18 | IIIa-3 | 0.09 | AA | A | A | B |
| Example 19 | IIIa-4 | 0.45 | B | B | B | B |
| Example 20 | IIIa-5 | 0.09 | AA | A | A | B |
| Example 21 | IIIa-6 | 0.33 | AA | A | A | B |
| Example 22 | Ia-8 | 0.18 | AA | A | A | A |
| Example 23 | IIa-9 | 0.18 | AA | A | A | A |
| Example 24 | IIa-10 | 0.25 | AA | A | A | A |
| Example 25 | IIIa-7 | 0.15 | AA | A | A | A |
| Comparative | None | 0 | A | D | C | D |
| Example 1 | | | | | | |
| Comparative | SURFLON | 0.23 | C | C | C | D |
| Example 2 | S243 | | | | | |
| Comparative | MEGFACE | 1.25 | B | D | C | D |
| Example 3 | F-444 | | | | | |
| Comparative | MEGFACE | 0.23 | B | C | C | C |
| Example 4 | F-554 | | | | | |

From the results shown in Table 5 above, it was confirmed that the liquid crystal film having the fluorine-containing polymer of the embodiment of the present invention is a film with high homogeneity, having excellent aligning properties, and less interference unevenness, bumpy defects, and cissing (Examples 1 to 25).

From the comparison of Examples 1 to 25, it was shown that the liquid crystal film formed using the fluorine-containing polymer having a repeating unit derived from the liquid crystal compound can further suppress cissing (Examples 22 to 25).

What is claimed is:

1. A fluorine-containing polymer comprising at least one repeating unit represented by any of General Formulae (I) to (III). 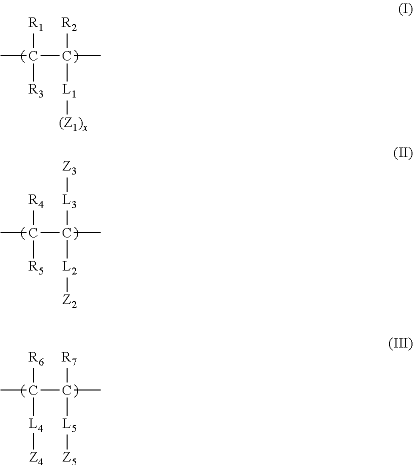
in General Formulae (I) to (III),
L₁ represents an (x+1)-valent linking group,
x represents an integer of 2 or more,
L₂ to L₅ each independently represent a single bond or a divalent linking group,
R₁ to R₇ each independently represent a hydrogen atom, a fluorine atom, a chlorine atom, or an alkyl group having 1 to 20 carbon atoms, and
Z₁ to Z₅ each independently represent a fluorine atom-containing aliphatic hydrocarbon group which may have an oxygen atom, and a plurality of Z₁'s may be the same as or different from each other,
provided that a unit represented by Formula (Ie) is not included in General Formula (I), 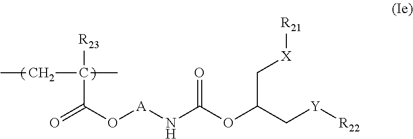
in General Formula (Ie),
R₂₁ represents a perfluoroalkyl group having 1 to 20 carbon atoms, a partially fluorinated alkyl group having 1 to 20 carbon atoms, a perfluoroalkyl group having a total number of carbon atoms of 1 to 20, in which perfluoroalkyl groups are linked through an oxygen atom, or a partially fluorinated alkyl group having a total number of carbon atoms of 1 to 20, in which partially fluorinated alkyl groups are linked through an oxygen atom,
R₂₂ represents the same group as R₂₁, an alkyl group having 1 to 10 carbon atoms, an aralkyl group having 1 to 10 carbon atoms, or a phenyl group,
R₂₃ represents a hydrogen atom or a methyl group,
A represents a divalent linking group represented by —CH₂—CH₂—, —CH₂—CH₂—CH₂—, —CH₂CH(CH₃)—, or —CH(CH₃)CH₂—, and
X and Y each independently represent a divalent linking group represented by Structural Formula (a), (b), or (c),
provided that R⁴¹ in Structural Formula (c) represents an alkyl group having 1 to 6 carbon atoms,

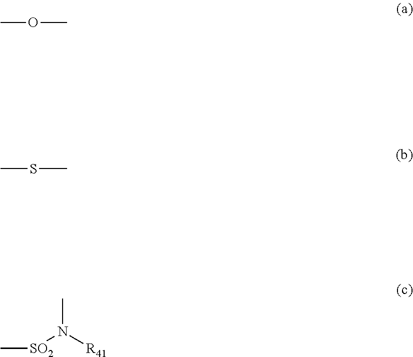

2. The fluorine-containing polymer according to claim 1, further comprising a repeating unit represented by General Formula (IV), 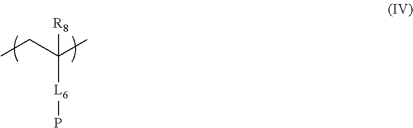
in General Formula (IV),
R₈ represents a hydrogen atom, a fluorine atom, a chlorine atom, or an alkyl group having 1 to 20 carbon atoms,
P represents an aromatic ring which may have a substituent, and
L₆ represents a single bond or a divalent linking group.

3. The fluorine-containing polymer according to claim 1, further comprising a repeating unit represented by General Formula (V), 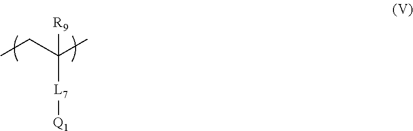
in General Formula (V),
R₉ represents a hydrogen atom, a fluorine atom, a chlorine atom, or an alkyl group having 1 to 20 carbon atoms,
L₇ represents a single bond or a divalent linking group, and
Q₁ represents a group including a polymerizable group selected from the group consisting of a cationically polymerizable group and a radically polymerizable group.

4. The fluorine-containing polymer according to claim 1, further comprising a repeating unit represented by General Formula (VI), 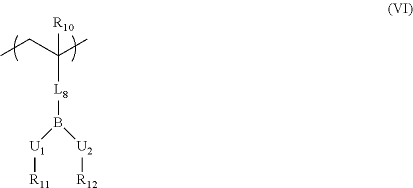
in General Formula (VI),
R₁₀ represents a hydrogen atom, a fluorine atom, a chlorine atom, or an alkyl group having 1 to 20 carbon atoms,
U₁ and U₂ each independently represent —O—, —S—, —COO—, —OCO—, —CONH—, —NHCOO—, or —NH—,
R₁₁ and R₁₂ each independently represent a hydrogen atom, a substituted or unsubstituted aliphatic hydrocarbon group, a substituted or unsubstituted aryl group, or a substituted or unsubstituted heteroaryl group, and R₁₁ and R₁₂ may be linked to each other through a linking group, and
L₈ represents a single bond or a divalent linking group.

5. The fluorine-containing polymer according to claim 1, further comprising a partial structure formed by a radical polymerization of a compound having a mesogenic group derived from at least one liquid crystal compound selected from the group consisting of a rod-like liquid crystal compound and a disk-like liquid crystal compound, and two or more polymerizable groups,
wherein the fluorine-containing polymer is branched.

6. The fluorine-containing polymer according to claim 5,
wherein the compound having a mesogenic group derived from a rod-like liquid crystal compound and two or more polymerizable groups is a compound represented by General Formula (X),
Q^{X1}—L^{X1}—Cy^{X1}—L^{X2}—(Cy^{X2}—L^{X3})ₙₓ—Cy^{X3}—L^{X4}—Q^{X2} General Formula (X)
in General Formula (X), Q^{X1} and Q^{X2} each independently represent a polymerizable group, L^{X1} and L^{X4} each independently represent a divalent linking group, L^{X2} and L^{X3} each independently represent a single bond or a divalent linking group, Cy^{X1}, Cy^{X2}, and Cy^{X3} each independently represent a divalent cyclic group, and nx represents an integer of 0 to 3.

7. The fluorine-containing polymer according to claim 5,
wherein the compound having a mesogenic group derived from a disk-like liquid crystal compound and two or more polymerizable groups is a compound represented by General Formula (I-X), 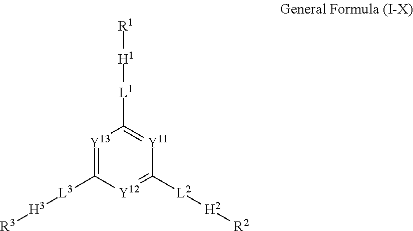
in General Formula (I-X), Y¹¹, Y¹², and Y¹³ each independently represent a methine which may be substituted or a nitrogen atom, L¹, L², and L³ each independently represent a single bond or a divalent linking group, H¹, H², and H³ each independently represent a group represented by General Formula (I-A) or a group represented by General Formula (I-B), and R¹, R², and R³ each independently represent a group represented by General Formula (I-R), 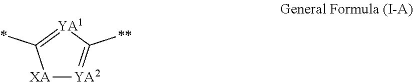
in General Formula (I-A), YA¹ and YA² each independently represent a methine which may have a substituent, or a nitrogen atom, XA represents an oxygen atom, a sulfur atom, a methylene, or an imino, * represents a position for bonding to an L¹ to L³ side in General Formula (I-X), and ** represents a position for bonding to an R¹ to R³ side in General Formula (I-X), 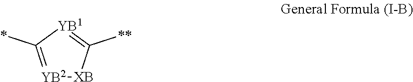
in General Formula (I-B), YB¹ and YB² each independently represent a methine which may have a substituent, or a nitrogen atom, XB represents an oxygen atom, a sulfur atom, a methylene, or an imino, * represents a position for bonding to an L¹ to L³ side in General Formula (I-X), and ** represents a position for bonding to an R¹ to R³ side in General Formula (I-X),
*—(L^{r1}—Q²)ₙ₁—L^{r2}—L^{r3}—Q¹ General Formula (I-R)
in General Formula (I-R), * represents a position for bonding to an H¹ to H³ side in General Formula (I-X), L^{r1} represents a single bond or a divalent linking group, Q² represents a divalent group having at least one cyclic structure, n1 represents an integer of 0 to 4, L^{r2} and L^{r3} each independently represent a divalent linking group, and Q¹ represents a polymerizable group or a hydrogen atom, provided that in General Formula (I-X), at least two of a plurality of Q¹'s represent polymerizable groups.

8. The fluorine-containing polymer according to claim 1,
wherein the repeating unit represented by Formula (I) is a repeating unit represented by Formula (VII), 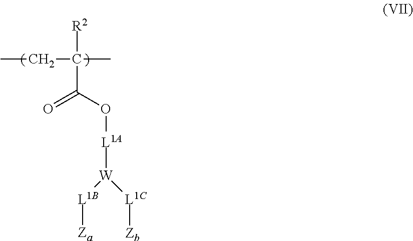
in General Formula (VII),
R² represents a hydrogen atom, a fluorine atom, a chlorine atom, or an alkyl group having 1 to 20 carbon atoms,
L^{1A} represents a single bond or a divalent group having 2 to 50 carbon atoms,
L^{1B} and L^{1C} each independently represent a divalent group having 2 to 50 carbon atoms,
W represents a trivalent group, and
Zₐ and Z_{b} each independently represent a fluorine atom-containing aliphatic hydrocarbon group which may have an oxygen atom.

9. A composition comprising the fluorine-containing polymer according to claim 1.

10. The composition according to claim 9, further comprising a polymerizable liquid crystal compound,
wherein a content of the polymerizable liquid crystal compound is 40% by mass or more with respect to a total mass of the composition.

11. An optical film comprising a layer formed from the composition according to claim 9.

12. A liquid crystal film comprising a layer formed from the composition according to claim 9.

13. A hardcoat film comprising a layer formed from the composition according to claim 9.

14. A polarizing plate comprising a layer formed from the composition according to claim 9.
